(19) United States
(12) Patent Application Publication
(10) Pub. No.: US 2024/0188568 A1
(43) Pub. Date: Jun. 13, 2024

(54) ENVIRONMENTALLY FRIENDLY COMPOSITIONS AND METHODS OF THEIR USE FOR PROMOTING THE GROWTH OF TURFGRASS OVER WEEDS

(71) Applicant: Edaphix, LLC, Bozeman, MT (US)

(72) Inventor: Stuart R. Jennings, Bozeman, MT (US)

(73) Assignee: Edaphix, LLC, Bozeman, MT (US)

(21) Appl. No.: 18/286,523

(22) PCT Filed: Apr. 12, 2022
(86) PCT No.: PCT/US2022/024408

§ 371 Date: Oct. 11, 2023

Related U.S. Application Data
(60) Provisional application No. 63/173,741, filed on Apr. 12, 2021.

(51) Int. Cl. A01N 59/14; A01N 51/00; A01P 13/02; A01P 21/00

(52) U.S. Cl. CPC A01N 59/14; A01N 51/00; A01P 13/02; A01P 21/00

(57) ABSTRACT

This disclosure provides compositions, formulations, systems, and methods of their use to promote the growth of turfgrasses and allowing them to outcompete and/or exert allelopathic influence on weeds.

### CROSS-REFERENCE TO RELATED APPLICATIONS

This application claims the benefit of priority to PCT Application No. PCT/US22/024408, filed on Apr. 12, 2022 and U.S. provisional application No. 63/173,741 filed on Apr. 12, 2021, both of which are hereby incorporated by reference in their entirety.

### FIELD OF THE DISCLOSURE

The field of the present disclosure relates generally to promoting the growth of desirable perennial grasses by enabling them to outcompete unwanted weedy species. More particularly, this disclosure relates to compositions and methods of their use to promote the growth of turfgrasses and allowing them to outcompete and/or exert allelopathic influence on weeds.

### BACKGROUND OF THE DISCLOSURE

A weed is a plant considered undesirable in a particular situation, “a plant in the wrong place”. The terms “weed” or “weedy” generally refer to specific plants that are unwanted in certain human-controlled settings, such as farm fields, gardens, lawns, and parks. Invasive weeds are a serious worldwide problem and about 5% of the world economy (˜$1.4 trillion) is spent annually on control. The approach to weed control currently used is ineffective, expensive and causes excessive harm to the environment. The current global practice for weed control involves spraying chemical weed control formulations, including synthetic herbicides derived from petrochemicals, on the live, above ground tissue of growing plants to disrupt select physiological processes of the plant.

Health Canada decided in 2010 not to allow the coupling of pesticides and fertilizers in combination products. In other words, they can no longer be sold as one combined product, commonly known as “weed-and-feed.” This federal ruling was consistent with a general trend among Canada's provinces and municipalities to discourage the use of all cosmetic herbicides. Chemical herbicides for lawns are also under increasing scrutiny by regulators in the United States.

Weed-free lawns that are aesthetically pleasing are a goal for most homeowners. As more governments and regulatory authorities have banned or severely limited the use of chemical herbicides for weed control on residential lawns, achieving this becomes a challenge. Even in the absence of banning chemicals, many people would prefer a safer alternative. Non-herbicide weed control attempts are currently limited to the use of iron solutions and other non-lethal remedies such as vinegar applied directly to the weed and not the grass. These efforts are ineffective.

The present disclosure provides compositions and formulations of perennial grass-promoting lawn fertilizers and their uses to promote the growth and/or health of desirable grass species. Such improved grass plants are then able to out-compete weeds on lawns and golf courses. The compositions and formulations of the present disclosure are composed of ingredients that are safe and currently federally registered and approved for use in the United States, Canada and elsewhere.

### SUMMARY OF THE DISCLOSURE

The compositions, formulations, systems and methods of the present disclosure address a long-felt need for selectively promoting the growth and/or health of desirable perennial grass species so that they are better able to outcompete invasive, unwanted, weedy plant species. Such compositions, formulations, systems and methods of the present disclosure do not utilize chemically synthesized herbicides. The present disclosure achieves weed control in lawns by promoting soil chemistry that favors perennial grasses over weeds. The present disclosure provides environmentally friendly and sustainable alternatives to the fertilizers and chemically synthesized herbicides that are presently available for turfgrass establishment, maintenance and management. The compositions and methods of the present disclosure promote the growth of perennial grasses allowing them to outcompete weeds.

The compositions, formulations, systems and methods of the present disclosure effectively promote desirable grasses and result in the reduction or elimination of weeds on lawns, golf courses and other types of grassy areas. The compositions and formulations of the present disclosure utilize a fertilizer-based formula composed of selected ingredients, including micronutrients, which are all safe and currently federally registered and approved for use.

The compositions, formulations, systems and methods of the present disclosure promote the growth and/or health of turfgrasses thereby allowing them to outcompete and/or exert allopathic influence over weedy species.

The compositions, formulations, systems and methods of the present disclosure provide for selectively controlling the growth of at least one invasive plant species in a turfgrass community. Therefore, in one embodiment, the compositions and methods provided herein control the growth of at least one invasive plant species in a turfgrass community.

The compositions, formulations, systems and methods of the present disclosure provide for controlling unwanted weeds in the vicinity of preferred, cultivated perennial grasses in a lawn or turf area.

In one embodiment, the present disclosure provides compositions, formulations, systems and methods of applying a composition comprising boron and nitrogen to an area of lawn or turf comprising at least one perennial grass species and at least one weed species growing therein, wherein the method results in an application rate of about 25 lbs/acre to about 100 lbs/acre of boron and about 40 lbs/acre to about 100 lbs/acre of nitrogen, and wherein the method promotes the germination, health, vigor and/or growth of the at least one perennial grass species and suppresses the germination, health, vigor and/or growth of the at least one weed species within one month following application.

In another embodiment, the present disclosure provides such compositions, formulations, systems and methods wherein the application rate is about 75 lbs/acre of boron and about 60 lbs/acre of nitrogen.

In another embodiment, the present disclosure provides such compositions, formulations, systems and methods wherein the application rate is about 50 lbs/acre of boron and about 50 lbs/acre of nitrogen.

In another embodiment, the present disclosure provides such compositions, formulations, systems and methods wherein the at least one weed species is dandelion or creeping Charlie.

In another embodiment, the present disclosure provides such compositions, formulations, systems and methods wherein the at least one perennial grass species is selected from the group consisting of Kentucky bluegrass, fescue, bent grass, and perennial ryegrass.

In another embodiment, the present disclosure provides such compositions, formulations, systems and methods wherein the area of lawn or turf is in the Northeastern United States.

In another embodiment, the present disclosure provides such compositions, formulations, systems and methods wherein the area of lawn or turf is in Eastern Canada.

In another embodiment, the present disclosure provides such compositions, formulations, systems and methods further comprise measuring the area of lawn or turf that is covered by the at least one perennial grass species before the composition is applied and again 1 month after the composition is applied.

In another embodiment, the present disclosure provides such compositions, formulations, systems and methods wherein the area of lawn or turf covered by the at least one perennial grass species has increased by at least 25% relative to the area of law or turf covered by the at least one weed species 1 month after the composition is applied.

In another embodiment, the present disclosure provides such compositions, formulations, systems and methods wherein wherein the composition is in granular form or in liquid form.

In another embodiment, the present disclosure provides such compositions, formulations, systems and methods wherein wherein the composition is applied as a foliar spray.

In another embodiment, the present disclosure provides such compositions, formulations, systems and methods wherein, wherein the method continues to promote the germination, health, vigor and/or growth of the at least one perennial grass species and suppress the germination, health, vigor and/or growth of the at least one weed species for 1 month to 21 months after the composition is applied.

In another embodiment, the present disclosure provides such compositions, formulations, systems and methods wherein wherein the at least one weed species is eliminated from the area of lawn or turf.

In another embodiment, the present disclosure provides such compositions, formulations, systems and methods wherein wherein the application of the composition occurs in the Spring months or the Summer months.

In another embodiment, the present disclosure provides such compositions, formulations, systems and methods wherein wherein the application of the composition occurs post-flowering of the weed species.

In another embodiment, the present disclosure provides such compositions, formulations, systems and methods wherein the method further comprises providing supplemental watering of the area of lawn or turf.

All patents, patent applications, provisional patent applications and publications referred to or cited herein, are incorporated by reference in their entirety to the extent they are not inconsistent with the teachings of the specification.

### BRIEF DESCRIPTION OF THE DRAWINGS

FIG. 1 illustrates a typical small experimental turfgrass plot.

FIG. 2 illustrates a frame placed over a section of a small experimental turfgrass plot that is used to estimate the proportion of perennial grasses and weeds.

FIG. 3 illustrates weed cover in response to treatment for the small experimental turfgrass plots and comparing treatments described in this application to conventional lawn weed control herbicidal options. As shown in FIG. 5 and FIG. 6, the time of treatment from left to right for each ‘Treatment” on the x-axis is as follows: 1 month, 8 months, 10 months, 12 months and 21 months, respectively.

FIG. 4 illustrates the findings of the nitrogen plus boron (N+B) treatments and compares them to the boron-only treatments (B) and an untreated control. As shown in FIG. 5 and FIG. 6, the time of treatment from left to right for each ‘Treatment” on the x-axis is as follows: 1 month, 8 months, 10 months, 12 months and 21 months, respectively.

FIG. 5 illustrates the findings of the liquid formulation treatments.

FIG. 6 illustrates the percent weed cover in response to foliar liquid treatments of boron alone versus nitrogen plus boron.

FIG. 7 illustrates turf weed cover comparing foliar and granular treatments of boron.

FIG. 8 illustrates the percentage perennial grass cover and weed cover averaged over the 21 months of monitoring.

FIG. 9 is a photograph of an area treated by a formulation of the present invention (right hand side) versus an untreated area (left hand side) approximately 1 month after treatment of the right-hand side.

### DETAILED DESCRIPTION OF DISCLOSURE

Invasive plants (i.e. weeds) are well established across the globe and contribute to economic losses, habitat degradation, losses in land productivity and value. Weeds have become established through a variety of landscape changes including, but not limited to, fire, grazing, land clearing, tillage, urbanization, and other land disturbing activities. Weed seeds have also traveled the globe becoming established as exotic species on continents on opposite sides of the world. Many of the noxious weeds found in the U.S. evolved naturally elsewhere, become established, and proliferate in the absence of natural controls.

Herbicides are the principal strategy for controlling weeds including synthetic formulations such as glyphosate (ROUNDUP®/Monsanto, and others), 2,4-D (2,4-Dichlorophenoxyacetic acid), PLATEAU® (imazapyr, BASF), JOURNEY® (imazapic+glyphosate, BASF), MATRIX® (sulfonylurea, DuPont), LANDMARK XP® (sulfometuron and chlorsulfuron, Dupont), and OUST® (sulfometuron, DuPont). Effectiveness of conventional herbicide applications is highly dependent on timing of herbicide application relative to both plant physiology/growth stage, specific contact with growing vegetation, and complimenting rainfall conditions. Land managers often rule out the use of herbicides for control of weeds due to high cost, low effectiveness and damage to desirable species. Effective weed control methods, which do not harm desirable species, are available, but often have limitations related to cost, need for repeated application and a general concern for the hazards associated with the application of organic chemicals in the environment. Most herbicides used for control of invasive species are organic liquid chemicals applied to the leaf tissue, which result in disruption of plant metabolic processes. These same organic chemicals are not naturally derived and may be harmful to water quality, wildlife and humans. Additionally, research suggests that some invasive plant species are developing resistance to herbicides (Maxwell et al. 1990; Heap 2006) and the widespread use of herbicides worldwide (i.e. glyphosate) may cause unintended consequences including limiting micronutrient availability (Yamada et al. 2009), as well as broad endocrine disruption.

Billions of dollars are spent annually controlling weeds. The Nature Conservancy Global Invasive Species Team reports worldwide damage from invasive species amounts to $1.4 trillion annually, or five percent of the global economy (Pimentel et al. 2001). In the U.S., impacts from invasive species amount to $120 billion annually with more than 100 million acres affected (Pimental et al. 2005). For example, leafy spurge (Euphorbia esula) infestations in the northern Great Plains costs ranchers $120 million annually (Bangsund et al. 1991).

The Canadian market for fertilizer and weed control for lawns is estimated at CAD500M. Lawn fertilizer products that promote the growth of perennial grasses so that they outperform weedy species are not currently available to the homeowner. Building on research for the design of fertilizers to promote the health and growth of perennial grasses on United States prairie grasslands, the present disclosure provides fertilizer formulations based on approved ingredients that will help turfgrasses outcompete weeds at a cost that is competitive with the current approach to fertilizer plus ineffective weed control. While field research on Western United States' prairie grasslands has validated this general approach, prior to the present disclosure, no research has been done on perennial grasses for lawns in the Eastern United States and Canada, which have completely different levels of precipitation, soil types and pH, as well as different species of grasses and weeds.

### Turfgrasses

Turfgrasses (aka turf grasses) are narrow-leaved grass (i.e., monocot) species that form a uniform, long-lived ground cover that can tolerate traffic and low mowing heights (usually two inches or below). Representative examples of turfgrass communities that will benefit from the present disclosure include but are not limited to residential and commercial lawns, roadway median strips, roadsides, recreational areas, drainage basins, catchments, golf courses, bocce ball courts, badminton courts, volleyball courts, racquet ball courts, sports stadiums and sports fields (e.g., baseball, football and soccer fields). Whether for a home or golf course, turfgrass is the lush green grass that blankets the ground surrounding various venues.

According to the National Park Service (Benefits of Turf Grass, Jan. 29, 2018), sustainably maintained turf serves the environment in many ways, including: (1) slowing down the speed and reducing the force of flowing water, (2) catching and filtering water to prevent or reduce soil and nutrient erosion, (3) replenishing the air by taking up carbon dioxide and producing oxygen, (4) reducing pollen production by preventing the growth of weedy species, (5) acting as a barrier to fire damage and spreading, (6) deterring insect pests, ticks and rodent pests that are typically deterred from crossing large areas of turf, (7) reducing injuries from impact as compared to other types of natural and artificial surfaces, (8) regulating temperature via their process of transpiration, (9) providing the habitat and energy source for helpful microbial populations, (10) improving the atmosphere by sequestering carbon, and (11) reducing noise, particularly when planted on a slope facing the source of the noise.

Throughout the United States urban landscapes are continuing to expand onto former farms, pastures, and native areas and is being converted into turfgrass, such as home lawns, parks, commercial landscapes, recreational facilities, golf courses, and other greenbelts. Recent global concerns over increased atmospheric carbon dioxide (CO₂) that can potentially alter the earth's climate systems have resulted in rising interest in studying soil organic matter (SOM) dynamics and carbon (C) sequestration capacity in various ecosystems. R F Follett and Y. L. Qian (Assessing Soil Carbon Sequesration in Turfgrass Systems Using Long Term Soil Testing Data, Soil Management and Sugarbeet Research, Fort Collins, CO, USDA ARS, last modified 8/12/2016) concluded that C sequestration in turf soils occurs at a significant rate that is comparable to those reported for United States' land that has been placed in the conservation reserve program.

As used in horticultural contexts, turf refers to the surface layer of soil with its matted, dense vegetation, usually grasses grown for ornamental or recreational use. Grass used in a landscape customarily is referred to as a “lawn” while grass used on a baseball field or golf course is referred to as “turf.” By definition, a lawn is a piece of residential, commercial or industrial land on which grass grows. Turf is the term used by horticulturists referring to grass that is mowed and maintained with the same uses as a lawn. Turf is valuable in the landscape for aesthetic appeal and environmental contributions, such as protecting soil from erosion, capturing runoff water, reducing dust and heat irradiation. As a natural carpet, a lawn is a cushion in recreational sports or for relaxation.

A lawn is an area of land planted with grasses or other durable plants, which are maintained at a short height and used for aesthetic and recreational purposes. Common characteristics of a lawn are that it is composed primarily or only of grass species, it is subject to weed and pest control, it is subject to practices aimed at maintaining its green color, and it is regularly mowed to ensure an acceptable length, although these characteristics are not binding as a definition. In recreational contexts, the specialized names turf, pitch, field or green may be used, depending on the sport and the continent. The term lawn, referring to a managed grass space, dates to no earlier than the 16th century. Tied to suburban expansion and the creation of the household aesthetic, the lawn is an important aspect of the interaction between the natural environment and the constructed urban and suburban space.

Sod is grass specially cultivated, mowed and cut like pieces of carpet into strips or squares attached to 1-2 inches of soil beneath, held together by roots. While the terms “sod” and “turf” are often used interchangeably to refer to this grass and the part of the soil beneath it held together by its roots and/or another type of material, such grass sections, usually provided in rolls or matts, are more popularly known as “turf” and the word “sod” is limited mainly to agricultural situations.

Different types of turfgrass favor either the warm season or cold season and it is important to know what type of turfgrass will work best for the climate in which it will be used. The present disclosure can be practiced with all turfgrasses, including cool season turfgrasses and warm season turfgrasses.

Examples of cool season turfgrasses are Bluegrasses (Poa L.), such as Kentucky Bluegrass (Poa pratensis L.), Rough Bluegrass (Poa trivialis L.), Canada Bluegrass (Poa compressa L.), Annual Bluegrass (Poa annua L.), Upland Bluegrass (Poa glaucantha Gaudin), Wood Bluegrass (Poa nemoralis L.), and Bulbous Bluegrass (Poa bulbosa L.); the Bentgrasses and Redtop (Agrostis L.), such as Creeping Bentgrass (Agrostis palustris Huds.), Colonial Bentgrass (Agrostis tenius Sibth.), Velvet Bentgrass (Agrostis canina L.), South German Mixed Bentgrass (Agrostis L.), and Redtop (Agrostis alba L.); the Fescues (Festuca L.), such as Red Fescue (Festuca rubra L.), Chewings Fescue (Festuca rubra var. commutata Gaud.), Sheep Fescue (Festuca ovina L.), Hard Fescue (Festuca ovina var. duriuscula L. Koch), Hair Fescue (Festuca capillata Lam.), Tall Fescue (Festuca arundinacea Schreb.), Meadow Fescue (Festuca elatior L.); the Ryegrasses (Lolium L.), such as Perennial Ryegrass (Lolium perenne L.), Italian Ryegrass (Lolium multiflorum Lam.); the Wheatgrasses (Agropyron Gaertn.), such as Fairway Wheatgrass (Agropyron cristatum (L.) Gaertn.), Western Wheatgrass (Agropyron smithii Rydb.). Other cool season turfgrasses include Beachgrass (Ammopnila Host.), Smooth Brome (Bromus inermis Leyss.), Timothy (Phleum L.), Orchardgrass (Dactylis glomerata L.), and Crested Dog's-Tail (Cynosurus cristatus L.).

Turfgrasses widely used in northern and eastern Canada and the United States include but are not limited to Kentucky bluegrass (Poa pratensis), ryegrass (Lolium perenne), tall fescue (Festuca arundinacea), Bermuda grass (Cynodon dactylon), and Canada blue grass (Poa compressa).

Examples of warm season turfgrasses are the Bermudagrasses (Cynodon L. C. Rich), such as the Zoysiagrasses (Zoysia Willd.), St. Augustinegrass (Stenotaphrum secundatum (Walt.) Kuntze), Centipedegrass (Eremochioa ophiuroides (Munro.) Hack.), Carpetgrass (Axonopus Beauv.), Bahiagrass (Paspalum notatum Flugge.), Kikuyugrass (Pennisetum clandestinum Hochst. ex Chiov.), Buffalograss (Buchloe dactyloides (Nutt.) Engelm.), Blue Grama (Bouteloua gracilis (H.B.K.) Lag. ex Steud.), Sideoats Grama (Bouteloua curtipendula (Michx.) Torr.), and Dichondra (Dichondra Forst.).

Bags of grass seed purchased from a retail store or on-line generally have a little of each of several or more types of grasses. This helps ensure that something works in the particular area where it is sown and that a lawn is successfully established. Thus, a typical lawn may not be uniform.

PennState Extension (The Cool-Season Turfgrasses: Basic Structures, Growth and Development; on-line; 13 pages; last updated Nov. 10, 2016) provides a descriptive overview and drawings showing the basic structures of grass plants. A mature, unmowed grass plant is composed of leaves, roots, stems, and a seed head. Some grass species do not have all the structures discussed therein; and, mowed grasses typically lack flower stems and seed heads.

A grass leaf is divided into three parts: the blade, sheath, and collar region. The blade is long and narrow and grows more or less horizontally away from the main shoot. The sheath is the portion of the leaf that envelopes the shoot or stem. The collar region is located where the blade and sheath meet and may or may not have structures called the collar, ligule, and auricle. The smooth area on the backside of the leaf where the blade and sheath meet is the collar. It is usually a lighter color than the blade and may continue across the width of the leaf or be divided in half by a large mid vein. A ligule is a thin piece of tissue that extends just above the top of the leaf sheath and can vary in size and shape. An auricle is another small piece of leaf tissue that grows from the collar and can vary in size and shape.

Roots are the belowground part of a grass plant that anchor it in the soil and take-up water and nutrients. Turfgrass roots are fibrous, branching, and very slender. There are two types of root systems in grasses, the primary and the secondary. The difference between the two will be explained later in this section.

Three types of stems occur in grasses; the crown, horizontal stems (rhizomes and stolons), and the flower stem. Although the crown is a stem, it does not look like the other stem types found in grasses. It is very small (just a fraction of an inch long), white, and completely enclosed by leaf sheaths. The crown is located in a protected position between the roots and shoot near the soil surface. Horizontal stems begin to form in the crown and develop into rhizomes or stolons. Rhizomes grow below ground for a short distance, and then rise to the soil surface to form new shoots. In some grass species, rhizomes produce growing points (often referred to as nodes) which give rise to roots and shoots forming new or‘daughter’ plants. Rhizomes are usually white. Stolons grow aboveground and form nodes that give rise to new plants. Stolons are green and can creep over other grasses and bare spots in lawns, often forming circular patches. Flower stems are also formed in the crown, usually in late spring or early summer in most cool-season grasses. Typically, they are not seen in turf since they are mowed off before they reach maturity. On unmowed grass, flower stems grow vertically and give rise to seed heads.

The seed head is the flowering part of the grass plant. The basic unit of the seed head is called the spikelet. A spikelet is made up of grass flowers, the small stalks that support them, and bracts (small, papery leaves that cover the flowers). There are three types of seed heads based on the arrangement of the spikelets, panicle, spike, and raceme. In the panicle type, the spikelets are borne on branches that are arranged along the central or main stem. The main stem is an extension of the flower stem. Kentucky bluegrass is a turfgrass with a panicle-type seed head. The spike-type seed head has spikelets that are borne directly on the main stem. Perennial ryegrass is a turfgrass with a spike-type seed head. In the raceme type, spikelets are borne on very short branches along a main stem. True raceme seed heads are rare in grasses and none of the cool season turfgrasses produces them. Crabgrass, a common annual grass weed, has a modified spike-like raceme.

The ‘seed’ of grass is really a dried fruit called a caryopsis. The caryopsis is made-up mainly of the embryo and endosperm. The embryo contains the beginnings of the leaves, growing points, and roots of the grass plant. The endosperm makes up the bulk of the caryopsis and contains the food (primarily starch) required by the developing plant as it germinates and grows. The entire caryopsis is surrounded by the pericarp, sometimes referred to as the ovary wall. The caryopsis and pericarp are enclosed by two papery structures called the lemma and palea.

The basic requirements for germination of turfgrass seed are adequate moisture, favorable temperatures, and oxygen. The first step in seed germination is absorption of water (sometimes referred to as imbibition). The rate at which grass seed absorbs water depends on the amount of water present and the permeability of the seed. As water is absorbed, the seed swells. Shortly thereafter, enzymes produced by the embryo break down the endosperm and convert the starch into carbohydrates. Carbohydrates can be used directly by the embryo and developing seedling for energy and growth.

The first true leaf to emerge from the seed during germination is enclosed within a protective structure called the coleoptile. Soon after germination, the coleoptile and first leaf begin to elongate and grow towards the soil surface. The coleoptile stops growing just after it reaches the soil surface, but the leaf continues to elongate and breaks through the coleoptile sheath. As the leaf expands and elongates it begins to produce its own food through a process called photosynthesis. Soon after the first leaf emerges, the developing seedling produces a second leaf from the growing point or node enclosed in the coleoptile. All succeeding leaves follow the same route—emerging from the growing point and growing upward within the folds of the older leaves. Eventually, the coleoptile withers away and is no longer visible.

The growing point that gives rise to leaves on mature turfgrass plants is at the tip of the crown and is called the stem apex. This structure looks like a small dome with ridges rising alternately from each side. These ridges are the beginnings of the new leaves. As a leaf begins to develop, it encloses the entire stem apex. This leaf continues to elongate and expand and eventually forms a fully developed leaf with a blade, sheath, and collar region. The fact that grass leaves begin to grow from the stem apex located at the base of the plant is the main reason why grass can be mowed without sustaining serious injury. Growth continues from the base of the leaf after a portion of the leaf blade is mowed off.

The first evidence that the seed has germinated occurs when the embryonic root or radicle breaks through the seed coat. Soon after, the first leaf emerges from the seed. At this point germination has occurred and the plant is considered a seedling.

New leaves are produced from other ridges on the stem apex and emerge from the folds of the older leaves. Thus, the oldest leaves are on the outside of the plant and the youngest are located in the center of the plant. Turfgrass leaves live for a period then die and are replaced by new ones. Under favorable environmental conditions, the number of leaves per plant remains the same as new leaves replace those that die. The rate of leaf growth is dependent on many factors including temperature, moisture, nutrition, and to some extent, day length. Optimum temperatures for leaf growth among the cool season turfgrasses range from 60° to 75° F. Leaf growth increases with increasing day length as long as temperatures are within the optimum range and moisture is adequate. Application of nitrogen fertilizer can greatly increase leaf growth if moisture and temperature are not limiting.

Soon after the radicle emerges from the seed, the first true roots develop from the embryo. These roots are called primary roots and begin taking-up water and nutrients from the soil when they are fully developed. Although the primary roots continue to function for up to a year after germination, water and nutrient uptake is gradually taken over by the secondary roots (sometimes referred to as adventitious roots) which become more numerous as the grass plant matures. Secondary roots are produced from nodes in the crown or from nodes on horizontal stems. Turfgrass roots are very different from leaves and stems. The growing point or meristem is located at the tip of the root. This is where all new root cells are produced. The meristem is protected from the abrasive effects of the soil by a structure called the root cap. In the area just behind the meristem, new cells grow mostly in length. This area is called the region of cell elongation. Behind the region of cell elongation, cells begin to develop into tissues that absorb water and nutrients. Among these tissues are root hairs—tiny hair-like outgrowths that grow from the root surface into the surrounding soil. The primary function of root hairs is water and nutrient uptake. Root hairs number in the billions for a fully developed root system and can greatly increase the amount of soil the roots contact. Water and nutrients are transported from root hairs to the interior of the root where special conducting tissues move water and nutrients to the leaves and shoots.

Turfgrass root growth is affected mainly by soil temperature, moisture, and oxygen. The optimum temperatures for root growth of cool-season grasses are lower than for shoot growth. Although the optimum temperature range for rooting differs somewhat among turfgrass species, most cool season turfgrasses produce the best root growth at soil temperatures between 500 and 65° F. When temperatures reach 90° F. in the surface inch of soil, Kentucky bluegrass root growth is greatly reduced. Roots of cool-season grasses can grow at soil temperatures below 50° F., but growth slows dramatically as temperatures approach freezing (32° F.). Root growth is greatest for cool-season grasses during spring and fall and much reduced during the summer and winter months.

Turfgrasses take-up water from the soil through their root system. The amount of water the roots absorb will depend primarily on the number of roots, the depth of rooting, and the amount of water in the soil. Since the rooting depth of cool-season grasses is usually between 2 and 6 inches, most water absorption initially occurs near the soil surface. As the surface water is depleted, roots begin using up water deeper in the soil. A well-developed and actively growing root system can take advantage of this deeper soil moisture as surface moisture is depleted in dry periods. Contrary to popular belief, roots do not ‘seek out’ water, instead they grow more vigorously and proliferate where water is available.

Turfgrass roots need an adequate supply of oxygen for normal growth and development. Severely compacted soils have limited supplies of oxygen and will not support good root growth even when favorable temperatures and moisture levels are present. Too much water will also deplete the soil of oxygen and cause deterioration of turfgrass roots. Soils with loose, crumbly structure and good drainage are ideal for root growth and development.

Other factors that have an effect on root growth and development are soil pH, fertilization practices, salt concentrations, herbicides, diseases, and insects. These will be discussed in other sections of this manual.

Of the three stem types mentioned previously, the crown is the most important. It gives rise to leaves, secondary roots, and other stems. Because new leaf growth occurs at the base of the plant, grass plants can tolerate mowing and some other types of minor injury to leaf blades. However, crowns can be damaged by mowers when blades are set too low. When this happens, plants are severely damaged and new leaf growth is unlikely.

Since new secondary roots are produced from the crown, some of the existing root system can be damaged without killing the plant—if the root-initiating portion of the crown is not injured. Sod producers routinely sever a portion of the grass root system with sod harvesters, and then transport the sod to a new location. The newly laid sod generates a new root system from secondary roots formed in the crown.

Rhizomes and stolons begin to grow from nodes in the crown and break through the surrounding leaf sheaths to spread laterally. Rhizomes of Kentucky bluegrass and creeping red fescue grow beneath the soil surface and then turn up towards the soil surface to form new shoots. Some other grasses (mostly warm-season grasses and weed grasses) have long rhizomes that produce nodes that can branch and produce shoots and roots, forming new plants.

Rhizomes are a desirable trait in turfgrasses because they allow plants to send new shoots into areas that are thin or damaged by traffic, drought, and/or disease. Kentucky bluegrass is the premier sod grass in the northern U.S. because its rhizomes allow turf to ‘knit’ and hold together as the sod is cut, rolled, and lifted. Kentucky bluegrass is a desirable species for use in athletic fields because its rhizomes provide superior footing for athletes.

Stolons grow along the soil surface and can creep over established turf. New shoots are produced from nodes or from tips of the stolon, as it turns upward. Although the stoloniferous cool season turfgrasses, rough bluegrass and creeping bentgrass, are desirable for some applications, they can be very troublesome weeds if mixed with other lawn grasses since they form light-colored, circular patches as they creep over the more desirable turfgrasses.

Tillers are shoots that develop from crown tissues and grow vertically within the sheaths that surround the crown. Mature tillers produce leaves, stems, and root systems; thus, they can function independently of the mother plant. Tillers increase the shoot density of lawns by replacing shoots that die in winter and summer. Individual tillers live for about a year and formation of new tillers is stimulated by cool temperatures, short day lengths, moderately low mowing heights, and high mowing frequencies. Peak tiller formation occurs in early spring and fall. Turfgrass stands are long-lived because dying shoots are constantly being replaced by new tillers. This process is so gradual that the transition is unnoticeable.

For information on turfgrass science, maintenance and management, see, e.g., the following: R. Emmons and F. Rossi, 2015, Turfgrass Science and Management 5^{th} Edition, Cengage Learning, 608 pages; Carrow et al., 2002, Turfgrass Soil Fertility & Chemical Problems: Assessment and Management 1^{st} Edition, Wiley, 400 pages; A. J. Turgeon and J. E. Kaminski, 2019, Turfgrass Management 10^{th} Edition, Turfpath LLC, 392 pages, Christians et al., 2016, Fundamentals of Turfgrass Management 5^{th} Edition, Wiley, 480 pages; and M. Owen and J. Lanier, 2016, Best Management Practices for Lawn and Landscape Turf, Version 1.51, UMass Extension, 131 pages.

### Chemical Elements and Plant Growth, Health and Survival

Studies have shown that low-concentration micronutrient compounds can be used for selective control of certain invasive plant species in U.S. Western rangelands and prairielands. See, e.g., U.S. Pat. Nos. 8,835,355, 9,096,478, 9,775,357, 10,251,399 and 10,681,913; U.S. Patent Application Publication Nos. US20190183128, US20200187504, US20170318815, US20150351407, US20140342911, US20210037830, US20140200143, US20200260735; and, WIPO Published Patent Application No. WO/2014/113475A1, each of which is specifically incorporated herein for everything it discloses.

Although this field research on Western U.S. prairie grasslands has shown that weed control can be achieved by promoting soil chemistry that favors perennial grasses over weeds, no research has been done on perennial grasses for lawns in the eastern United States and Canada. These areas have completely different levels of precipitation, soil types and pH, plant husbandry methods, as well as different species of grasses and weeds then U.S. prairie grasslands.

Of the sixteen chemical elements known to be important to a plant's growth and survival, thirteen of those elements come from the soil and can be dissolved in water and absorbed through a plant's root system. In some instances, there are insufficient levels of these elements to sustain normal plant growth and development. Agriculturalists rely on the application of fertilizer to ameliorate elemental nutritional deficiencies, with the expectation of a positive, ‘desirable’ plant response to the added nutrient. It is known that all plant species have definable nutrient requirements and many plant species have unique sensitivities to trace elements, otherwise known as micronutrients. Some combinations and concentrations of these nutrients, particularly the micronutrients, can be detrimental or toxic to some plants. Sensitivities to low or high micronutrient levels can be expressed in plants as depressed or stunted growth, delayed maturity, incomplete physiological development, cell necrosis, or premature death (Kabata-Pendias and Pendias, 2001). The range of micronutrients required for optimal plant growth for each species may be broad or narrow. Soils have unique geochemical characteristics related to climate and parent material. Native plant communities have adapted to these unique conditions over thousands of years. Under natural conditions, these plant-soil systems maintain an equilibrium level of nutrient availability until disturbed by natural or anthropogenic forces causing a geochemical disequilibrium, which makes these plant-soil systems susceptible to invasive species colonization.

Phytotoxic levels of trace elements in soils are known to occur naturally. Acid-sulfate soil systems are known to mobilize metals resulting in phytotoxic soil conditions for plant species not tolerant of soil acidity. Saline soil conditions are also known to occur in arid climates resulting in phytotoxic conditions for plant species not tolerant of elevated salinity. Anthropogenic releases of contaminants to the natural environment are also known to cause phytotoxic soil conditions. Mining and smelting are both known to cause acidic and metalliferous soil conditions, while agricultural practices such as fallow farming may lead to salinization of the soil resource.

Farmers may add fertilizers or soil amendments to increase the yield of crops and overcome any geochemical limitations of the soil, which affects crop yield. Plant macronutrients nitrogen, phosphorous and potassium are routinely added to soil to maximize crop yield. In some cases, trace elements such as copper, zinc or boron may be added to the soil if the crop grown has unique trace element fertilization needs. Farmers may also add soil amendments such as lime (such as CaCO₃) to control soil acidity. Similarly, land reclamation scientists may add soil amendments and fertilizers to control undesirable soil geochemistry at disturbed sites. Seeding of plant species, which are tolerant of site-specific conditions, is also a common practice for revegetation of disturbed sites.

According to the present disclosure, minute concentrations of the plant micronutrients boron, copper, zinc, manganese, chlorine and/or molybdenum when applied to the soil, directly to weed seed, or to soil containing weed seed, result in seed death, failure of weed seed to germinate, and premature mortality of emerging seedlings through micronutrient induced phytotoxicity. The phytotoxicity may result by either abiotic or biotic processes. The important biological processes may include microbiological and/or fungal regulation of nutrient concentrations as well as formation of allelochemicals that mediate competition between plants.

The present disclosure further provides combinations of (A) micronutrients and (C) other agriculturally useful compositions including, but are not limited to: 1) one or more additional micronutrients or micronutrient fertilizers, 2) macronutrients or macronutrient fertilizers, 3) agriculturally acceptable adjuvants, 4) biological compounds or related carbon-based organic compounds, 5) inorganic additives, and/or 6) seed, seed coating, or seed inoculant. The present disclosure provides method of using the micronutrient compositions and combinations for selective control of the invasive species.

According to the present disclosure, soil conditions adverse to health and/or growth of weed species yet not adverse to the health and/or growth of desirable plant species are made possible through knowledge of the dose-response curve for each unique micronutrient-plant interaction. The resulting modified geochemical soil conditions cause selective control of invasive plant species while allowing establishment and persistence of desirable plant species. Timing of application of the micronutrient is targeted to elevate soluble soil micronutrient concentrations in soil containing weed seed prior to seed germination. Thus, micronutrient application can be made any time following weed seed drop and before weed seed germination. The timing of micronutrient application is unique to the invasive species targeted and its growth cycle. Fundamentally, the elevated soil micronutrient conditions must exist while the plant is actively growing (whether seed is germinating below the soil surface or producing leaf tissue above the soil surface). The period of micronutrient application may encompass the entire calendar year, depending on the plant species and unique phenological needs for nutrients and site conditions including composition of desirable plant species present. Annual weeds growing from seed every year will require dissimilar timing strategies for micronutrient compound application compared to perennial weed species with extensive and long-lived root systems. Perennial turf grass species also vary their uptake of micronutrients seasonally and may alter the concentrations taken up by weedy species. Often turf grass species exhibit extensive root systems with little ability to store nutrients compared to weedy species with tap roots and other nutrient storage strategies and companion small root systems.

According to the present disclosure, mature growing invasive species can also be controlled by micronutrient addition. For example, weeds commonly grow to maturity early in the growing season and may produce and drop seed in late spring to mid-summer.

For reasons of convenience or performance, combinations of products for control of invasive plant species may be advantageous. In part, combination products are driven by the high labor and equipment costs associated with crop/pasture/landscape management across large acreage where it makes more sense to apply two or more beneficial ingredients at the same time. In part, combination products are driven by performance where the outcome of adding two or more beneficial ingredients is synergistic and product performance is accelerated or augmented by combinations of products for control of invasive plant species. In turf management “Weed and Feed” turf products routinely include both fertilizer and herbicide and are well known strategies for simultaneous applications and applied for reasons of either convenience or performance. Fertilization with macronutrients nitrogen, phosphorous and potassium are routinely applied as combination in varying percentages. Likewise, synthetic weed herbicides may be applied as a ‘cocktail’ of multiple herbicidal constituents sometimes including products produced by different manufacturers.

Although, organic chemical herbicides for control of invasive species are known, selective control of invasive plant species using micronutrients in addition to chemical herbicides or other agricultural compositions has not been practiced commercially on turf or lawns. The present disclosure, among other things, discloses the combination of (A) a micronutrient and (C) an agricultural composition (“the combination of the disclosure”). Further, the present disclosure discloses uses of the combination of the disclosure for selective control of invasive species, soil health augmentation and stimulation of natural soil processes (biomimicry), and effective soil management and vegetation management.

The combination of the disclosure can be in a form where (A) and (C) are separately formulated and separately applied or used. The combination of the disclosure can also be in a form where (A) and (C) are in a single composition. The combination of the disclosure can also apply to (A) and (C), which are formulated or in a form ready to be used as tank-mix partners.

### (A) Micronutrients

Of the sixteen chemical elements known to be important to a plant's growth and survival, thirteen come from the soil, are dissolved in water and absorbed through a plant's roots. In some instances, there are not always enough of these nutrients in the soil for a plant to grow healthy. In other instances, some combinations and concentrations of these nutrients, particularly the micronutrients, can be detrimental or toxic to some plants. Micronutrients, those elements essential for plant growth and which are needed in only very small (micro) quantities, are boron

(B), copper (Cu), iron (Fe), chlorine (Cl), manganese (Mn), molybdenum (Mo) and zinc (Zn). These micronutrients play critical roles in carbohydrate transport, metabolic regulation, osmosis and ionic balance, enzyme and chlorophyll synthesis and function, internal chemical transformations, and cell reproduction/division.

According to one exemplary embodiment the present disclosure, the micronutrients comprises boron, copper, zinc, manganese, chlorine, and/or molybdenum. In one embodiment, the micronutrients comprise a boron source, a copper source, a zinc source, a manganese source, a chlorine source, and/or molybdenum source. As used herein the “source” for elemental micronutrients include organic and inorganic compounds and complexes that can provide soluble micronutrients (boron, copper, zinc, manganese, chlorine, molybdenum, etc.) in the soil.

In some embodiments, a boron source can include, but are not limited to, boric acid, sodium borate, sodium tetraborate, and disodium tetraborate.

In some embodiments, a copper source can include, but are not limited to, chelated copper such as Na₂CuEDTA, copper sulfate such as CuSO₄·5H₂O, cupric oxide (CuO), and cuprous oxide (Cu₂O).

In one embodiment, the micronutrients are useful in increasing the growth of desirable plant species (such as Kentucky bluegrass) while controlling invasive plant species (such as cheatgrass, dandelion, creeping Charlie, and spotted knapweed). In one embodiment, the micronutrients comprise boron or a boron source. In one embodiment, boron is useful in increasing the growth of desirable plant species (such as Kentucky bluegrass) while controlling invasive plant species (such as cheatgrass, dandelion, creeping Charlie, and spotted knapweed).

As used herein, the phrases “desirable plant species” and “desirable plants” refer to plants that are present in a specific location where they are wanted. As used herein, the phrases “invasive plant species” and “invasive plants” refer to plants that are present in a specific location where they are unwanted. Thus, according to the present disclosure, whether a plant is considered a desirable or an invasive plant in a particular situation depends on the specific location involved and the desires of the manager or owner of that location. For example, a certain grass species may be considered a desirable plant in a mixed alfalfa/grass field used for forage production or livestock grazing. That same grass species, however, may be considered an invasive plant in an alfalfa field to be used for certified alfalfa seed production. In the latter situation, the grass species would be classified a weed and if too many seeds or other parts of the grass species were harvested with the alfalfa seed that may result in the seed from that alfalfa production field being denied certification. On an un-tilled landscape occupied by native vegetation the colonization of the site by non-native or exotic plants is illustrative in that the native vegetation would be the “desirable species” and the non-native and exotic colonizing species would be an “invasive species”.

A partial list of known invasive species would include, but not be limited to: cheatgrass (Bromus) (such as Downy brome (Bromus tectorum), Japanese brome (bromus Japonicus), etc.), dandelion (Taraxacum oficinale), knapweeds (Centaurea) (such as spotted (C. maculosa)), diffuse (C. difiusa), Russian (C. repens), etc.), bindweed (Convolvulus), chickweed (Stellaria media), ground ivy (Glechoma hederacea) (aka creeping charlie), poison ivy (Toxicodendron radicans), Canada thistle (Cirsium arvense), burdock (Arctium), houndstongue (Cynoglossum), yellow star thistle (Centaurea solstitialis), Himalayan bush clover (Lespedeza cuneata), privet (Ligustrum), Russian thistle (Salsola), kochia (Bassia), halogeton (Halogeton), Japanese knotweed (Fallopia japonica) and related knotweeds (Fallopia), leafy spurge (Euphorbia), St. Johnswort (Hypericum perforatum), toadflax (Linaria) (such as yellow toadflax (Linaria vulgaris) and Dalmation toadflax (Linaria dalmatica)), tansy (Tanacetum vulgare), whitetop (Lepidium draba), hawkweed (Hieracium), cinquefoil (Potentilla), ox-eye daisy (Leucanthemum vulgare), Wild Parsnip (Pastinaca sativa L.) and others either known to be a problematic invasive species and also those not yet determined to be such. For additional information on weeds see, e.g., R. Dickinson and F. Royer, Weeds of North America, 2014, University of Chicago Press, 656 pages; Invasive Weeds of North America: A Folding Pocket Guide to Invasive & Noxious Species (Wildlife and Nature Identification), 1^{st} Edition, 2017; Thurlow Merrill Prentice, Weeds & Wildflowers of Eastern North America, First Edition, 1973, Peabody Museum of Salem; U.S. Dept. of Agriculture, Common Weeds of the United States, Revised Edition, 1971, Dover Publications, 480 pages; Weeds, 2001, Golden Guides from St. Martin's Press, 160 pages; R. L. Sheley and J. K. Petroff (eds.), Biology and Management of Noxious Rangeland Weeds, 1999, Barnes & Noble, 438 pages; U.S. Pat. Nos. 5,180,415; 9,416,363; and, R. P. Randall, A Global Compendium of Weeds, Third Edition, 2017, 3654 pages. The list of known invasive species can also include annuals: pigweed (Amaranthus), lambsquarters (Chenopodium berlandieri), foxtail (Setaria), crabgrass (Digitus), wild mustard (Sinapis arvensis), field pennycress (Thlaspi arvense), ryegrass (Lolium), goosegrass (Galium aparine), chickweed, wild oats (Avena fatua), velvet leaf (Abutilon theophrasti), purslane (Portulaca oleracea), barnyard grass (Echinochloa), smartweed (Polygonum pensylvanicum), knotweed, cocklebur (Xanthium), wild buckwheat (Fallopia convolvulus), kochia, medic (Medicago), corn cockle (Agrostemma githago), ragweed (Ambrosia), sowthistle (Sonchus), coffeeweeds (common chicory (Cichorium intybus), Chinese senna or sicklepod (Senna Obtusifolia), coffee senna (Senna occidentalis), Colorado River hemp (Sesbania herbacea), croton (Croton), cuphea (Cuphea), dodder (Cuscuta), fumitory (Fumaria), groundsel (Senecio), hemp nettle (Galeopsis), knawel (Scleranthus annuus), spurge (Euphorbia), spurry (Spergula), jungle rice (Echinochloa colona), pondweed (Potamogeton), dog fennel (Eupatorium capillifolium), carpetweed (Mollugo verticillata), morning glory (Convolvulaceae), bedstraw (Galium aparine), or ducksalad (Heteranthera limosa); biennials such as wild carrot (Daucus carota), matricaria (Matricaria), wild barley (Hordeum leporinum), campion (Silene), chamomile (Matricaria discoidea), mullein (velvet plant), roundleaved mallow (Malva), bull thistle (Cirsium vulgare), moth mullein (Verbascum blattaria), and purple star thistle (Centaurea calcitrapa); or perennials such as white perennial ryegrass (Lolium perenne), quackgrass (Elymus repens), Johnson grass (Sorghum halepense), hedge bindweed (Calystegia sepium), Bermuda grass (Cynodon dactylon), sheep sorrel (Rumex acetosella), curly dock (Rumex crispus), nutgrass (Cyperus rotundus), field chickweed (Cerastium arvense), campanula (Campanula), field bindweed (Convolvulus arvensis), mesquite (Prosopis), toadflax, yarrow (Achillea millefolium), aster (Aster), gromwell (Lithospermum), horsetail (Equisetum arvense), ironweed (Vernonia), sesbania (Sesbania), bulrush (Schoenoplectus), cattail (Typha) or wintercress (Barbarea).

In some aspects of the present disclosure, annual grasses are a unique type of invasive plant found in degraded rangeland landscapes and have been implicated in outcompeting desirable and non-weedy perennial plants, competing for water and other soil resources and contributing to ever-worsening cycles of rangeland wildfires. These invasive annual grasses often have limited value to both wildlife and domesticated grazing livestock. These grasses may include, but are not limited to, downy brome (Bromus tectorum), Japanese brome (Bromus Japonicus), soft brome (Bromus hordeaceus), field brome (Aegilops cylindrica), red brome (Bromus rubens), Medusahead (Taeniatherum caput-medusae), ventenata (Ventenata dubia), bulbous bluegrass (Poa bulbosa), Annual wheatgrass (Eremopyrum triticeum, jointed goatgrass (Aegilops cylindrica) and others. Perennial turf and pasture grasses may be invaded by weedy annual grasses such as barnyard grass (Echinochloa crusgalli), rattail fescue (Vulpia myuros), goosegrass (Eleusine indica), Crabgrass (Digitaria spp.), annual bluegrass (Poa annua), annual ryegrass (Lolium multiflorum), panicum spp. And others.

In other aspects of the present disclosure, perennial grasses are typically desirable species in turf applications and may be either of native origin (North American or Canadian) or introduced non-native and domesticated species commonly used in turf and pasture applications. These perennial species are typically deep-rooted and grow for many years from the same rootstock and contribute to soil formation, water infiltration, carbon capture and many beneficial attributes unlike invasive species.

In further aspects of the present disclosure, turf and pasture grasses may include, but are not limited to Crested/desert wheatgrass (Agropyron desertorum), Kentucky bluegrass (Poa pratensis), Canada bluegrass (Poa compressa), orchard grass (Dactylis glomerata), timothy (phleum pratense), smooth brome (Bromus inermis), perennial ryegrass (Lolhum perenne), red fescue (Festuca rubra), tall fescue (Festuca arundinacea), intermediate wheatgrass (Thinopyrum intermedium), tall wheatgrass (Thinopyrum ponfcum), bermudagrass (Cynodon dactylon), hard/sheep fescue (Festuca ovina), Russian wildrye (Psathyrostachys junceus), meadow brome (Bromus biebersteinii), bentgrass (Agrostis spp.), and others.

The present disclosure provides a list of known invasive species that include annual, biennial and perennial species such as: pigweed (Amaranthus spp.), lambsquarters (Chenopodium berlandieri), foxtail (Setaria spp.), crabgrass (Digitus spp.), wild mustard (Sinapis arvensis), field pennycress (Thlaspi arvense), ryegrass (Lolium spp), goosegrass (Galium aparine), chickweed (Stellaria media), wild oats (Avena fatua), velvet leaf (Abutilon theophrasti), purslane (Portulaca oleracea), barnyard grass (Echinochloa spp.), smartweed (Polygonum pensylvanicum), knotweed (Polygonum spp) and others.

The present disclosure teaches strategies for control of annual grasses, annual forbs and perennial forbs that are invasive. These control strategies work broadly for groups of plants listed above rather than by individual species. The control strategies relate to root structure (i.e. taproot versus branching/extensive roots in perennial and/or biennial forbs) and timing (i.e. early season for annual forbs and grasses). The present disclosure can be applied for controlling the broad groupings as well as the specific species.

As used herein, the term “hectare” refers to a metric unit of area equal to a square with 100-meter sides (1 hm²), or 10,000 m², and is primarily used in the measurement of land. There are 100 hectares in one square kilometer. An acre is about 0.405 hectare and one hectare contains about 2.47 acres.

This disclosure demonstrates that fertilization by micronutrients is selectively harmful to invasive plants while desirable species are either stimulated or tolerant of the same levels shown to be phytotoxic to the weedy species. This makes ecological sense as later successional plant communities have more highly evolved nutrient cycling and elevated levels of fertility. The desirable plants characteristic of the late successional plant communities are tolerant and benefit from higher levels of soil fertility and especially adequate amounts of trace elements (also known as micronutrients). Invasive species are intolerant of elevated micronutrient levels and thrive in low nutrient soils, thus, low nutrient soil is unable to retard weedy colonizers. The recycling of trace elements by later successional plant communities may have been a primary natural control on preventing weed invasion. Upon disturbance and loss of pre-disturbance fertility native plant communities become susceptible to weed invasion. The recovery of these systems through natural soil building and plant succession is likely to occur over long periods of time (hundreds to thousands of years) absent repeated disturbance.

Without bound to any theory, micronutrients translocated into the plant shoots and subsequent surface decay provides a weed-inhibiting function through nutrient cycling. The phytotoxic micronutrients fix the soil required to create conditions conducive to perennial plants, so that means creating soil conditions favorable to late-successional ‘old growth’ rangeland plants rather than colonizers, while being phytotoxic to invasive species.

Weeds are negatively impacted by small quantities of micronutrients whereas more desirable species (perennial grasses, native forbs) are tolerant of these same levels. There is a differential tolerance between invasive species and desirable plants (see WO 2014/113475, which is hereby incorporated by reference in its entirety for all purposes). For example, consider the micronutrient copper, its total elemental amount in a given soil might be 50 mg/Kg with maybe 0.1% plant available copper in any given year. If inputs and outputs of copper are in balance, the total amount of copper remains at 50 mg/Kg and the plant available amount remain at 0.1% of the total. In the example of overgrazing, copper translocated to the above ground biomass is removed from the system and micronutrient recycling to the soil is disrupted. Over time the total amount of copper in the soil begins to decline to <50 mg/Kg, but more significantly the plant available amount of copper sharply declines (the total elemental amount is attributable to geologic materials and is often very slowly weathered to plant available forms). For the sake of this example, assume that weeds are not tolerant of more than 0.1% plant available copper. If that level drops due to overgrazing to 0.01% plant available copper, then the site would likely become colonized by invasive plants if a seed source for an invasive plant species were nearby. Thus, fertilizing the soil to restore the pre-disturbance plant available copper level (target of 0.1%), with micronutrients (A) comprising copper or a copper source, would result in reduction or elimination of weeds and reestablishment of more desirable plant species either through natural recolonization or reseeding.

In one aspect, the role of the micronutrients is fundamentally about mass balance—restoring appropriate amounts of soil micronutrients in soil by replacing micronutrients lost due to land disturbance. According to the present disclosure, the consequences of restoring pre-disturbance levels of soil micronutrients include making the soil inhospitable to invasive species and beneficial to desirable plants. Different invasive weed species have different sensitivities to the micronutrients compared to species that are more desirable.

How much micronutrients to add is a function of the existing amount of micronutrients in the soil and the specific weedy and specific desirable plant species present at a site on which the disclosure is to be practiced. The amount of micronutrients present in a disturbed soil is a unique quantity that can be measured by laboratory analysis. Geologic parent material, soil formation history, land use history, climate and other factors influence the elemental levels of all inorganic constituents in the soil. The process to determine the specific micronutrients and amounts of each to be applied involves collecting samples of soil from at least two representative areas or sites: at least one sample from an undisturbed portion of the site with desirable plant species and at least one sample from a disturbed portion of the site with invasive plant species and diminished desirable plant species cover. The difference in soil micronutrient levels between the “good” site and “bad” site form the basis for calculation of fertilizer application rates. The amount of micronutrients added is the difference between the degraded site with low fertility and the reference site with natural levels of soil fertility. According to the present disclosure, site-specific micronutrient prescription can be developed and applied. In larger landscapes with common soil and vegetation characteristics, generalized micronutrient application strategies may be applicable. In addition, when undisturbed sites cannot be found on the larger landscape, generalized micronutrient application may be required to control the targeted invasive species.

Plant micronutrient levels in soil are generally very low (roughly a few pounds per acre of a given plant available micronutrient). Correspondingly, the amount of micronutrient fertilizer to be added per acre would also be low and dependent on the elemental levels of micronutrient in the fertilizer to be applied. In the case where the micronutrient is impractical to apply at low rates (a few pounds per acre) due to the difficulty of applying a thin uniform amount of fertilizer using mechanical equipment, the fertilizer can be bulked up to add weight and/or volume to aid in spreading. Bulking of fertilizer can be accomplished using sand, rice hulls, corn meal, sawdust, crushed walnut shells, corn stover or equivalent. For example, if the target micronutrient application rate was 5 pounds per acre and the reasonable minimum application rate with a given piece of equipment was 10 pounds per acre, an additional 5 pounds of bulking material could be added to the 5 pounds of the micronutrients (the active ingredient).

A second factor affecting the amount of micronutrients to be added is the plant species present—both desirable and invasive. In this disclosure, it is recognized that each plant species has a unique trace element requirement: too little of a given micronutrient and the plant is deficient, too much of a given micronutrient and the plant experiences phytotoxicity. In one embodiment, invasive species have lower tolerance to a given soil micronutrient concentration compared to desirable plant species (typically perennial grasses). It is this differential sensitivity to micronutrients in the soil shown by desirable plants compared to invasive plant species that is important. The micronutrients will include levels of one or more micronutrients at or above levels that favor the health and growth of turfgrasses over that of invasive plant species and below levels harmful to desirable species for a given site. In some embodiments, perennial grass species are much more tolerant of elevated micronutrient levels compared to weeds.

Perennial grass plant community is comprised of native plant species (e.g. bluebunch wheatgrass, etc.) and/or introduced plant species (e.g. Kentucky bluegrass, etc.). Micronutrient application to the soil can occur at any time during the year; however, maximum affect has been observed when micronutrient fertilizer is applied in the late summer/early fall or early spring in advance of seasonal plant growth. According to the present disclosure, mid- to late-summer has shown to be the best time for application of micronutrients to turf grass infested by weeds and especially dandelion. In western landscapes occupied by invasive weeds, winters are typically cold with snow and frozen ground. Maximum plant growth typically occurs in the spring (April-June when snow melts, ground thaws, soil temperatures warm and spring rains occur). The effect of soil micronutrient application during this period may not be observed for one year as plant growth occurs due to existing soil nutrients rather than the added soil nutrients (unless the micronutrient is applied early in the spring and/or unless significant rainfall occurs). Invasive plant species appear most sensitive to elevated micronutrient levels when the plants are young. Annual plant species appear most sensitive during seed germination and establishment early in the phenology of the plant. It should be noted that the effect on invasive plants from micronutrient additions to soil are dissimilar from organic chemical-based herbicides that kill plants over a period of days to weeks and are generally applied to the growing leaf tissue.

The micronutrient requires sufficient time for the fertilizer to be applied to the soil, become dissolved by rainfall, irrigation, or snowmelt and to change the chemistry of the soil solution such that germinating seed or young plants imbibe the applied trace element solution by root uptake. As discussed elsewhere herein, foliar application may, in some instances, result in foliar nutrient uptake that could result in faster plant responses. Changes to the plant community are best observed over long-periods of time (months-years) compared to conventional organic herbicide applications that take affect over short periods. This disclosure also should be thought of in terms of greatly reducing the prevalence of weeds by changing the soil chemistry, but not eliminating all weeds. This is an ecological approach to restoring desirable plant communities and their soil quality. This approach to weed control is fundamentally different from the current practice, which focuses solely on the plant and invasive species control as a one-component system. The micronutrients change the soil chemistry to change the plant community as a two-component system, each dependent on the other.

Further, an herbicidal application of organic chemicals is often an annual process as new plants grow from seed. In the subject disclosure, the micronutrient application is a one-time application intent on restoring soil health, plant community composition and long-term control of weeds through natural micronutrient cycling. Subsequent micronutrient applications may be required if target soil levels are not attained during a first application due to landscape factors, climate, grazing, fire or related land management activities. Multiple applications of micronutrients are not prohibited by this disclosure.

By changing soil conditions through the application of the micronutrients in the uppermost soil layers (˜1 inch depth) weed seeds and seedlings can be inhibited during or immediately following germination therein preventing the plant from growing to maturity and producing seed to sustain subsequent generation of plants. This effect may disrupt the life cycle of annual weedy plant species. Existing desirable perennial plant species are unharmed due to deeper roots, which are not exposed to surficial micronutrient levels. Over a period of months or years, the surface applied micronutrients will reach roots in the deeper soil at diluted concentrations, which are expected to have a long-lasting beneficial fertilization effect due to prior nutrient depletion caused by land disturbance and an inhibitory effect on perennial weeds. The application of micronutrient compounds to create weed-inhibitory conditions and persisting soil residual fertility are intended in addition to providing desirable plants with nutrient resources to synthesize allelochemicals to combat future invasion of weedy plants. Many disturbed sites are both water limited due to climate and nutrient limited due to soil depletion. The resulting ecological lift is caused by the combined effect of enhancing existing desirable vegetation and diminishing the frequency and extent of weedy plants.

In an illustrative example of the applicability of the micronutrients, plant community response to water soluble trace elements has been observed at the Anaconda Smelter Superfund site in Anaconda, MT. At this site, uncontrolled releases of hazardous substances from the operation of a copper smelter have resulted in sharp gradients in soil concentrations of water-soluble copper and zinc. Immediately adjacent to the smelter stack (where the releases originated) soil levels of water-soluble copper and zinc are highest and with increasing distance from the smelter stack soil levels of copper and zinc decrease. Along the gradient of water-soluble copper and zinc present in the soil, plant community zonation is observed with plants exhibiting tolerance to highly elevated copper and zinc found close to the smelter stack and plants with low tolerance to water-soluble copper and zinc found only a great distance from the smelter. Perennial grass species, for example, appear to be tolerant of elevated soil copper and zinc compared to native forbs, which are not found near the smelter stack. In the case of dandelions (an invasive plant species), healthy fields of dandelions are found in uncontaminated soils a distance from the smelter. A short distance closer to the smelter, dandelions are very stressed with black leaf spots and reddish leaf margins. Dandelions are not found where moderate to high levels of water-soluble copper and zinc are measured in the soil. In contrast the invasive plant species spotted knapweed is found growing in soils with low to high levels of water-soluble copper and zinc, suggested differential and elevated tolerance of copper and zinc compared to dandelion.

In one embodiment, the micronutrient is provided in a dry formulation. In one embodiment, the dry formulation is in a granular form. In one embodiment, the dry formulation can be in a dry powder or in a pelletized form. The dry formulation of the micronutrients can be applied to the soil surface with a tractor or a spreader. The dry formulation would become available to the plant upon rainfall or snowmelt.

In one embodiment, the micronutrient is in a dry formulation and the dry formulation is spread on the soil surface or onto vegetation, prior to filtering down to the soil surface by gravity or being dissolved into the soil by water addition by rainfall, snowmelt or irrigation practices.

In some embodiments, the micronutrients comprise boron, boron source, copper, copper source, zinc, zinc source, manganese, manganese source, molybdenum, molybdenum source, chlorine or a chlorine source. In some embodiments, the micronutrients comprises soluble sources of boron, copper, zinc, manganese, molybdenum or chlorine in the range of about 0.01 mg/L to about 50 mg/L, about 0.01 mg/L to about 0.5 mg/L, or about 0.5 mg/L to about 50 mg/L measured in the soil solution. The selection of a specific micronutrient and application rate will be made based on species-specific sensitivity to each micronutrient and cost for each micronutrient fertilizer.

In one embodiment, the micronutrient may be taken up by the plant as a foliar nutrient or the liquid spray drizzling down the vegetation tissue and into the soil to be taken up by roots, or in combination of uptake mechanisms. In other embodiments, the micronutrient compound is spread on the soil surface or onto vegetation prior to filtering down to the soil surface by gravity, prior to being dissolved into the soil by water addition by rainfall, snowmelt or irrigation practices.

In one embodiment, the micronutrients are provided in a liquid formulation. In one embodiment, the liquid formulation is in a spray mixture formulation. In one embodiment, a liquid formulation can be prepared by dissolving the micronutrients in water. In some embodiments, the micronutrients can be dissolved in any liquid not harmful to plants. In one embodiment, a liquid formulation can be applied with a sprayer as long as the application rates are appropriate to achieve the desired fertility goals.

In one embodiment of the liquid formulation of the micronutrients, the formulation is thoroughly mixed to assure complete dissolution of the micronutrients. The solution is can then be applied as an aerial spray to the target area. The solution can be applied to the surface of soil containing invasive species seed, directly to weed seed, or to senesced or live, seed-bearing weed plants at a rate of 2-200 milliliters per square meter. A target area may be any plant community where invasive species are present, e.g. urban land, rangeland, forestland, roadside, brownfield, or disturbed land.

As used herein, the phrase “urban land” refers to an area having the characteristics of a city or otherwise developed for human habitation, with intense development and a wide range of public facilities and services. Urban land includes turf and residential horticultural lands.

As used herein, the term “rangeland” refers to an expanse of land suitable for livestock or wildlife to wander and graze on.

As used herein, the term “forestland” refers to a section of land covered with forest or set aside for the cultivation of forests or as wildland without silvicultural intent.

As used herein, the term “brownfield” refers to a piece of industrial or commercial property that is abandoned or underused and often environmentally contaminated, especially one considered as a potential site for redevelopment.

As used herein, the phrase “disturbed land” refers to land that has been physically disturbed by resource operations (e.g., from mining, logging or construction) that cannot be used for other purposes (e.g., for agriculture or home sites). Disturbed land may be caused by, but not limited to, grazing by wildlife and domestic animals, fire, road construction, climate change, flooding, landslide, erosion, invasive species colonization, tillage for agriculture, urbanization, pipeline or utility installation, dam building (or removal), and the like.

In some embodiments of the present disclosure, the target area does not include land under intensive agronomical or horticultural production. For example, in some embodiments of the present disclosure, the target area does not include land being used to grow row crops, such as is used for large-scale growing of soybeans, maize/corn, cotton, dry peas and the like. In other examples, in some embodiments of the present disclosure, the target area does not include land being used to grow truck crops (i.e., large-scale vegetable crops), such as is used for large-scale growing of watermelons, fresh peas, peppers, cucumbers, tomatoes, onions and the like. In still other examples, in some embodiments for the present disclosure, the target area does not include land being used to grow large-scale production of flowers, such as is used for large-scale growing of tulips, daffodils, chrysanthemums and the like.

In one embodiment, the micronutrient is designated F1 (0 lbs. Boron/acre), F2 (25 lbs. Boron/acre), F3 (50 lbs. Boron/acre) or F4 (10 lbs. Boron/acre). In some embodiments, the F1, F2, F3 and F4 are applied to the soil in granular form.

### Micronutrients Comprising Boron or a Boron Source

In one embodiment, the micronutrients comprise boron or a boron source. In one embodiment, the boron source is boric acid, sodium borate, sodium tetraborate, or disodium tetraborate, or other soluble sources of boron. In some embodiments, soluble boron can be provided by dissolving boric acid, sodium borate, sodium tetraborate, or disodium tetraborate, or other soluble sources of boron, in water or alternative agriculturally acceptable liquid to create a boron-containing solution. In one embodiment, water-soluble boron can be provided by dissolving boric acid, sodium borate, sodium tetraborate, or disodium tetraborate, or other water-soluble sources of boron, in water.

In some embodiments, the micronutrient comprising boron or a boron source has a boron soil concentration ranging from about 0.01 mg/L to about 50 mg/L or from about 0.5 mg/L to about 50 mg/L of water-soluble boron. In other embodiments, the applied liquid micronutrient solution comprising boron or a boron source has a boron concentration ranging from about 0.1 g/L to about 1 g/L, about 0.1 g/L to about 10 g/L, about 0.5 g/L to about 10 g/L, about 2 g/L to about 20 g/L, from about 3 g/L to about 30 g/L, from about 4 g/L to about 40 g/L, from about 5 g/L to about 50 g/L, about 6 g/L to about 60 g/L, about 7 g/L to about 70 g/L, about 8 g/L to about 80 g/L, about 9 g/L to about 90 g/L, or about 10 g/L to about 100 g/L of water soluble boron.

In some embodiments, the micronutrients comprising boron or a boron source is applied to a locus to achieve a water soluble boron soil concentration of about: 0.01 mg/L, 0.02 mg/L, 0.03 mg/L, 0.04 mg/L, 0.05 mg/L, 0.06 mg/L, 0.07 mg/L, 0.08 mg/L, 0.09 mg/L, 0.10 mg/L, 0.15 mg/L, 0.20 mg/L, 0.25 mg/L, 0.30 mg/L, 0.35 mg/L, 0.40 mg/L, 0.45 mg/L, 0.50 mg/L, 0.55 mg/L, 0.60 mg/L, 0.65 mg/L, 0.70 mg/L, 0.75 mg/L, 0.80 mg/L, 0.85 mg/L, 0.90 mg/L, 0.95 mg/L, 1.00 mg/L, 1.50 mg/L, 2.00 mg/L, 2.50 mg/L, 3.00 mg/L, 3.50 mg/L, 4.00 mg/L, 4.50 mg/L, 5.00 mg/L, 5.50 mg/L, 6.00 mg/L, 6.50 mg/L, 7.00 mg/L, 7.50 mg/L, 8.00 mg/L, 8.50 mg/L, 9.00 mg/L, 9.50 mg/L, 10.00 mg/L, 11.00 mg/L, 12.00 mg/L, 13.00 mg/L, 14.00 mg/L, 15.00 mg/L, 16.00 mg/L, 17.00 mg/L, 18.00 mg/L, 19.00 mg/L, 20.00 mg/L, 21.00 mg/L, 22.00 mg/L, 23.00 mg/L, 24.00 mg/L, 25.00 mg/L, 26.00 mg/L, 27.00 mg/L, 28.00 mg/L, 29.00 mg/L, 30.00 mg/L, 31.00 mg/L, 32.00 mg/L, 33.00 mg/L, 34.00 mg/L, 35.00 mg/L, 36.00 mg/L, 37.00 mg/L, 38.00 mg/L, 39.00 mg/L, 40.00 mg/L, 41.00 mg/L, 42.00 mg/L, 43.00 mg/L, 44.00 mg/L, 45.00 mg/L, 46.00 mg/L, 47.00 mg/L, 48.00 mg/L, 49.00 mg/L, and 50.00 mg/L of soil.

In other embodiments, the micronutrients comprising boron or a boron source is applied to a locus to achieve water soluble boron soil concentration ranges as follows (including any/all concentrations between these ranges): 0.01-0.02 mg/L, 0.02-0.03 mg/L, 0.03-0.04 mg/L, 0.04-0.05 mg/L, 0.05-0.06 mg/L, 0.06-0.07 mg/L, 0.07-0.08 mg/L, 0.08-0.09 mg/L, 0.09-0.10 mg/L, 0.10-0.15 mg/L, 0.15-0.20 mg/L, 0.20-0.25 mg/L, 0.25-0.30 mg/L, 0.30-0.35 mg/L, 0.35-0.40 mg/L, 0.40-0.45 mg/L, 0.45-0.50 mg/L, 0.50-0.55 mg/L, 0.55-0.60 mg/L, 0.60-0.65 mg/L, 0.65-0.70 mg/L, 0.70-0.75 mg/L, 0.75-0.80 mg/L, 0.80-0.85 mg/L, 0.85-0.90 mg/L, 0.90-0.95 mg/L, 0.95-1.00 mg/L, 1.00-1.50 mg/L, 1.50-2.00 mg/L, 2.00-2.50 mg/L, 2.50-3.00 mg/L, 3.00-3.50 mg/L, 3.50-4.00 mg/L, 4.00-4.50 mg/L, 4.50-5.00 mg/L, 5.00-5.50 mg/L, 5.50-6.00 mg/L, 6.00-6.50 mg/L, 6.50-7.0 mg/L, 7.00-7.50 mg/L, 7.50-8.0 mg/L, 8.00-8.50 mg/L, 8.50-9.0 mg/L, 9.00-9.50 mg/L, 9.50-10.00 mg/L, 10.00-10.50 mg/L, 10.50-11.00 mg/L, 11.00-11.50 mg/L, 11.50-12.00 mg/L, 12.00-13.00 mg/L, 13.00-14.00 mg/L, 14.00-15.00 mg/L, 15.00-16.00 mg/L, 16.00-17.00 mg/L, 17.00-18.00 mg/L, 18.00-19.00 mg/L, 19.00-20.00 mg/L, 20.00-21.00 mg/L, 21.00-22.00 mg/L, 22.00-23.00 mg/L, 23.00-24.00 mg/L, 24.00-25.00 mg/L, 25.00-26.00 mg/L, 26.00-27.00 mg/L, 27.00-28.00 mg/L, 28.00-29.00 mg/L, 29.00-30.00 mg/L, 30.00-31.00 mg/L, 31.00-32.00 mg/L, 32.00-33.00 mg/L, 33.00-34.00 mg/L, 34.00-35.00 mg/L, 35.00-36.00 mg/L, 36.00-37.00 mg/L, 37.00-38.00 mg/L, 38.00-39.00 mg/L, 39.00-40.00 mg/L, 40.00-41.00 mg/L, 41.00-42.00 mg/L, 42.00-43.00 mg/L, 43.00-44.00 mg/L, 44.00-45.00 mg/L, 45.00-46.00 mg/L, 46.00-47.00 mg/L, 47.00-48.00 mg/L, 48.00-49.00 mg/L, and 49.00-50.00 mg/L of soil.

In one embodiment, 5 mg boron/L concentration is achieved by dissolving 29.4 mg boric acid in 1000 milliliters of water. In another embodiment, the 20 mg boron/L concentration is achieved by dissolving 117.6 mg boric acid in 1000 milliliters of water.

In some embodiments, the micronutrients comprising boron or a boron source has a boron concentration of about 0.5-1 g/L to about 1.00-1.50 g/L, about 1.50-2.00 g/L, about 2.00-2.50 g/L, about 2.50-3.00 g/L, about 3.00-3.50 g/L, about 3.50-4.00 g/L, about 4.00-4.50 g/L, about 4.50-5.00 g/L, about 5.00-5.50 g/L, about 5.50-6.00 g/L, about 6.00-6.50 g/L, about 6.50-7.0 g/L, about 7.00-7.50 g/L, about 7.50-8.0 g/L, about 8.00-8.50 g/L, about 8.50-9.0 g/L, about 9.00-9.50 g/L, about 9.50-10.00 g/L, about 10.00-11.00 g/L, about 11.00-12.00 g/L, about 12.00-13.00 g/L, about 13.00-14.00 g/L, about 14.00-15.00 g/L, about 15.00-16.00 g/L, about 16.00-17.00 g/L, about 17.00-18.00 g/L, about 18.00-19.00 g/L, about 19.00-20.00 g/L, about 20.00-21.00 g/L, about 21.00-22.00 g/L, about 22.00-23.00 g/L, about 23.00-24.00 g/L, about 24.00-25.00 g/L, about 25.00-26.00 g/L, about 26.00-27.00 g/L, about 27.00-28.00 g/L, about 28.00-29.00 g/L, about 29.00-30.00 g/L, about 30.00-31.00 g/L, about 31.00-32.00 g/L, about 32.00-33.00 g/L, about 33.00-34.00 g/L, about 34.00-35.00 g/L, about 35.00-36.00 g/L, about 36.00-37.00 g/L, about 37.00-38.00 g/L, about 38.00-39.00 g/L, about 39.00-40.00 g/L, about 40.00-41.00 g/L, about 41.00-42.00 g/L, about 42.00-43.00 g/L, about 43.00-44.00 g/L, about 44.00-45.00 g/L, about 45.00-46.00 g/L, about 46.00-47.00 g/L, about 47.00-48.00 g/L, about 48.00-49.00 g/L, about 49.00-50.00 g/L, about 50.00-55.00 g/L, about 55.00-60.00 g/L, about 60.00-65.00 g/L, about 65.00-70.00 g/L, about 70.00-75.00 g/L, about 75.00-80.00 g/L, about 85.00-90.00 g/L, about 90.00-95.00 g/L, or about 95.00-100.00 g/L in a liquid formulation of interest.

In one embodiment, a 10% B liquid that can be publicly obtained and/or purchased is diluted to 10:1 mix (Water:10% B liquid), which is 1% B solution. This 1% B solution has a boron concentration of about 10 g/L.

In one embodiment, 14.1 g boron/L concentration is achieved by dissolving 1044 grams of 20.5% boron into 4 gallons of water. In one embodiment, 17.6 g boron/L concentration is achieved by dissolving 1300 grams of 20.5% boron into 4 gallons of water. In one embodiment, 19.4 g boron/L concentration is achieved by dissolving 1440 grams of 20.5% boron into 4 gallons of water. In one embodiment, 35.2 g boron/L concentration is achieved by dissolving 2600 grams of 20.5% boron into 4 gallons of water.

In one embodiment, the micronutrient comprising boron or a boron source can be prepared by dissolving boron or a boron source in cold water, room-temperature water, lukewarm water, warm water, hot water or boiling water.

In some embodiments, the micronutrients comprising boron or a boron source is in a liquid formulation.

In one embodiment, the micronutrients comprising boron or a boron source is in a dry formulation. In some embodiments, the dry formulation is a coarse granular form, fine granular form, or a powder form. In some embodiments, the micronutrients in powder form is more soluble than the micronutrients in a fine granular form. In some embodiments, the micronutrients in fine granular form is more soluble than the micronutrients in a coarse granular form.

In some embodiments, the micronutrients comprising boron or a boron source is in a dry formulation comprises about 5% to about 40% elemental boron by weight of the micronutrients, or any value and subranges there between. In some embodiments, the micronutrients comprising boron or a boron source is in a dry formulation comprises about 5% to about 30% elemental boron by weight of the micronutrients, and any value and subranges there between. In some embodiments, the micronutrients comprising boron or a boron source is in a dry formulation comprises about 10% to about 30% elemental boron by weight of the micronutrients, and any value and subranges there between. In some embodiments, the micronutrients comprising boron or a boron source is in a dry formulation comprises about 10% to about 25% elemental boron by weight of the micronutrients, and any value and subranges there between.

In some embodiments, the micronutrients comprising boron or a boron source is in a dry formulation comprises 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, and about 40%, elemental boron by weight of the micronutrients.

In one embodiment, the rates of application of the micronutrients comprising boron or a boron source is at about 1 lbs. to about 200 lbs. of elemental boron per acre, and any value and subranges there between. In some embodiments of the present disclosure, the turf formulations typically comprise 25-50 pounds of elemental B per acre. In some embodiments, the rates of application of the micronutrients comprising boron or a boron source is at about 5 lbs. to about 160 lbs. of elemental boron per acre, and any value and subranges there between. In some embodiments, the rates of application of the micronutrients comprising boron or a boron source is at about 5 lbs., about 10 lbs., about 15 lbs., about 20 lbs., about 25 lbs., about 30 lbs., about 35 lbs., about 40 lbs., about 45 lbs., about 50 lbs., about 55 lbs., about 60 lbs., about 65 lbs., about 70 lbs., about 75 lbs., about 80 lbs., about 85 lbs., about 90 lbs., about 95 lbs., about 100 lbs., about 105 lbs., about 110 lbs., about 115 lbs., about 120 lbs., about 125 lbs., about 130 lbs., about 135 lbs., about 140 lbs., about 145 lbs., about 150 lbs. about 155 lbs., or about 160 lbs. of elemental boron per acre.

In some embodiments, the rates of application of the micronutrients comprising boron or a boron source for turf and range treatment of weeds is at about 5 lbs. to about 160 lbs. of elemental boron per acre, and any value and subranges there between. In some embodiments, the rates of application of the micronutrients comprising boron or a boron source for turf and range treatment of weeds is at about 8-100 lbs. of elemental boron per acre. In other embodiments, the rates of application of the micronutrients comprising boron or a boron source for turf and range treatment of weeds is at about 9 lbs. of elemental boron per acre, about 25 lbs. of elemental boron per acre, about 50 lbs. of elemental boron per acre, about 75 lbs. of elemental boron per acre and about 100 lbs. of elemental boron per acre.

In some embodiments, the rates of application of the micronutrients comprising boron or a boron source for rangeland treatment of invasive species is at about 5 lbs. to about 160 lbs. of elemental boron per acre, and any value and subranges there between. In some embodiments, the rates of application of the micronutrients comprising boron or a boron source for rangeland treatment of invasive species is at about 5 lbs., about 10 lbs., about 15 lbs., about 20 lbs., about 25 lbs., about 30 lbs., about 35 lbs., about 40 lbs., about 45 lbs., about 50 lbs., about 55 lbs., about 60 lbs., about 65 lbs., about 70 lbs., about 75 lbs., about 80 lbs., about 85 lbs., about 90 lbs., about 95 lbs., about 100 lbs., about 105 lbs., about 110 lbs., about 115 lbs., about 120 lbs., about 125 lbs., about 130 lbs., about 135 lbs., about 140 lbs., about 145 lbs., about 150 lbs. about 155 lbs., or about 160 lbs. of elemental boron per acre. In some embodiments, the rates of application of the micronutrients comprising boron or a boron source for rangeland treatment of cheatgrass is at about 5 lbs., about 10 lbs., about 15 lbs., about 20 lbs., about 25 lbs., about 30 lbs., about 35 lbs., about 40 lbs., about 45 lbs., about 50 lbs., about 55 lbs., about 60 lbs., about 65 lbs., about 70 lbs., about 75 lbs., about 80 lbs., about 85 lbs., about 90 lbs., about 95 lbs., about 100 lbs., about 105 lbs., about 110 lbs., about 115 lbs., about 120 lbs., about 125 lbs., about 130 lbs., about 135 lbs., about 140 lbs., about 145 lbs., about 150 lbs. about 155 lbs., or about 160 lbs. of elemental boron per acre. In one embodiment, the micronutrients comprising boron or a boron source for rangeland treatment of cheatgrass is in a dry formulation. In some embodiments, the dry formulation can be applied to the soil.

In one embodiment, the micronutrients comprising boron or a boron source for rangeland treatment of cheatgrass is in a liquid formulation, which can be applied at a rate of about 5 lbs. to about 30 lbs. of elemental boron per acre, and any value and subranges there between. In some embodiments, the micronutrients comprising boron or a boron source for rangeland treatment of cheatgrass is in a liquid formulation, which can be applied at a rate of about 15 lbs. of elemental boron per acre. In some embodiments, the liquid formulation can be applied to the plant tissue.

In some embodiments, the rates of application of the micronutrients comprising boron or a boron source for turf treatment of invasive species is at about 5 lbs. to about 125 lbs. of elemental boron per acre, and any value and subranges there between. In some embodiments, the rates of application of the micronutrients comprising boron or a boron source for turf treatment of invasive species is about 5 lbs., about 10 lbs., about 15 lbs., about 20 lbs., about 25 lbs., about 30 lbs., about 35 lbs., about 40 lbs., about 45 lbs., about 50 lbs., about 55 lbs., about 60 lbs., about 65 lbs., about 70 lbs., about 75 lbs., about 80 lbs., about 85 lbs., about 90 lbs., about 95 lbs., about 100 lbs., about 105 lbs., about 110 lbs., about 115 lbs., about 120 lbs., about 125 lbs., about 130 lbs., about 135 lbs., about 140 lbs., about 145 lbs., about 150 lbs. about 155 lbs., or about 160 lbs. of elemental boron per acre. In some embodiments, the rates of application of the micronutrients comprising boron or a boron source for turf treatment of dandelions and creeping Charlie is about 5 lbs., about 10 lbs., about 15 lbs., about 20 lbs., about 25 lbs., about 30 lbs., about 35 lbs., about 40 lbs., about 45 lbs., about 50 lbs., about 55 lbs., about 60 lbs., about 65 lbs., about 70 lbs., about 75 lbs., about 80 lbs., about 85 lbs., about 90 lbs., about 95 lbs., about 100 lbs., about 105 lbs., about 110 lbs., about 115 lbs., about 120 lbs., about 125 lbs., about 130 lbs., about 135 lbs., about 140 lbs., about 145 lbs., about 150 lbs. about 155 lbs., or about 160 lbs. of elemental boron per acre. In some embodiments, the rates of application of the micronutrients comprising boron or a boron source for turf treatment of clovers is at about 5 lbs., about 10 lbs., about 15 lbs., about 20 lbs., about 25 lbs., about 30 lbs., about 35 lbs., about 40 lbs., about 45 lbs., about 50 lbs., about 55 lbs., about 60 lbs., about 65 lbs., about 70 lbs., about 75 lbs., about 80 lbs., about 85 lbs., about 90 lbs., about 95 lbs., about 100 lbs., about 105 lbs., about 110 lbs., about 115 lbs., about 120 lbs., about 125 lbs., about 130 lbs., about 135 lbs., about 140 lbs., about 145 lbs., about 150 lbs. about 155 lbs., or about 160 lbs. of elemental boron per acre. In some embodiments, the rates of application of the micronutrients comprising boron or a boron source for turf treatment of dandelions, creeping Charlie, and/or clovers is at about 5 lbs., about 10 lbs., about 15 lbs., about 20 lbs., about 25 lbs., about 30 lbs., about 35 lbs., about 40 lbs., about 45 lbs., about 50 lbs., about 55 lbs., about 60 lbs., about 65 lbs., about 70 lbs., about 75 lbs., about 80 lbs., about 85 lbs., about 90 lbs., about 95 lbs., about 100 lbs., about 105 lbs., about 110 lbs., about 115 lbs., about 120 lbs., about 125 lbs., about 130 lbs., about 135 lbs., about 140 lbs., about 145 lbs., about 150 lbs. about 155 lbs., or about 160 lbs. of elemental boron per acre.

In one embodiment, the micronutrients comprising boron or a boron source for turf treatment of dandelions, creeping Charlie, and/or clovers is in a dry formulation that can be applied at a rate of about 25 lbs. to about 100 lbs. of elemental boron per acre. In some embodiments, the dry formulation can be applied to the soil.

In one embodiment, the micronutrients comprising boron or a boron source for turf treatment of dandelions, creeping Charlie, and/or clovers is in a liquid formulation, which can be applied at a rate of about 5 lbs. to about 150 lbs. of elemental boron per acre, and any value and subranges there between. In some embodiments, the micronutrients comprising boron or a boron source for turf treatment of dandelions, creeping Charlie, and/or clovers is in a liquid formulation, which can be applied at a rate of about 15 lbs. to 100 lbs. of elemental boron per acre. In some embodiments, the liquid formulation can be applied to the plant tissue. In some embodiments, the liquid formulation can be used in a foliar spray on plant tissue with unknown amounts of the micronutrients drizzling down into the soil.

When the micronutrients comprising boron or a boron source is applied as a dry, spreadable powder, some source of boron is crystalline, powdered boric acid, or in other boron-containing compounds. In an embodiment, the application of a dry formulation of boron containing micronutrients can be in a flowable form, e.g., 1.98 g boric acid per square meter is applied to the target area.

Applying a boron-containing formulation to weed seeds, weed seedlings, and/or weed plants functions by disrupting the target species cell physiology when moisture-containing boron is imbibed by the seed or seedling from the soil. While control of invasive plant species is the outcome of the disclosure, the applications of micronutrients are intended to change the soil chemistry. The soil is the host of the micronutrients delivered to the invasive plant species. In each application embodiment, whether liquid or dry, the applied boron is made plant-available through either dissolution by rainfall, snowmelt or other environmental conditions, or plant uptake of the liquid application, and is therefore plant-available regardless of the form of application. The actual mechanism of boron involvement in plant physiology remains somewhat unclear. There is a very narrow window between the levels of boron required by and toxic to plants. The subject disclosure discloses the specific, narrow window of concentrations of boron toxic to invasive plant species, thereby allowing control by application of boron concentrations in excess of invasive plant species toxic limits, yet below levels toxic to desirable species.

Another embodiment of the application of the micronutrients entails measuring the amount of plant-available boron in the soil in the target area and adding supplemental boron to achieve an effective level harmful to invasive plant species, but not harmful to desirable vegetation (also referred to as the Induced Phytotoxicity Threshold or IPT). Under this embodiment, the naturally occurring soil boron level is measured therein establishing a baseline boron concentration. This method is made possible by laboratory, greenhouse and field-testing of common plant species and development of unique characteristic dose-response curves identifying plant growth characteristics resulting from varying the water-soluble boron concentrations across the range of about 0.5 to about 50 mg/L. The novel finding that facilitates the disclosure is the sensitivity of invasive plants species to low levels of water-soluble soil boron compared to desirable plant species found on rangeland or other environments.

As well known to those skilled in the art, application rates can be calculated based on the purity of the micronutrient in the composition being applied. For example, if one wants to apply 50 lbs. of boron per acre and the coarse granular fertilizer has a boron purity of 14.3%, then 349.7 lbs. of the fertilizer must be applied per acre. For a fine granular fertilizer with a boron purity of 15%, the amount of fertilizer to be applied would be 333.3 lbs. per acre. If a powder fertilizer had a boron purity of 20.5%, then 243.9 lbs. must be applied per acre. The solubility of each type of these fertilizers in water is, in general, low, moderate and high, respectively.

Each of the embodiments of the present disclosure as described herein for preparation and application of boron are similarly applicable to formulations containing the other micronutrients useful for this disclosure. Such formulations containing the other micronutrients, or combinations thereof, may be similarly prepared and applied to a target area, depending on the invasive species that is to be controlled or eradicated and the IPT for that species, micronutrient and target area soil conditions or preexisting micronutrient levels.

Boron toxicity to invasive plant species appears to cause significant changes in the physiology and activity of numerous enzymes in seed and seedling development, and consequently plant metabolism during the life cycle of the plant. Three main candidates for boron toxicity involve the ability of boron to bind compounds with two hydroxyl groups in the cis-configuration: (a) alteration of cell wall structure; (C) metabolic disruption by binding to the ribose moieties of molecules such as adenosine triphosphate (ATP), nicotinamide adenine dinucleotide; and (c) disruption of cell division and development by binding to ribose, either as a free sugar or within RNA. However, the only defined physiological role of boron in plants is as a cross-linking molecule involving reversible covalent bonds with cis-diols on either side of borate. Because boronic acids cannot cross-link two molecules, the addition of boronic acids causes the disruption of cytoplasmic strands and cell-to-cell wall detachment. Boronic acids appear to specifically disrupt or prevent borate-dependent cross-links important for the structural integrity of the cell, including the organization of transvacuolar cytoplasmic strands. Boron likely plays a structural role in the plant cytoskeleton.

### Micronutrients Comprising Copper or a Copper Source

In one embodiment, the micronutrients comprise copper or a copper source. In some embodiments, a copper source can be selected from Table 1. In one embodiment, the micronutrients comprising copper or a copper source is highly soluble compared to geological mineral sources in the natural soil.

TABLE 1
Fertilizer sources of copper.

| | | % Copper |
|---|---|---|
| Source | Formula | by weight |
| Copper chelate | Na₂CuEDTA | 13 |
| Copper sulfate | CuSO₄•5H₂O | 25 |
| Cupric oxide | CuO | 75 |
| Cuprous oxide | Cu₂O | 89 |

Table 1 shows the percentage of elemental copper by weight in each of the listed copper source. Thus, in order to apply the micronutrients at a rate of 10 pounds/acre of copper using the Na₂CuEDTA, 76.9 pounds of Na₂CuEDTA will be required as the copper content in the Na₂CuEDTA is 13% by weight. Similarly, for the same rate of copper application, 40 pounds copper sulfate will be required per acre, or 13 pounds of cupric oxide per acre, or 11.2 pounds of cuprous oxide per acre.

Whether the micronutrient is applied as a dry formulation or as a liquid formulation is irrelevant as the objective is to achieve the desired amount of the micronutrients in the soil to favor the species desired and reduce or eliminate the invasive weedy species.

In some embodiments of the present disclosure, the micronutrients comprising copper or a copper source is applied to a locus to achieve copper soil concentration ranges as follows (including any and all concentrations between these ranges): 1-25 mg/Kg, 25-50 mg/Kg, 50-75 mg/Kg, 75-100 mg/Kg, 100-125 mg/Kg, 125-150 mg/Kg, 150-175 mg/Kg, 175-200 mg/Kg, 200-225 mg/Kg, 225-250 mg/Kg, 250-275 mg/Kg, 275-300 mg/Kg, 300-325 mg/Kg, 325-350 mg/Kg, 350-375 mg/Kg, 375-400 mg/Kg, 400-425 mg/Kg, 425-450 mg/Kg, 450-475 mg/Kg, 475-500 mg/Kg, 500-525 mg/Kg, 525-550 mg/Kg, 550-575 mg/Kg, 575-600 mg/Kg, 600-625 mg/Kg, 625-650 mg/Kg, 650-675 mg/Kg, 675-700 mg/Kg, 700-725 mg/Kg, 725-750 mg/Kg, 750-775 mg/Kg, 775-800 mg/Kg, 800-825 mg/Kg, 825-850 mg/Kg, 850-875 mg/Kg, 875-900 mg/Kg, 900-925 mg/Kg, 925-950 mg/Kg, 950-975 mg/Kg, 975-1000 mg/Kg, 1000-1025 mg/Kg, 1025-1050 mg/Kg, 1050-1075 mg/Kg, 1075-1100 mg/Kg, 1100-1125 mg/Kg, 1125-1150 mg/Kg, 1150-1175 mg/Kg, 1175-1200 mg/Kg, 1200-1225 mg/Kg, 1225-1250 mg/Kg, 1250-1275 mg/Kg, 1275-1300 mg/Kg, 1300-1325 mg/Kg, 1325-1350 mg/Kg, 1350-1375 mg/Kg, 1375-1400 mg/Kg, 1400-1425 mg/Kg, 1425-1450 mg/Kg, 1450-1475 mg/Kg, 1475-1500 mg/Kg, 1500-1525 mg/Kg, 1525-1550 mg/Kg, 1550-1575 mg/Kg, 1575-1600 mg/Kg, 1600-1625 mg/Kg, 1625-1650 mg/Kg, 1650-1675 mg/Kg, 1675-1700 mg/Kg, 1700-1725 mg/Kg, 1725-1750 mg/Kg, 1750-1775 mg/Kg, 1775-1800 mg/Kg, 1800-1825 mg/Kg, 1825-1850 mg/Kg, 1850-1875 mg/Kg, 1875-1900 mg/Kg, 1900-1925 mg/Kg, 1925-1950 mg/Kg, 1950-1975 mg/Kg, 1975-2000 mg/Kg, 2000-2025 mg/Kg, 2025-2050 mg/Kg, 2050-2075 mg/Kg, 2075-2100 mg/Kg, 2100-2125 mg/Kg, 2125-2150 mg/Kg, 2150-2175 mg/Kg, 2175-2200 mg/Kg, 2200-2225 mg/Kg, 2225-2250 mg/Kg, 2250-2275 mg/Kg, 2275-2300 mg/Kg, 2300-2325 mg/Kg, 2325-2350 mg/Kg, 2350-2375 mg/Kg, 2375-2400 mg/Kg, 2400-2425 mg/Kg, 2425-2450 mg/Kg, 2450-2475 mg/Kg, 2475-2500 mg/Kg, 2500-2525 mg/Kg, 2525-2550 mg/Kg, 2550-2575 mg/Kg, 2575-2600 mg/Kg, 2600-2625 mg/Kg, 2625-2650 mg/Kg, 2650-2675 mg/Kg, 2675-2700 mg/Kg, 2700-2725 mg/Kg, 2725-2750 mg/Kg, 2750-2775 mg/Kg, 2775-2800 mg/Kg, 2800-2825 mg/Kg, 2825-2850 mg/Kg, 2850-2875 mg/Kg, 2875-2900 mg/Kg, 2900-2925 mg/Kg, 2925-2950 mg/Kg, 2950-2975, and 2975-3000 milligrams of copper per kilogram of soil. In other embodiments of the present disclosure, copper micronutrient is applied to a locus to achieve a soil copper concentration of about: 25 mg/Kg, 50 mg/Kg, 75 mg/Kg, 100 mg/Kg, 125 mg/Kg, 150 mg/Kg, 175 mg/Kg, 200 mg/Kg, 225 mg/Kg, 250 mg/Kg, 275 mg/Kg, 300 mg/Kg, 325 mg/Kg, 350 mg/Kg, 375 mg/Kg, 400 mg/Kg, 425 mg/Kg, 450 mg/Kg, 475 mg/Kg, 500 mg/Kg, 525 mg/Kg, 550 mg/Kg, 575 mg/Kg, 600 mg/Kg, 625 mg/Kg, 650 mg/Kg, 675 mg/Kg, 700 mg/Kg, 725 mg/Kg, 750 mg/Kg, 775 mg/Kg, 800 mg/Kg, 825 mg/Kg, 850 mg/Kg, 875 mg/Kg, 900 mg/Kg, 925 mg/Kg, 950 mg/Kg, 975 mg/Kg, 1000 mg/Kg, 1025 mg/Kg, 1050 mg/Kg, 1075 mg/Kg, 1100 mg/Kg, 1125 mg/Kg, 1150 mg/Kg, 1175 mg/Kg, 1200 mg/Kg, 1225 mg/Kg, 1250 mg/Kg, 1275 mg/Kg, 1300 mg/Kg, 1325 mg/Kg, 1350 mg/Kg, 1375 mg/Kg, 1400 mg/Kg, 1425 mg/Kg, 1450 mg/Kg, 1475 mg/Kg, 1500 mg/Kg, 1525 mg/Kg, 1550 mg/Kg, 1575 mg/Kg, 1600 mg/Kg, 1625 mg/Kg, 1650 mg/Kg, 1675 mg/Kg, 1700 mg/Kg, 1725 mg/Kg, 1750 mg/Kg, 1775 mg/Kg, 1800 mg/Kg, 1825 mg/Kg, 1850 mg/Kg, 1875 mg/Kg, 1900 mg/Kg, 1925 mg/Kg, 1950 mg/Kg, 1975 mg/Kg, 2000 mg/Kg, 2025 mg/Kg, 2050 mg/Kg, 2075 mg/Kg, 2100 mg/Kg, 2125 mg/Kg, 2150 mg/Kg, 2175 mg/Kg, 2200 mg/Kg, 2225 mg/Kg, 2250 mg/Kg, 2275 mg/Kg, 2300 mg/Kg, 2325 mg/Kg, 2350 mg/Kg, 2375 mg/Kg, 2400 mg/Kg, 2425 mg/Kg, 2450 mg/Kg, 2475 mg/Kg, 2500 mg/Kg, 2525 mg/Kg, 2550 mg/Kg, 2575 mg/Kg, 2600 mg/Kg, 2625 mg/Kg, 2650 mg/Kg, 2675 mg/Kg, 2700 mg/Kg, 2725 mg/Kg, 2750 mg/Kg, 2775 mg/Kg, 2800 mg/Kg, 2825 mg/Kg, 2850 mg/Kg, 2875 mg/Kg, 2900 mg/Kg, 2925 mg/Kg, 2950 mg/Kg, 2975 mg/Kg, and 3000 milligrams of copper per kilogram of soil.

Copper compounds vary in solubility. Therefore, the plant-available amounts of copper will vary in the soil in accordance to the mineral form of copper and their respective solubility. For example, copper fertilizers might be as much as 50% soluble while copper fallout from a smelter might be less than 1% soluble. Likewise, soil acidity is an important control on copper solubility. For a given total elemental amount of copper, the plant availability (solubility) may vary by orders of magnitude in accordance with the soil pH.

In some embodiments of the present disclosure, the micronutrients comprising copper or a copper source is applied to a locus to achieve a soluble copper soil concentration of about: 0.01 mg/L, 0.02 mg/L, 0.03 mg/L, 0.04 mg/L, 0.05 mg/L, 0.06 mg/L, 0.07 mg/L, 0.08 mg/L, 0.09 mg/L, 0.10 mg/L, 0.15 mg/L, 0.20 mg/L, 0.25 mg/L, 0.30 mg/L, 0.35 mg/L, 0.40 mg/L, 0.45 mg/L, 0.50 mg/L, 0.55 mg/L, 0.60 mg/L, 0.65 mg/L, 0.70 mg/L, 0.75 mg/L, 0.80 mg/L, 0.85 mg/L, 0.90 mg/L, 0.95 mg/L, 1.00 mg/L, 1.50 mg/L, 2.00 mg/L, 2.50 mg/L, 3.00 mg/L, 3.50 mg/L, 4.00 mg/L, 4.50 mg/L, 5.00 mg/L, 5.50 mg/L, 6.00 mg/L, 6.50 mg/L, 7.00 mg/L, 7.50 mg/L, 8.00 mg/L, 8.50 mg/L, 9.00 mg/L, 9.50 mg/L, 10.00 mg/L, 11.00 mg/L, 12.00 mg/L, 13.00 mg/L, 14.00 mg/L, 15.00 mg/L, 16.00 mg/L, 17.00 mg/L, 18.00 mg/L, 19.00 mg/L, 20.00 mg/L, 21.00 mg/L, 22.00 mg/L, 23.00 mg/L, 24.00 mg/L, 25.00 mg/L, 26.00 mg/L, 27.00 mg/L, 28.00 mg/L, 29.00 mg/L, 30.00 mg/L, 31.00 mg/L, 32.00 mg/L, 33.00 mg/L, 34.00 mg/L, 35.00 mg/L, 36.00 mg/L, 37.00 mg/L, 38.00 mg/L, 39.00 mg/L, 40.00 mg/L, 41.00 mg/L, 42.00 mg/L, 43.00 mg/L, 44.00 mg/L, 45.00 mg/L, 46.00 mg/L, 47.00 mg/L, 48.00 mg/L, 49.00 mg/L, and 50.00 mg/L of soil.

In other embodiments of the present disclosure, the micronutrients comprising copper or a copper source is applied to a locus to achieve soluble copper soil concentration ranges as follows (including any/all concentrations between these ranges): 0.01-0.02 mg/L, 0.02-0.03 mg/L, 0.03-0.04 mg/L, 0.04-0.05 mg/L, 0.05-0.06 mg/L, 0.06-0.07 mg/L, 0.07-0.08 mg/L, 0.08-0.09 mg/L, 0.09-0.10 mg/L, 0.10-0.15 mg/L, 0.15-0.20 mg/L, 0.20-0.25 mg/L, 0.25-0.30 mg/L, 0.30-0.35 mg/L, 0.35-0.40 mg/L, 0.40-0.45 mg/L, 0.45-0.50 mg/L, 0.50-0.55 mg/L, 0.55-0.60 mg/L, 0.60-0.65 mg/L, 0.65-0.70 mg/L, 0.70-0.75 mg/L, 0.75-0.80 mg/L, 0.80-0.85 mg/L, 0.85-0.90 mg/L, 0.90-0.95 mg/L, 0.95-1.00 mg/L, 1.00-1.50 mg/L, 1.50-2.00 mg/L, 2.00-2.50 mg/L, 2.50-3.00 mg/L, 3.00-3.50 mg/L, 3.50-4.00 mg/L, 4.00-4.50 mg/L, 4.50-5.00 mg/L, 5.00-5.50 mg/L, 5.50-6.00 mg/L, 6.00-6.50 mg/L, 6.50-7.0 mg/L, 7.00-7.50 mg/L, 7.50-8.0 mg/L, 8.00-8.50 mg/L, 8.50-9.0 mg/L, 9.00-9.50 mg/L, 9.50-10.00 mg/L, 10.00-10.50 mg/L, 10.50-11.00 mg/L, 11.00-11.50 mg/L, 11.50-12.00 mg/L, 12.00-13.00 mg/L, 13.00-14.00 mg/L, 14.00-15.00 mg/L, 15.00-16.00 mg/L, 16.00-17.00 mg/L, 17.00-18.00 mg/L, 18.00-19.00 mg/L, 19.00-20.00 mg/L, 20.00-21.00 mg/L, 21.00-22.00 mg/L, 22.00-23.00 mg/L, 23.00-24.00 mg/L, 24.00-25.00 mg/L, 25.00-26.00 mg/L, 26.00-27.00 mg/L, 27.00-28.00 mg/L, 28.00-29.00 mg/L, 29.00-30.00 mg/L, 30.00-31.00 mg/L, 31.00-32.00 mg/L, 32.00-33.00 mg/L, 33.00-34.00 mg/L, 34.00-35.00 mg/L, 35.00-36.00 mg/L, 36.00-37.00 mg/L, 37.00-38.00 mg/L, 38.00-39.00 mg/L, 39.00-40.00 mg/L, 40.00-41.00 mg/L, 41.00-42.00 mg/L, 42.00-43.00 mg/L, 43.00-44.00 mg/L, 44.00-45.00 mg/L, 45.00-46.00 mg/L, 46.00-47.00 mg/L, 47.00-48.00 mg/L, 48.00-49.00 mg/L, and 49.00-50.00 mg/L of soil. In one embodiment, the micronutrients comprising copper or a copper source is applied to a locus to achieve soluble copper soil concentration of about 0.1 mg/L to about 50 mg/L. In one embodiment, the micronutrients comprising copper or a copper source is applied to a locus to achieve soluble copper soil concentration of about 0.1 mg/L to about 5 mg/L.

Many variations of the micronutrients will occur to those skilled in the art. Some variations include plant micronutrients in addition to or in place of boron. Known plant micronutrients include boron, copper, zinc, manganese, iron, chlorine and molybdenum. Other variations call for variations and ranges of the concentrations of each element being applied, and the compound source for the micronutrient. See, e.g., Table 1 supra. Other variations include application of combinations of more than one plant micronutrient. Other variations include application of micronutrients with macronutrients nitrogen (N), phosphorous (P) or potassium (K). Additional variations include the targeted invasive plant species subject to control or eradication. Additional variations include the type of site or landscape to which the methods and compositions of this disclosure may be applied. There are many different techniques, which may be used to apply or distribute a specific form of the compounds (whether liquid or dry). The application rate can be adjusted across a range from low to high concentration to reduce, control, and eliminate/eradicate a particular invasive plant species or species. The application rate can be adjusted and applied to protect against future invasion by invasive species. The application rate can also be applied at such levels to cause a condition for all plants resulting in bare ground. All such variations are intended to be within the scope and spirit of the disclosure.

Although some embodiments are shown to include certain features or steps, the applicant specifically contemplates that any feature or step disclosed herein may be used together or in combination with any other feature or step in any embodiment of the disclosure. It is also contemplated that any feature or step may be specifically excluded from any embodiment of the disclosure.

The utility of the micronutrients is multi-fold and includes but is not limited to:
a) can comprise non-synthetic, non-organic naturally occurring inorganic earth elements, which are known plant nutrients, non-carcinogenic and non-impairing to soil and water resources at the low concentrations involved in this disclosure;
b) can be relatively inexpensive, easily accessible materials, combined with relatively simplified methods of utilization;
c) boron sources such as boric acid, borate salts or boron (and the other micronutrients of the disclosure) are neither classified as endocrine disruptors nor are they currently on the list of compounds being screened by the U.S. EPA as part of the Endocrine Disruptor Screening Program (EDSP) for potential in humans;
d) boron sources such as boric acid and borate salts (and the other micronutrients of the disclosure) are classified by the U.S. EPA as “not likely to be carcinogenic to humans” under the 2005 carcinogen assessment guidelines;
e) no reported risk from occupational exposures studies indicating the carcinogenicity of boric acid, borate salts or boron (and the other micronutrients of the disclosure);
f) the effectiveness and use of the subject disclosure are facilitated by the application of relatively small/minute amounts of material required to treat large areas of land;
g) elective to weedy plant species, allowing the micronutrients to be used on land parcels of mixed plant communities without significant adverse impact on desired plant species; and,
h) application of low concentrations of micronutrient-containing compositions to plants, seeds, seedlings or soil which results in responses of weedy species while minimizing impact to existing desirable native plant species.

The low rates of the application for the micronutrients are also manifested in low unit cost per land area treated.

Extensive research has documented that plants are often sensitive to relatively minute concentrations or exposures to unique synthetic compounds or combinations of naturally occurring elements, including micronutrients. For example, glyphosate (aka ROUNDUP®, a synthetic Monsanto/Bayer product) is effective at causing photosynthetic disruption in chlorophyllitic plants at an application rate of as little as 0.75 pounds active ingredient per acre, which equates to only approximately 8 mg/square foot of application, equivalent to approximately 14 ppm application rate. The American Phytopathological Society (APS) reported that micronutrients are generally toxic when present in high amounts, although ‘high concentrations’ are not clearly defined, and little toxicity have been reported at exceptionally low micronutrient concentrations. This occurrence is known as micronutrient toxicity syndrome (MTS). As an example, Jong et al. (1996) reported micro-nutrient toxicity in French marigold induced from boron, copper, iron, manganese, molybdenum, and zinc at concentrations of 0.5, 4, 2, 1 and 5 mg/L, respectively. In addition, plants can vary considerably from species to species in their susceptibility to nutrient toxicities. For example, Lee and others (1996) reported inducing seed geranium (Pelargonium×hortorum) micronutrient toxicity symptoms by applying nutrient solutions containing 0.5 mg/L B, Cu, or Zn, or as little as 0.25 mg/L Mo, in combination with nitrogen, phosphorus, and potassium. Micronutrient toxicity has also been reported for Begonia, Chrysanthemum, Geraniums, Marigolds, Poinsettia, and Lilium longiflorum (Hammer et al. 1987; Jong-Myung et al. 1996; Lee et al. 1996; Marousky, 1981).

The toxic effects of excessive application of nutrients to agricultural and horticultural crops are well documented. Even the macronutrient nitrogen can be toxic to plants if applied in excess. Similarly, excessive application of micronutrients can cause phytotoxic effects. However, excessive micronutrient concentrations are rarely found in native soils, with the exception of mineralized areas. In mineral soils, release of micronutrients is usually quite slow. Much of the available soil micronutrients are held rather tightly by soil organic material or as solid mineral matter and thus toxicity to plants is not a frequent occurrence under ‘field’ conditions. For the majority of landscape plants micronutrient concentrations in the saturated soil paste extract between 0.15-0.5 parts per million are desired. Depending on plant sensitivity, some of these elements can be toxic at soil test concentrations above one part per million. Nutrient toxicity does not often occur in most arable soils. Such toxicity exerts different effects on very diverse processes in vascular plants, such as altered metabolism, reduced root cell division, lower leaf chlorophyll contents and photosynthetic rates, and decreased lignin and suberin levels, among others (Nable et. al. 1997; Reid 2007b). Accordingly, reduced growth of shoots and roots is typical of plants exposed to high micronutrient levels (Nable et al. 1990). Referring to Keren and Bingham (1985), safe concentrations of micro-nutrients in irrigation water range from 0.3 mg/L for sensitive plants [i.e. avocado (Persea americana), apple (Malus domestica) and bean (Phaseolus vulgaris)], 1-2 mg/L for semi tolerant plants [oat (Avena saliva), maize (Zea mays), potato (Solanum tuberosum)], and 2-4 mg/L for tolerant plants [i.e. carrot (Daucus carota), alfalfa (Medicago saliva) and sugar beet (Beta vulgaris)].

### (C) Agricultural Compositions

The present disclosure provides a composition comprising (A) any one of the micronutrients disclosed herein and (C) another agricultural composition. The present disclosure also provides a combination comprising (A) and (C) as described herein. The present disclosure also provides methods for using the composition or the combination of (A) and (C) as described herein. The present disclosure further provides methods for using the composition or the combination of (A) and (C) as described herein, for a selective treatment of invasive species.

### Micronutrients and Macronutrients

In one embodiment, the agricultural composition (C) comprises micronutrients. In some embodiments, micronutrient is selected from copper, zinc, iron, boron, manganese, molybdenum, or chlorine.

In one embodiment, the agricultural composition (C) comprises boron or a boron source. In some embodiments, the agricultural composition (C) is applied at a rate to provide about 10 lbs. elemental boron to about 50 lbs. elemental boron per acre of land, or any value and subranges there between. In one embodiment, the agricultural composition (C) is applied at a rate to provide average of about 20 lbs. elemental boron. In some embodiments, the agricultural composition (C) is applied at a rate to provide fertility level of about 1 lb. elemental boron to about 10 lbs. elemental boron per acre of land. In some embodiments, the agricultural composition (C) is applied at a rate to provide an average fertility level of about 3 lbs. of elemental boron per an acre of land.

In one embodiment, the agricultural composition (C) comprises copper or a copper source. In some embodiments, the agricultural composition (C) is applied at a rate to provide about 5 lbs. elemental copper to about 20 lbs. elemental copper per acre of land, or any value and subranges there between. In one embodiment, the agricultural composition (C) is applied at a rate to provide average of about 10 lbs. elemental copper. In some embodiments, the agricultural composition (C) is applied at a rate to provide fertility level of about 0.75 lb. elemental copper to about 5 lbs. elemental copper per acre of land. In some embodiments, the agricultural composition (C) is applied at a rate to provide an average fertility level of about 2 lbs. of elemental copper per an acre of land.

In one embodiment, the agricultural composition (C) comprises an iron or an iron source. In some embodiments, the agricultural composition (C) is applied at a rate to provide about 5 lbs. elemental iron to about 20 lbs. elemental iron per acre of land, or any value and subranges there between. In one embodiment, the agricultural composition (C) is applied at a rate to provide average of about 10 lbs. elemental iron. In some embodiments, the agricultural composition (C) is applied at a rate to provide fertility level of about 0.25 lb. elemental iron to about 5 lbs. elemental iron per acre of land. In some embodiments, the agricultural composition (C) is applied at a rate to provide an average fertility level of about 1.5 lbs. of elemental iron per an acre of land.

In one embodiment, the agricultural composition (C) comprises a manganese or a manganese source. In some embodiments, the agricultural composition (C) is applied at a rate to provide about 5 lbs. elemental manganese to about 15 lbs. elemental manganese per acre of land, or any value and subranges there between. In one embodiment, the agricultural composition (C) is applied at a rate to provide average of about 10 lbs. elemental manganese. In some embodiments, the agricultural composition (C) is applied at a rate to provide fertility level of about 0.75 lb. elemental manganese to about 4.65 lbs. elemental manganese per acre of land. In some embodiments, the agricultural composition (C) is applied at a rate to provide an average fertility level of about 2.3 lbs. of elemental manganese per an acre of land.

In one embodiment, the agricultural composition (C) comprises a molybdenum or a molybdenum source. In some embodiments, the agricultural composition (C) is applied at a rate to provide about 2 lbs. elemental molybdenum to about 10 lbs. elemental molybdenum per acre of land, or any value and subranges there between. In one embodiment, the agricultural composition (C) is applied at a rate to provide average of about 5 lbs. elemental molybdenum. In some embodiments, the agricultural composition (C) is applied at a rate to provide fertility level of about 0.78 lb. elemental molybdenum to about 6.6 lbs. elemental molybdenum per acre of land. In some embodiments, the agricultural composition (C) is applied at a rate to provide an average fertility level of about 2.6 lbs. of elemental molybdenum per an acre of land.

In one embodiment, the agricultural composition (C) comprises a zinc or a zinc source. In some embodiments, the agricultural composition (C) is applied at a rate to provide about 5 lbs. elemental zinc to about 20 lbs. elemental zinc per acre of land, or any value and subranges there between. In one embodiment, the agricultural composition (C) is applied at a rate to provide average of about 10 lbs. elemental zinc. In some embodiments, the agricultural composition (C) is applied at a rate to provide fertility level of about 0.5 lb. elemental zinc to about 7 lbs. elemental zinc per acre of land. In some embodiments, the agricultural composition (C) is applied at a rate to provide an average fertility level of about 2.25 lbs. of elemental zinc per an acre of land.

In one embodiment, the agricultural composition (C) comprises macronutrients. In some embodiments, macronutrient is selected from nitrogen, phosphorous, or potassium. In some embodiments, the agricultural composition (C) comprises nitrogen, phosphorous, and potassium.

In one embodiment, the agricultural composition (C) comprises an inorganic nitrogen source. In some embodiments, the agricultural composition (C) is applied at a rate to provide about 100 lbs. inorganic nitrogen to about 300 lbs. inorganic nitrogen per acre of land, or any value and subranges there between. In one embodiment, the agricultural composition (C) is applied at a rate to provide average of about 200 lbs. inorganic nitrogen. In some embodiments, the agricultural composition (C) is applied at a rate to provide fertility level of about 10 lbs. inorganic nitrogen to about 138 lbs. inorganic nitrogen per acre of land. In some embodiments, the agricultural composition (C) is applied at a rate to provide an average fertility level of about 56 lbs. of inorganic nitrogen per an acre of land.

In one embodiment, the agricultural composition (C) comprises an organic nitrogen source. In some embodiments, the agricultural composition (C) is applied at a rate to provide about 200 lbs. organic nitrogen to about 2000 lbs. organic nitrogen per acre of land, or any value and subranges there between. In one embodiment, the agricultural composition (C) is applied at a rate to provide average of about 500 lbs. organic nitrogen. In some embodiments, the agricultural composition (C) is applied at a rate to provide fertility level of about 2 lbs. organic nitrogen to about 200 lbs. organic nitrogen per acre of land. In some embodiments, the agricultural composition (C) is applied at a rate to provide an average fertility level of about 27.5 lbs. of organic nitrogen per an acre of land.

In one embodiment, the agricultural composition (C) comprises a phosphorous source. In some embodiments, the agricultural composition (C) is applied at a rate to provide about 50 lbs. phosphorous to about 200 lbs. phosphorous per acre of land, or any value and subranges there between. In one embodiment, the agricultural composition (C) is applied at a rate to provide average of about 100 lbs. phosphorous. In some embodiments, the agricultural composition (C) is applied at a rate to provide fertility level of about 10 lbs. phosphorous to about 100 lbs. phosphorous per acre of land. In some embodiments, the agricultural composition (C) is applied at a rate to provide an average fertility level of about 35 lbs. of phosphorous per an acre of land.

In one embodiment, the agricultural composition (C) comprises a potassium source. In some embodiments, the agricultural composition (C) is applied at a rate to provide about 125 lbs. potassium to about 500 lbs. potassium per acre of land, or any value and subranges there between. In one embodiment, the agricultural composition (C) is applied at a rate to provide average of about 250 lbs. potassium. In some embodiments, the agricultural composition (C) is applied at a rate to provide fertility level of about 25 lbs. potassium to about 200 lbs. potassium per acre of land. In some embodiments, the agricultural composition (C) is applied at a rate to provide an average fertility level of about 75 lbs. of potassium per an acre of land.

In one embodiment, the agricultural composition (C) comprises boron or a boron source

In one embodiment, the agricultural composition (C) comprises micronutrients and macronutrients.

In one embodiment, the agricultural composition (C) is a multi-element fertilizer. In one embodiment, the multi-element fertilizer comprises micronutrients and macronutrients. In some embodiments, the multi-element fertilizer comprises nitrogen, phosphorous, and potassium and at least two micronutrients selected from copper, zinc, iron, boron, manganese, molybdenum, or chlorine. In some embodiments, the multi-element fertilizer comprises nitrogen, phosphorous, potassium, copper, zinc, iron, boron, manganese, and molybdenum. In one embodiment, the multi-element fertilizer is Mora-Leaf 20-20-20.

In one embodiment, the agricultural composition (C) comprising micronutrient and/or macronutrient is an organic fertilizer or an inorganic fertilizer. In some embodiments, the organic fertilizer or the inorganic fertilizer comprises calcium, magnesium, sulfur, carbon, hydrogen or oxygen elements.

In some embodiments, the agricultural composition (C) comprising micronutrients and/or macronutrients is in an amount less than 10% of weight of the micronutrients (A) in the combination. In some embodiments, the agricultural composition (C) comprising micronutrients and/or macronutrients is in an amount less than 5% of weight of the micronutrients (A) in the combination. In some embodiments, the agricultural composition (C) comprising micronutrients and/or macronutrients is in an amount less than 5%, less than 4%, less than 3%, less than 2%, or less than 1% of weight of the micronutrients (A) in the combination.

### Adjuvant

In one embodiment, the agricultural composition (C) comprises an adjuvant. In one embodiment, the agricultural composition (C) comprising an adjuvant is provided in a liquid formulation. In one embodiment, the adjuvant is selected from a wetting agent, an activator, a crop oil concentrate, a buffer, a marker dye or a surfactant.

In one embodiment, the wetting agent is selected from polyoxyethylene alkylphenol ether sulfates formaldehyde condensate, polyoxyethylene alkyl phenol ether phosphate, polyoxyethylene phenethyl phenol ether phosphates, alkyl sulfates salts, alkyl sulfonates, naphthalene sulfonate, or TERSPERSE2500 (Huntsman Corp.). In some embodiments, the wetting agent is wetting agent is selected from organosilicones (e.g., Sylgard 309 from Dow Corning Corporation or Silwet L77 from Union Carbide Corporation) including polyalkylene oxide modified polydimethylsiloxane (Silwet L7607 from Union Carbide Corporation), methylated seed oil, and ethylated seed oil (e.g., Scoil from Agsco or Hasten from Wilfarm), alkylpolyoxyethylene ethers (e.g., Activator 90), alkylarylalolates (e.g., APSA 20), alkylphenol ethoxylate and alcohol alkoxylate surfactants (e.g., products sold by Huntsman), fatty acid, fatty ester and fatty amine ethoxylates (e.g., products sold by Huntsman), products sold by Cognis such as sorbitan and ethoxylated sorbitan esters, ethoxylated vegetable oils, alkyl, glycol and glycerol esters and glycol ethers, tristyrylphenol ethoxylates, anionic surfactants such as sulphonates, such as sulphosuccinates, alkylaryl sulphonates, alkyl naphthalene sulphonates (e.g., products sold by Adjuvants Unlimited), calcium alkyl benzene sulphonates, and phosphate esters (e.g., products sold by Huntsman Chemical or BASF), as salts of sodium, potassium, ammonium, magnesium, triethanolamine (TEA), etc. Other specific examples of the above sulfates include ammonium lauryl sulfate, magnesium lauryl sulfate, sodium 2-ethyl-hexyl sulfate, sodium actyl sulfate, sodium oleyl sulfate, sodium tridecyl sulfate, triethanolamine lauryl sulfate, ammonium linear alcohol, ether sulfate ammonium nonylphenol ether sulfate, and ammonium monoxynol-4-sulfate. Other examples of wetting agents or dispersing agents include, but are not limited to, sulfo succinamates, disodium N-octadecylsulfo-succinamate; tetrasodium N-(1,2-dicarboxyethyl)-N-octadecylsulfo-succinamate: diamyl ester of sodium sulfosuccinic acid; dihexyl ester of sodium sulfosuccinic acid; and dioctyl esters of sodium sulfosuccinic acid, dihexyl ester of sodium sulfosuccinic acid: and dioctyl esters of sodium sulfosuccinic acid; castor oil and fatty amine ethoxylates, including sodium, potassium, magnesium or ammonium salts thereof. Dispersants and wetting agents also include natural emulsifiers, such as lecithin, fatty acids (including sodium, potassium or ammonium salts thereof) and ethanolamides and glycerides of fatty acids, such as coconut diethanolamide and coconut mono- and diglycerides, sodium polycarboxylate; sodium salt of naphthalene sulfonate condensate; sodium lignosulfonates, aliphatic alcohol ethoxylates; tristyrylphenol ethoxylates and esters: ethylene oxide-propylene oxide block copolymers, sodium dodecylbenzene sulfonate; N-oleyl N-methyl taurate; 1,4-dioctoxy-1,4-dioxo-butane-2-sulfonic acid; sodium lauryl sulphate; sodium dioctyl sulphosuccinate; aliphatic alcohol ethoxylates; nonylphenol ethoxylates, sodium taurates, and sodium or ammonium salts of maleic anhydride copolymers, lignosulfonic acid formulations or condensed sulfonate sodium, potassium, magnesium or ammonium salts, polyvinylpyrrolidone (available commercially as Polyplasdone XL-10 from International Specialty Products or as Kollidon C1 M-10 from BASF Corporation), polyvinyl alcohols, modified or unmodified starches, methylcellulose, hydroxyethyl or hydroxypropyl methylcellulose, carboxymethyl methylcellulose, or combinations, such as a mixture of either lignosulfonic acid formulations or condensed sulfonate sodium, potassium, magnesium or ammonium salts with polyvinylpyrrolidone (PVP).

In one embodiment, the activator is a polyoxyalkylene polysiloxane surfactant, a linear alkylbenzene sulfonate, an ethoxylated sorbitan ester such as a polyoxyethylene sorbitans, an alcohol ethoxylate such as an alcohol C5-15 ethoxylate, or combinations thereof. In one embodiment, the activator is an ammonium salt selected from ammonium nitrate, ammonium chloride, ammonium carbonate, ammonium bicarbonate, mono ammonium phosphate, di ammonium phosphate, tri ammonium phosphate, ammonium sulfate, or combinations thereof.

In one embodiment, the crop oil concentrate (COC) comprises paraffinic petroleum-based oils (blend of crop oils) and non-ionic surfactants. In one embodiment, the COC comprises paraffinic oil and a surfactant or an emulsifier. In one embodiment, the COC is paraffinic oil formulated with one or more of: surfactant blend, polyol fatty acid esters and/or polyethoxylated derivatives, emulsifiers, nitrogen solution blend, ethoxylated alcohol, water conditioners, or ethoxylated alkyl phosphate esters.

In one embodiment, the buffer may be selected from ammonium salt/ammonia, deprotonated lysine/doubly deprotonated lysine, potassium phosphate monobasic/potassium phosphate dibasic, potassium bicarbonate/potassium carbonate, boric acid/borax, potassium phosphate dibasic/potassium phosphate tribasic, ammonium citrate tribasic, or potassium phosphate monobasic/potassium phosphate dibasic systems.

In one embodiment, the marker dye is an organic dye. In some embodiments, the marker dye is a naturally occurring dye. In one embodiment, a marker dye comprises beet juice. In some embodiments, the marker dye is Fluorescent Red Liquid Concentrate and Hi-Light™ Blue.

### Biological Compounds or Related Carbon-Based Organic Compounds

In one embodiment, the agricultural composition (C) comprises a biological compound or a related carbon-based organic compound. In one embodiment, the biological compound or the related carbon-based organic compound is selected from fungus, spores, bacteria, soluble carbon-based solids or liquids (including sugar), organic matter, mycorrhizae, biochar, hydromulch, hydraulic mulch, waste products such as sawdust, manure, straw, corn stover, shells, hulls, or meal.

In one embodiment, the agricultural composition (C) comprises fungi, spores and/or bacterial inoculant. In one embodiment, the agricultural composition (C) comprises spores and/or bacterial inoculant. In one embodiment, the agricultural composition (C) comprises a Pseudomonas fluorescens bacterial strain. In one embodiment, the Pseudomonas fluorescens bacterial strain is Pseudomonas fluorescens strain ACK55, Pseudomonas fluorescens strain NKK78 or Pseudomonas fluorescens strain SMK69. See U.S. Pat. No. 9,578,884.

In one embodiment, the agricultural composition (C) comprising spores and/or bacterial inoculant is applied at a rate to provide from about 1 gram of spores or bacterial inoculant per one acre of land to about 5000 grams of spores or bacterial inoculant per one acre of land, or at any value and subranges there between.

In one embodiment, the agricultural composition (C) comprises soluble carbon or soluble carbon source. In one embodiment, the agricultural composition (C) comprises soluble sugar. In one embodiment, the soluble sugar is sucrose. See McLendon et al. Oecologia (1992) 91: 312-317. In one embodiment, the agricultural composition (C) comprising sucrose is applied at a rate from about 1000 kg C/ha/yr to about 2000 kg C/ha/yr, or at any value and subranges there between. In one embodiment, the agricultural composition (C) comprising sucrose is applied at a rate from about 1600 kg C/ha/yr. In one embodiment, the agricultural composition (C) comprising sucrose is applied at a rate from about 10 kg C/ha/yr to about 1000 kg C/ha/yr, or at any value and subranges there between. In one embodiment, the agricultural composition (C) comprising sucrose is applied at a rate from about 10 kg C/ha/yr to about 500 kg C/ha/yr, or at any value and subranges there between.

In one embodiment, the agricultural composition (C) comprising soluble carbon or soluble carbon source is applied at a rate from about 1 lb. of soluble carbon per one acre of land to about 1000 lbs. of soluble carbon per one acre of land, or at any value and subranges there between. In one embodiment, the agricultural composition (C) comprising soluble carbon or soluble carbon source is applied at a rate from about 10 lb. of soluble carbon per one acre of land to about 1000 lbs. of soluble carbon per one acre of land, or at any value and subranges there between.

In one embodiment, the agricultural composition (C) comprises organic matter. In one embodiment, the organic matter is compost or related decomposed organics used for vegetation enhancement. In one embodiment, the agricultural composition (C) comprising organic matter is applied at a rate from about 0.01 ton of organic matter per one acre of land to about 1000 tons of organic matter per one acre of land, or at any value and subranges there between. In one embodiment, the agricultural composition (C) comprising organic matter is applied at a rate from about 1 ton of organic matter per one acre of land to about 100 tons of organic matter per one acre of land, or at any value and subranges there between.

In one embodiment, the agricultural composition (C) comprises mycorrhizae. In one embodiment, mycorrhizae are a commercial inoculum developed for plant growth augmentation. In one embodiment, the agricultural composition (C) comprising mycorrhizae is applied at a rate from about 1 lb. of mycorrhizae per one acre of land to about 1000 lbs. of mycorrhizae per one acre of land, or at any value and subranges there between. In one embodiment, the agricultural composition (C) comprising mycorrhizae is applied at a rate from about 10 lb. of mycorrhizae per one acre of land to about 1000 lbs. of mycorrhizae per one acre of land, or at any value and subranges there between.

In one embodiment, the agricultural composition (C) comprises biochar. In one embodiment, biochar is a thermally degraded cellulosic material, such as wood, developed as a soil amendment. Biochar is created by the pyrolysis of biomass, which generally involves heating and/or burning of organic matter, in a reduced oxygen environment, at a predetermined rate. Such heating and/or burning is stopped when the matter reaches a charcoal like stage. Typically, biochars include porous carbonaceous materials, such as charcoal. Biochar is highly porous material. In one embodiment, the agricultural composition (C) comprising biochar is applied at a rate from about 100 lb. of biochar per one acre of land to about 1000 tons of biochar per one acre of land, or at any value and subranges there between. In one embodiment, the agricultural composition (C) comprising biochar is applied at a rate from about 500 lb. of biochar per one acre of land to about 100 tons of biochar per one acre of land, or at any value and subranges there between.

In one embodiment, the agricultural composition (C) comprises hydromulch or hydraulic mulch. In one embodiment, the application of hydromulch or hydraulic mulch comprises applying slurry of water, wood fiber mulch, and often a tackifier to prevent soil erosion. In one embodiment, the wood fiber mulch is a thermally refined wood fiber, In one embodiment, the agricultural composition (C) comprising hydromulch or hydraulic mulch is applied at a rate from about 100 lb. of hydromulch or hydraulic mulch per one acre of land to about 1000 tons of hydromulch or hydraulic mulch per one acre of land, or at any value and subranges there between. In one embodiment, the agricultural composition (C) comprising hydromulch or hydraulic mulch is applied at a rate from about 500 lb. of hydromulch or hydraulic mulch per one acre of land to about 100 tons of hydromulch or hydraulic mulch per one acre of land, or at any value and subranges there between. In one embodiment, hydraulic mulch is selected from Conwed Fibers®, Terra-Mulch®, HydroCover™, SoilCover®, EcoSolutions, Second Nature®, or Enviro-Fibers® (ProfileProducts).

In one embodiment, the agricultural composition (C) comprises sawdust. In one embodiment, sawdust is a waste material high in cellulosic carbon. In one embodiment, sawdust is generally a residue from sawmills. In one embodiment, the agricultural composition (C) comprising sawdust is applied at a rate from about 100 lb. of sawdust per one acre of land to about 1000 tons of sawdust per one acre of land, or at any value and subranges there between. In one embodiment, the agricultural composition (C) comprising sawdust is applied at a rate from about 500 lb. of sawdust per one acre of land to about 100 tons of sawdust per one acre of land, or at any value and subranges there between.

In one embodiment, the agricultural composition (C) comprises manure. In one embodiment, manure is an agricultural waste, typically from confined livestock feeding areas. In one embodiment, the agricultural composition (C) comprising manure is applied at a rate from about 100 lb. of manure per one acre of land to about 1000 tons of manure per one acre of land, or at any value and subranges there between. In one embodiment, the agricultural composition (C) comprising manure is applied at a rate from about 500 lb. of manure per one acre of land to about 100 tons of manure per one acre of land, or at any value and subranges there between.

In one embodiment, the agricultural composition (C) comprises straw. In one embodiment, straw is an agricultural waste, typically from cereal grain production. In one embodiment, the agricultural composition (C) comprising straw is applied at a rate from about 100 lb. of straw per one acre of land to about 1000 tons of straw per one acre of land, or at any value and subranges there between. In one embodiment, the agricultural composition (C) comprising straw is applied at a rate from about 500 lb. of straw per one acre of land to about 100 tons of straw per one acre of land, or at any value and subranges there between.

In one embodiment, the agricultural composition (C) comprises corn stover. In one embodiment, corn stover is waste leaves, stalks, and/or cobs of corn remaining after corn harvest. In one embodiment, the agricultural composition (C) comprising corn stover is applied at a rate from about 100 lb. of corn stover per one acre of land to about 1000 tons of corn stover per one acre of land, or at any value and subranges there between. In one embodiment, the agricultural composition (C) comprising corn stover is applied at a rate from corn stover 500 lb. of corn stover per one acre of land to about 100 tons of corn stover per one acre of land, or at any value and subranges there between.

In one embodiment, the agricultural composition (C) comprises shell, meal, and/or hulls. In one embodiment, shell, meal, and/or hulls is an agricultural waste material remaining after harvest. In one embodiment, shell, meal, and/or hulls includes, but are not limited to, seed shells, ground meal, pressed oil seed hulls, rice hulls, and related materials. In one embodiment, the agricultural composition (C) comprising hell, meal, and/or hulls is applied at a rate from about 100 lb. of hell, meal, and/or hulls per one acre of land to about 1000 tons of hell, meal, and/or hulls per one acre of land, or at any value and subranges there between. In one embodiment, the agricultural composition (C) comprising hell, meal, and/or hulls is applied at a rate from about 500 lb. of hell, meal, and/or hulls per one acre of land to about 100 tons of hell, meal, and/or hulls per one acre of land, or at any value and subranges there between.

### Inorganic Compounds

In one embodiment, the agricultural composition (C) comprises an inorganic compound. In one embodiment, the inorganic compound is selected from lime, silica, aluminosilicate, gypsum, or sulfur compound.

In one embodiment, the agricultural composition (C) comprises lime. In some embodiments, lime comprises calcium oxide, calcium hydroxide, calcium carbonate. In one embodiment, lime is selected from limestone, dolomite, calcite, cement kiln dust, limekiln dust, calcium oxide, or calcium hydroxide.

In one embodiment, the agricultural composition (C) comprising lime is applied at a rate from about 0.1 ton of lime per one acre of land to about 100 tons of lime per one acre of land, or at any value and subranges there between. In one embodiment, the agricultural composition (C) comprising lime is applied at a rate from about 1 ton of lime per one acre of land to about 10 tons of lime per one acre of land, or at any value and subranges there between.

In one embodiment, the inorganic compound is selected from calcium carbonate, calcium magnesium carbonate, calcium oxide, calcium hydroxide, cementitious waste product, or calcium sulfate.

In one embodiment, the agricultural composition (C) comprises gypsum (calcium sulfate). In one embodiment, the agricultural composition (C) comprising gypsum is applied at a rate from about 0.1 ton of gypsum per one acre of land to about 100 tons of gypsum per one acre of land, or at any value and subranges there between. In one embodiment, the agricultural composition (C) comprising gypsum is applied at a rate from about 1 ton of gypsum per one acre of land to about 10 tons of gypsum per one acre of land, or at any value and subranges there between.

In one embodiment, the agricultural composition (C) comprises a sulfur compound. In one embodiment, the sulfur compound decreases soil alkalinity. In one embodiment, the agricultural composition (C) comprising sulfur compound is applied at a rate from about 0.1 ton of sulfur compound per one acre of land to about 100 tons of sulfur compound per one acre of land, or at any value and subranges there between. In one embodiment, the agricultural composition (C) comprising sulfur compound is applied at a rate from about 1 ton of sulfur compound per one acre of land to about 10 tons of sulfur compound per one acre of land, or at any value and subranges there between.

In one embodiment, the agricultural composition (C) comprises a silica compound. In one embodiment, the agricultural composition (C) comprising silica compound is applied at a rate from about 100 lb. of silica compound per one acre of land to about 1000 tons of silica compound per one acre of land, or at any value and subranges there between. In one embodiment, the agricultural composition (C) comprising silica compound is applied at a rate from silica compound 500 lb. of silica compound per one acre of land to about 100 tons of silica compound per one acre of land, or at any value and subranges there between.

### Seeds, Seed Coating, and Seed Inoculants

In one embodiment, the agricultural composition (C) comprises a seed, seed coating, and/or a seed inoculant.

In one embodiment, the agricultural composition (C) comprising a seed, seed coating, and/or a seed inoculant is applied at a rate from about 1 lb. of a seed, a seed coating, or a seed inoculant per one acre of land to about 1000 lbs. of a seed, a seed coating, or a seed inoculant per one acre of land, or at any value and subranges there between. In one embodiment, the agricultural composition (C) comprising a seed, a seed coating, or a seed inoculant is applied at a rate from about 10 lb. of a seed, a seed coating, or a seed inoculant per one acre of land to about 1000 lbs. of a seed, a seed coating, or a seed inoculant per one acre of land, or at any value and subranges there between. In one embodiment, the rate of the application of the agricultural composition (C) comprising a seed, a seed coating, and/or a seed inoculant may depend on size of the seed and desired seed density.

Seed coating is the process of applying a biological, organic or inorganic coating to the exterior of a seed to protect the seed from harm, to aid in germination or to promote its growth. Conventional agriculture has long used microbiological seed coatings on legumes to inoculate seed and adjacent soil environment with beneficial organisms implicated in nitrogen fixation such as rhizobium. In agricultural applications, various fungicides, insecticides, symbionts, nutrients, adjuvants, phytoactive promoters, binders and polymers may be used to coat seed. Conversely, establishment of plants in harsh sites such as sagebrush restoration in arid rangeland may employ the use of coatings that include fertility augmentation such as compost. Other additives to seed coating may include calcium carbonate (primarily as a binder), activated carbon (to minimize herbicide injury to seed), and other plant extracts, polymers and adhesive products intended to aid in adherence of the desired coatings to the seed. The primary categories comprising seed coats are typically a liquid binder combined with powdered fillers and active ingredients.

Micronutrient compounds may also be used to coat seeds alone or in combination with other active ingredients (including, but not limited to, the agricultural composition (C) of the present disclosure) with the primary intent of promoting the growth of desirable (seeded) vegetation and improving the soil environment to facilitate nutrient uptake, geomicrobiological nutrient cycling, and abiotic soil conditions such as water holding and infiltration.

In some embodiments, all or most of the desired micronutrient fertilizer could be applied as a seed coating. The present disclosure teaches that about 5 to about 70 pounds of elemental boron per acre can be applied using a seed coating. For example, in order to add 40 pounds of elemental boron per acre by a seed coating, a seeding rate and species mix (i.e. micronutrient compounds and/or other active ingredients) can be consistent with normal practices for rangeland seeding. The application rate of 40 pounds of elemental boron per acre can be split with half of the micronutrient applied as a seed coating as 20.5% boron (B) and half of the boron product applied as granular fertilizer such as 15% boron (B). The 20.5% B fertilizer is powdered and highly soluble lending itself to seed coating, while the 15.0% B is larger granules amendable to application with an agricultural spreader but not as a seed coating. In one embodiment, (i) 1.02 gram of B fertilizer per square foot using 20.5% B fertilizer (corresponding to 20 pounds of B per acre) and applied by a seed coating and (ii) 1.39 gram of B fertilizer per square feet using 15.0% B fertilizer (corresponding to 20 pounds of B per acre) applied as a dry granular fertilizer can be used for the combined application rate of 40 pounds of B per acre. Thus, total 2.41 grams of B fertilizer per square foot (corresponding to 40 pounds B per acre) can be applied with 1.02 grams of 20.5% B used to seed coat 128 seeds (i.e. bluebunch wheatgrass) per square foot supplemented by 1.39 grams of 15% granular fertilizer applied to the soil surface. For example, the bluebunch wheatgrass seed is a common native perennial grass used in rangeland seeding. There are 140,000 seeds per pound and a typical seeding rate would be 40 pounds of seed per acre (that is, 128 seeds per square foot). The seeding rate might vary from 20 to 80 pounds seed per acre depending on other plant species included. In some embodiments, for seed coating about 0.01-15 grams of 20.5% B fertilizer is applied to an acceptable number of grass seeds per square foot. In some embodiments, for seed coating about 0.1-10 grams of B fertilizer is applied to an acceptable number of grass seeds per square foot. In some embodiments, for seed coating about 0.5-8 grams of B fertilizer is applied to an acceptable number of grass seeds per square foot. In some embodiments, for seed coating about 1-5 grams of B fertilizer is applied to an acceptable number of grass seeds per square foot. Higher fertilizer rates would result in thicker seed coatings. Seeds vary appreciably in size so the amount of fertilizer applied as a coating likewise may vary.

Seed coating is the practice of covering seeds with external materials to improve handling, protection, and, to a lesser extent, germination enhancement and plant establishment. Studies of seed coating have been published in the scientific literature such as Pedrini et al. (Seed Coating: Science or Marketing Spin?, Trends in Plant Science; Volume 22, Issue 2, February 2017, Pages 106-116) describing seed-coating ingredients, equipment, and various types of coating, which is hereby incorporated by reference. As one example, AgriCOTE is a seed application technology that can be used to apply various beneficial agricultural products to seed as described wildweb.co.za/CLIENTS/AdvanceSeed/seed_coating.php, the entire contents of which is hereby incorporated by reference.

### Excipients

In some embodiments, the micronutrients (A) or the agricultural composition (C) can further comprise an agriculturally acceptable excipient.

In some embodiments, an excipient is a multifunctional surfactant/dispersing agent/thickener/stabilizer which can reduce surface tension, improve plant surface adhesion, soil penetration and rewetting and/or to keep all components in a suspension. Alternatively, a separate surfactant/wetting agent and a thickener/stabilizer may be used to accomplish any or all of the above functions. In addition, an excipient can be a multifunctional chelator/dispersant/stabilizer, which may be included to chelate any of the metal ions present such as the calcium and to trap the excess calcium for later release.

In some embodiments, an excipient is a chelating agent. A chelate agent can increases the solubility of the metallic ions and favor the transportation of metallic ions inside the plant. Furthermore, after binding to the metallic ion and later on depositing the metallic ion in the place where the plant requires it, the organic part of the chelate returns to dissolve more ions, which can make the use of the micronutrients in the soil more prolonged.

In some embodiments, an excipient is a surfactant. Use of a surfactant can results in a high moisturizing ability and a capacity to decrease the superficial surface tension of the water, which facilitates assimilation of nutrients and other ingredients. On the other hand, due to the ability of the surfactant to form emulsions, the surfactant gives stability to the fertilizer.

In some embodiments, an excipient maintains a dry composition to remain flowable to the desired consistency. The dry flowable form of the micronutrient can be applied to the surface of soil containing weed seed, directly to weed seed, or to senesced or live, seed-bearing weed plants.

In some embodiments, the surfactant is selected from tertiary alkylamines and alkyletheramines, polyoxyethylene tertiary alkylamines and alkylemeramines, quaternary ammonium surfactants, pyridine and imidazoline surfactamts, polyoxyethylene alkylamine and alkyletheramine oxides, alkylbetaines, alkyl diamines and polyoxyethylene alkyl diamines. In other embodiments, the surfactant is selected from ethoxylated alcohols, ethoxylated alcohols, ethoxylated fatty esters, ethoxylated castor oil, alkoxylated glycols, ethoxylated fatty acids, carboxylated alcohols, carboxylic acids, fatty acids, ethoxlylated alkylphenols, fatty esters, lignins, blocked copolymers, EO/PO copolymers, octadecanoic acid, ammonium salt, 9-Octadecenoic acid (9Z) or potassium salt. In one embodiment, the surfactant is selected from sulfated polyoxyethylenated straight chain alcohol, polyoxyethylenated straight chain alcohol, or a sulfate of a linear primary alcohol.

### Combinations and Method of Use

Current techniques used for invasive plant species control are largely limited in their effectiveness as they are indiscriminately harmful to all existing vegetation to which they are applied (i.e. glyphosate), or are harmful to non-target species to which they are applied of the same life form as the invasive species (i.e. collateral damage to forbs with 2,4-D application). The fertilizer and weed control industries are multi-billion-dollar entities. Invasive plant management is a pervasive problem on as much as 100 million acres in the U.S., with only marginally effective control methods. The methods of the subject disclosure offer a new means to address invasive plant invasion and the associated economic losses due to diminished land productivity, yet without collateral damage to the environment.

The disclosure of combining application of a micronutrients and another agricultural composition provides a significant new tool and method for land managers to effectively control or eradicate invasive species over a wide variety of acreages and may be modified to suit site conditions, including specific plant communities.

In one embodiment, the application of a combination of a micronutrient and another agricultural composition provides synergistic control or synergistic eradication of invasive species over a wide variety of acreages and may be modified to suit site conditions, including specific plant communities. In one embodiment, synergistic control or synergistic eradication of invasive species means that the control or the eradication of invasive species with the combination is superior over methods involving the application of the micronutrients alone (as used in the combination) or the other agricultural composition alone (as used in the combination).

According to the present disclosure, any micronutrient fertilizer may be used, applied alone or in combination with other micronutrients, or even in combination with macronutrients such as nitrogen, phosphorous, and potassium.

The methods of the present disclosure use a combination of (A) a micronutrient and (C) another agricultural composition to selectively control invasive plant species. The micronutrients can effectively cause the death of live plant, seedlings, or seeds of invasive plant species, when the soluble trace element comes in contact with germinating seed or are taken up by the roots of live plants. Similarly, the micronutrients effectively cause the death of seedlings of invasive plant species, when the trace element comes in contact with the emerging seedlings. Relatively low concentrations of the micronutrients are required to be to invasive species but do not result in harm to desirable native species, or at least are less harmful over a spectrum of desirable native species.

The exact soil solution concentration that will result from any of the formulation disclosed herein is unknown because it depends on the soil and whether it is a sand, silt, or clay and how much water it holds. It is not unusual for an acre of dry soil to contain 2 million pounds of dry soil in the upper 6 inches plus 20% gravimetric water content. (400,000 pounds or ˜50,000 gallons). While the dry soil mass would not vary a great deal the amount of water in the soil might range from 10,000 to 100,000 gallons per acre. Therefore, with a 10× variation in soil water content addition of a given amount of fertilizer might result in a solution concentration that varied 10 times. Therefore, it is difficult to predict with certainty how the soil solution concentration (existing patent basis) will change in response to pragmatic applications of any one of compositions and combinations disclosed herein to control invasive plant species. Furthermore, as soon as the micronutrients (A) and or the agricultural composition (C) is added to the soil, the components of (A) and (C) are subject to crop uptake and leaching, plus the soil has preexisting amounts of soil nutrients.

In one embodiment of any one of the composition disclosed herein, the composition further comprising one or more ingredients selected from: a) a micronutrient; b) a macronutrient; c) an adjuvant; d) a biological compound or a related carbon-based organic compound; f) an inorganic compound; or g) a seed, a seed coating, or a seed inoculant.

In one embodiment of any one of the compositions disclosed herein, the micronutrient comprises boron or a copper. In one embodiment, the micronutrient comprises boron. In one embodiment, the micronutrient comprises boron in about 10% to about 30% by weight.

In one embodiment of any one of the compositions disclosed herein, the micronutrient is selected from copper, zinc, iron, boron, manganese, molybdenum, or chlorine. In one embodiment of any one of the compositions disclosed herein, the macronutrient is selected from nitrogen, phosphorous, or potassium.

In one embodiment of anyone of the composition disclosed herein, the composition further comprising an organic fertilizer or an inorganic fertilizer. In one embodiment, the organic fertilizer or the inorganic fertilizer comprises calcium, magnesium, sulfur, carbon, hydrogen or oxygen elements.

In one embodiment of any one of the compositions disclosed herein, the adjuvant is selected from a wetting agent, an activator, a crop oil concentrate, a buffer, a marker dye or a surfactant.

In one embodiment of any one of the composition disclosed herein, the biological compound and related carbon-based organic compound is selected from fungus, spores, bacteria, soluble carbon-based solids or liquids (including sugar), organic matter, mycorrhizae, biochar, hydromulch, hydraulic mulch, waste products such as sawdust, manure, straw, corn stover, shells, hulls, or meal.

In one embodiment of any one of the compositions disclosed herein, the inorganic compound is selected from lime, silica, aluminosilicate, gypsum, or sulfur compound. In one embodiment, the inorganic compound is selected from calcium carbonate, calcium magnesium carbonate, calcium oxide, calcium hydroxide, cementitious waste product, or calcium sulfate.

In one embodiment of any one of the compositions disclosed herein, the composition is in a dry granular form. In one embodiment, the composition comprises the adjuvant and the composition are a liquid.

In one embodiment of any one of the compositions disclosed herein, the composition comprises the micronutrient. In one embodiment, the composition comprises the biological compound or related carbon-based organic compound. In one embodiment, the composition comprises the inorganic compound. In one embodiment, the composition comprises the seed, the seed coating, or the seed inoculant.

In one embodiment, the present disclosure relates to an agricultural kit comprising:
(i) a micronutrient; and
(ii) an agricultural composition comprising one or more ingredients selected from a) a micronutrient; b) a macronutrient; c) a biological compound or a related carbon-based organic compound; d) an inorganic compound; or e) a seed, a seed coating, or a seed inoculant.

In one embodiment of any one of the agricultural kits disclosed herein, the agricultural composition is a liquid formulation further comprising an adjuvant.

In one embodiment of any one of the agricultural kits disclosed herein, the micronutrient comprises boron.

In one embodiment, the present disclosure relates to an agricultural combination comprising:
(i) a micronutrient; and
(ii) an agricultural composition comprising one or more ingredients selected from a) a micronutrient; b) a macronutrient; c) a biological compound or a related carbon-based organic compound; d) an inorganic compound; or e) a seed, a seed coating, or a seed inoculant.

In one embodiment of any one of the agricultural combinations disclosed herein, the agricultural composition is a liquid formulation further comprising an adjuvant.

In one embodiment of any one of the agricultural combinations disclosed herein, the micronutrient comprises boron.

In one embodiment, the present disclosure relates to a composition or a combination of the micronutrients (A) and an agricultural composition (C).

In one embodiment of any one of the agricultural combinations disclosed herein, the combination comprises a micronutrient and a macronutrient. In some embodiments, the macronutrient is nitrogen, phosphorous, and/or potassium.

In one embodiment of any one of the agricultural combinations as disclosed herein, the combination can be in a form of granular form or a coated granular form. In one embodiment, the agricultural composition can be in a granular form and the micronutrient can be applied as a coating to the granular agricultural composition. In one embodiment, the agricultural composition comprising nitrogen, phosphorous, and potassium can be in a granular form and the micronutrient can be applied as a coating to the granular form to provide the combination.

In one embodiment of any one of the agricultural combination as disclosed herein, the combination can be in a form of granular form or a coated granular form such that the release of the composition in the granular form may be delayed or modified by the coating.

In one embodiment, the present disclosure relates to a kit comprising the micronutrients (A) and an agricultural composition (C) as a separate formulation.

In one embodiment, the micronutrient (A) and the agricultural composition (C) are both in a dry formulation but provided separately. In one embodiment, the micronutrient (A) and the agricultural composition (C) are both in a dry formulation in a single composition.

In one embodiment, the micronutrient (A) and the agricultural composition (C) are both in a liquid formulation but provided separately. In one embodiment, the micronutrient (A) and the agricultural composition (C) are both in a liquid formulation in a single composition.

In one embodiment, the micronutrient (A) and the agricultural composition (C) are applied together as a single composition to the soil or to the plant requiring treatment. In one embodiment, the micronutrient (A) and the agricultural composition (C) are tank-mixing partners.

In one embodiment, the micronutrient (A) and the agricultural composition (C) are applied simultaneously but as a separate formulation to the soil or to the plant requiring treatment. In one embodiment, the micronutrient (A) and the agricultural composition (C) are applied sequentially as a separate formulation to the soil or to the plant requiring treatment. In some embodiments, the sequential application can be separated by hours, days, or months, depending on the need for treatment.

In some embodiments, the micronutrient (A) and the agricultural composition (C) are applied sequentially, wherein the micronutrient is applied in the fall and (C) is applied as directed by the product label and/or user guides.

The rates of the micronutrients (A) and the agricultural composition can be applied at any one of the rates as disclosed herein as appropriate for the soil condition in the area requiring a treatment.

The micronutrient (A) alone can be used for selective control of invasive plant species. See WO 2014/113475, the disclosure of which is hereby incorporated by reference in its entirety.

The present disclosure, in one embodiment, relates to a method of controlling invasive plant species by applying the micronutrient (A) and the agricultural composition (C). In one embodiment, the present disclosure relates to a method of selectively controlling invasive plant species while maintaining desirable plant species by applying the micronutrient (A) and the agricultural composition (C). In one embodiment, the micronutrient (A) is phytotoxic to the invasive species but not phytotoxic to the desirable plant species.

The present disclosure, in one embodiment, relates to a method of controlling invasive plant species existing in a perennial grass plant community by applying the micronutrient (A) and the agricultural composition (C). In one embodiment, the perennial grass plant community comprises bluebunch wheatgrass, Western wheatgrass, slender wheatgrass, Idaho fescue, sheep fescue, orchard grass, smooth brome, timothy and/or Kentucky bluegrass. In one embodiment, the perennial grass plant community comprises bluebunch wheatgrass, Idaho fescue, western wheatgrass and/or Kentucky bluegrass.

The present disclosure, in one embodiment, relates to a method of controlling invasive plant species existing in a perennial grass plant community by applying the micronutrient (A) and the agricultural composition (C). The present disclosure, in one embodiment, relates to a method of controlling invasive plant species existing in a perennial grass community rangeland or pastureland by applying the micronutrient (A) and the agricultural composition (C). In one embodiment, the perennial grass community rangeland or pastureland comprises bluebunch wheatgrass, Western wheatgrass, slender wheatgrass, Idaho fescue, sheep fescue, orchard grass, smooth brome, timothy and/or Kentucky bluegrass. In one embodiment, the perennial grass plant community comprises bluebunch wheatgrass, Idaho fescue, western wheatgrass and/or Kentucky bluegrass.

The present disclosure, in one embodiment, relates to a method of controlling invasive plant species existing in a perennial grass plant community by applying the micronutrient (A) and the agricultural composition (C).

In one embodiment, the present disclosure relates to a method of selectively controlling cheatgrass, dandelion, creeping Charlie, Canadian thistle, kochia, knotweed, poison ivy and/or spotted knapweed while maintaining desirable plant species by applying the micronutrient (A) and the agricultural composition (C).

The present disclosure provides a method of selectively controlling the growth of at least one invasive plant species. In one embodiment, the method provides controlling the growth of at least one invasive plant species in a perennial grass plant community or a perennial grass community rangeland or pastureland. In one embodiment, the method disclosed herein uses compositions and combinations comprising a micronutrient and an agricultural composition comprising a micronutrient, a macronutrient, a biological compound or a related carbon-based organic compound, an inorganic compound, or a seed, a seed coating, or a seed inoculant.

In one embodiment, the present disclosure relates to methods for selectively controlling the growth of at least one invasive plant species existing in a perennial grass plant community, comprising applying:
(i) a micronutrient; and
(ii) an agricultural composition comprising one or more ingredients selected from a) a micronutrient; b) a macronutrient; c) a biological compound or a related carbon-based organic compound; d) an inorganic compound; or e) a seed, a seed coating, or a seed inoculant.

In one embodiment, the present disclosure relates to methods for negatively impacting the growth of at least one invasive plant species, including the selective control of the invasive plant species, existing in a perennial grass plant community, while preserving the perennial grass plant community species, comprising applying:
(i) a micronutrient; and
(ii) an agricultural composition comprising one or more ingredients selected from a) a micronutrient; b) a macronutrient; c) a biological compound or a related carbon-based organic compound; d) an inorganic compound; or e) a seed, a seed coating, or a seed inoculant.

In one embodiment of any one of the methods disclosed herein, the micronutrient comprises boron or a copper. In one embodiment, the micronutrient comprises boron. In one embodiment of anyone of the methods disclosed herein, the micronutrient is applied to achieve a water-soluble boron concentration in the soil of the perennial grass plant community from about 3 milligrams per liter to about 50 milligrams per liter. In one embodiment, the micronutrient is applied at a rate of about 1 pound of elemental boron per one acre to about 150 pounds of elemental boron per one acre. In other embodiments, the micronutrient is applied at a rate of about 5, about 10, about 15, about 25, about 50, about 75, or about 100 pounds of elemental boron per one acre.

In one embodiment of any one of the methods disclosed herein, the micronutrient comprises boron, wherein the boron in the micronutrient is not conducive to good health and/or growth of at least one invasive plant species while maintaining or increasing the health, growth and vigor of the perennial grass. Maintaining the growth and vigor of the perennial grass can mean that the perennial grass is not harmed by the treatment but not necessary mean that resulted in increased growth and vigor.

In one embodiment of any one of the methods disclosed herein, the at least one invasive species is selected from the group consisting of cheatgrass, dandelion, creeping Charlie, Canadian thistle, kochia, knotweed, poison ivy and spotted knapweed. In one embodiment of any one of the methods disclosed herein, the perennial grass plant community comprises bluebunch wheatgrass, Western wheatgrass, slender wheatgrass, Idaho fescue, sheep fescue, orchard grass, smooth brome, timothy or Kentucky bluegrass.

In one embodiment of any one of the methods disclosed herein, the micronutrient in the agricultural composition is selected from copper, zinc, iron, boron, manganese, molybdenum, or chlorine.

In one embodiment of any one of the methods disclosed herein, the macronutrient in the agricultural composition is selected from nitrogen, phosphorous, or potassium.

In one embodiment of any one of the methods disclosed herein, the agricultural composition further comprises an organic fertilizer or an inorganic fertilizer.

In one embodiment of any one of the methods disclosed herein, the organic fertilizer or the inorganic fertilizer comprises calcium, magnesium, sulfur, carbon, hydrogen or oxygen elements.

In one embodiment of any one of the methods disclosed herein, the adjuvant in the agricultural composition is selected from a wetting agent, an activator, a crop oil concentrate, a buffer, a marker dye or a surfactant.

In one embodiment of any one of the methods disclosed herein, the biological compound and related carbon-based organic compound in the agricultural composition is selected from fungus, spores, bacteria, soluble carbon-based solids or liquids (including sugar), organic matter, mycorrhizae, biochar, hydromulch, hydraulic mulch, waste products such as sawdust, manure, straw, corn stover, shells, hulls, or meal.

In one embodiment of any one of the methods disclosed herein, the inorganic compound in the agricultural composition is selected from lime, silica, aluminosilicate, gypsum, or sulfur compound.

In one embodiment of any one of the methods disclosed herein, the inorganic compound in the agricultural composition is selected from calcium carbonate, calcium magnesium carbonate, calcium oxide, calcium hydroxide, cementitious waste product, or calcium sulfate.

In one embodiment of anyone of the methods disclosed herein, the micronutrient and the agricultural composition is in a dry granular formulation or in a liquid formulation.

In one embodiment of any one of the methods disclosed herein, the agricultural composition comprises an adjuvant and the agricultural composition is in a liquid formulation.

In one embodiment of any one of the methods disclosed herein, the agricultural composition comprises the micronutrient. In one embodiment, the agricultural composition comprises the macronutrient. In one embodiment, the agricultural composition comprises the biological compound or related carbon-based organic compound. In one embodiment, the agricultural composition comprises the inorganic compound. In one embodiment, the agricultural composition comprises the seed, the seed coating, or the seed inoculant.

In one embodiment of any one of the methods disclosed herein, the micronutrient and the agricultural composition are applied simultaneously or sequentially.

In one embodiment of any one of the methods disclosed herein, the composition further comprises one or more ingredients selected from: a) a micronutrient; b) a macronutrient; c) a biological compound or a related carbon-based organic compound; d) an inorganic compound; or e) a seed, a seed coating, or a seed inoculant.

In one embodiment of any one of the methods disclosed herein, the micronutrient comprises boron or a copper. In one embodiment, the micronutrient comprises boron. In one embodiment, the micronutrient comprises boron in about 10% to about 30% by weight. In one embodiment, the micronutrient is applied to achieve a water-soluble boron concentration in the soil of the perennial grass plant community from about 3 milligrams per liter to about 50 milligrams per liter. In one embodiment, the micronutrient is applied at a rate of about 1 pound of elemental boron per one acre to about 150 pounds of elemental boron per one acre. In one embodiment, the micronutrient is applied at a rate of about 5, about 10, about 15, about 25, about 50, about 75, or about 100 pounds of elemental boron per one acre.

In one embodiment of any one of the methods disclosed herein, the boron in the micronutrient is not conducive to the health, growth or vigor of at least one invasive plant species while maintaining or increasing the growth and vigor of the perennial grass.

In one embodiment of any one of the methods disclosed herein, the at least one invasive species is selected from the group consisting of cheatgrass, dandelion, creeping Charlie, Canadian thistle, kochia, knotweed, poison ivy and spotted knapweed. In one embodiment of any one of the methods disclosed herein, the perennial grass plant community comprises bluebunch wheatgrass, Western wheatgrass, slender wheatgrass, Idaho fescue, sheep fescue, orchard grass, smooth brome, timothy or Kentucky bluegrass.

In one embodiment of any one of the methods disclosed herein, the micronutrient is selected from copper, zinc, iron, boron, manganese, molybdenum, or chlorine.

In one embodiment of any one of the methods disclosed herein, the macronutrient is selected from nitrogen, phosphorous, or potassium.

In one embodiment of any one of the methods disclosed herein, the composition further comprises an organic fertilizer or an inorganic fertilizer. In one embodiment, the organic fertilizer or the inorganic fertilizer comprises calcium, magnesium, sulfur, carbon, hydrogen or oxygen elements.

In one embodiment of any one of the methods disclosed herein, the adjuvant is selected from a wetting agent, an activator, a crop oil concentrate, a buffer, a marker dye or a surfactant.

In one embodiment of any one of the methods disclosed herein, the biological compound and related carbon-based organic compound is selected from fungus, spores, bacteria, soluble carbon-based solids or liquids (including sugar), organic matter, mycorrhizae, biochar, hydromulch, hydraulic mulch, waste products such as sawdust, manure, straw, corn stover, shells, hulls, or meal.

In one embodiment of any one of the methods disclosed herein, the inorganic compound is selected from lime, silica, aluminosilicate, gypsum, or sulfur compound. In one embodiment, the inorganic compound is selected from calcium carbonate, calcium magnesium carbonate, calcium oxide, calcium hydroxide, cementitious waste product, or calcium sulfate.

In one embodiment of any one of the methods disclosed herein, the composition is in a dry granular formulation. In one embodiment, the composition comprises an adjuvant and the agricultural composition is in a liquid formulation.

In one embodiment of any one of the methods disclosed herein, the composition comprises the micronutrient. In one embodiment, the composition comprises the macronutrient. In one embodiment, the composition comprises the biological compound or related carbon-based organic compound. In one embodiment, the composition comprises the inorganic compound. In one embodiment, the composition comprises the seed, the seed coating, or the seed inoculant.

In one embodiment of any one of the methods disclosed herein, the micronutrient is in a dry granular form or in a liquid form.

### EXAMPLES

The disclosure will now be illustrated in detail by reference to the specific embodiments described in the following examples. The examples are intended to be purely illustrative of the disclosure and are not intended to limit its scope in any way.

Unless defined otherwise, all technical and scientific terms herein have the same meaning as commonly understood by one of ordinary skill in the art to which this disclosure belongs. Although any methods and materials, similar or equivalent to those described herein, can be used in the practice or testing of the present disclosure, the preferred methods and materials are described herein. All publications, patents, and patent publications cited are incorporated by reference herein in their entirety for all purposes.

The publications discussed herein are provided solely for their disclosure prior to the filing date of the present application. Nothing herein is to be construed as an admission that the present disclosure is not entitled to antedate such publication by virtue of prior disclosure.

It is understood that there are other embodiments of the disclosure other than that described herein, which is provided to explain the disclosure to those skilled in the state of the art and should not be construed as limiting the claims made below.

### Example 1. Repeated Monitoring of Established Long-Term Turfgrass Test Plots in Bozeman, MT

Initially, a series of small turfgrass test plots was studied to gather preliminary information that helped guide the establishment of this larger, long-term study involving multiple rates and formulations. The test plots of this experiment were established in a weedy turfgrass location within the Bridger Creek Subdivision Community Association, Phase 1, Section 31, Township 1 South, Range 6 East, P.M.M., City of Bozeman, Gallatin County, Montana. The experimental site was established in a location with approximately 20 inches of annual precipitation, with annual maximum precipitation amounts observed in May and June. Winter conditions with frozen ground prevail during approximately 5 months of the year (November-March). Soils have high organic matter content in the upper six inches and are underlain by floodplain gravels and a water table 3-15 feet below ground surface. The primary turf weeds at this location in their order of relative prevalence are clover, dandelion, creeping Charlie, oxeye daisy, black medic and Canadian thistle. All were controlled by the approaches described herein.

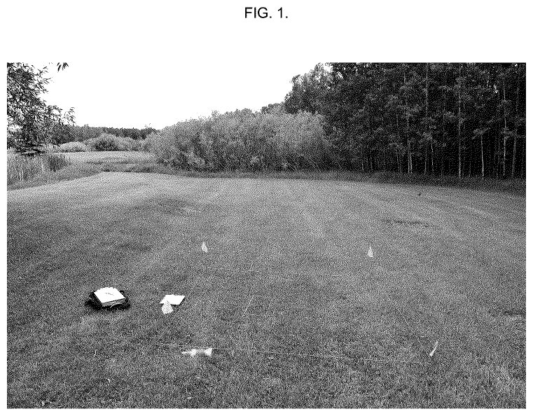

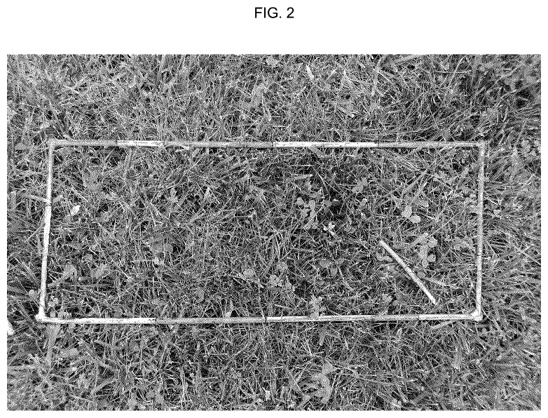

The plots were typically 50 square feet (FIG. 1). Vegetation cover measurements were made using a frame placed on the turf and an estimate was calculated for the proportion of perennial grasses and weeds in each frame (FIG. 2). Most of the plots were established in September of the first year, but several were installed later. Both granular and liquid formulations were used. The primary granular fertilizer products were nitrogen, boron and combined as N+B. Several herbicides were also compared including 2-4D, Roundup and anon-synthetic chelated iron product marketed as Bayer Natria. The plot information for this experiment are presented in Table 2. Since installation of the first plots, they have been monitored 5 times over a period of 21 months for vegetation cover. Plots 30 and 31 were the only spring applications.

TABLE 2
Treatments for the turfgrass testing plots.

| Plot | Relative Timing of | | Fertilizer |
|---|---|---|---|
| Number | Plot Installation | Treatment | Type |
| 1 | September 3, Year 1 | N @ 60 lbs/ac | Granular |
| 2 | September 3, Year 1 | B @ 50 lbs/ac | Granular |
| 3 | September 3, Year 1 | B @ 100 lbs/ac | Granular |
| 4 | September 3, Year 1 | N @ 60 lbs/ac | Granular |
| | | B @ 100 lbs/ac | |
| 5 | September 3, Year 1 | N @ 60 lbs/ac | Granular |
| | | B @ 75 lbs/ac | |
| 6 | September 3, Year 1 | Roundup ® @ | Foliar |
| | | 0.28 rate | |
| 7 | September 3, Year 1 | B1300 @ 0.30 kg | Foliar |
| 8 | September 3, Year 1 | B1300 @ 0.40 kg | Foliar |
| 9 | September 3, Year 1 | B1300 @ 0.48 kg | Foliar |
| 10 | September 3, Year 1 | Roundup ® @ | Foliar |
| | | 0.44 kg | |
| 11 | September 3, Year 1 | B1300 @ 0.60 kg | Foliar |
| 12 | September 3, Year 1 | Liquid (23 lbs | Foliar |
| | | B/ac) + NPK | |
| 13 | September 3, Year 1 | Liquid (47 lbs | Foliar |
| | | B/ac) + NPK | |
| 20 | September 18, Year 1 | Fe EDTA Natria ® | Foliar |
| 21 | September 18, Year 1 | B1300 | Foliar |
| 22 | September 18, Year 1 | 2-4 D | Foliar |
| 23 | September 26, Year 1 | N @ 700 lbs/ac | Foliar |
| | | B @ 700 lbs/ac | |
| 30 | May 23, Year 2 | N @ 60 lbs/ac | Granular |
| | | B @ 70 lbs/ac | |
| 31 | May 23, Year 2 | Foliar Cu @ | Granular |
| | | 400 lbs/ac | N + B plus |
| | | N @ 60 lbs/ac | Foliar Cu |
| | | B @ 60 lbs/ac | |
| 32 | October 1, Year 2 | N @ 60 lbs/ac | Granular |
| | | B @ 60 lbs/ac | |
| Control/ | September 3, Year 1 | N/A | N/A |
| Check | | | |

The B100 treatment is 100 pounds of boron per acre. The B+N treatment is 60 pounds of boron per acre plus 75 pounds of nitrogen per acre. The glyphosate treatment is Roundup®4 as 0.28 kg of applied liquid. The sprayer was weighed before and after application. Roundup®4 was mixed according to manufacturer's specs. The Natria®i FeEDTA is the Bayer™ chelated iron turf product. 2-4D is conventional herbicide. EDX-CBN is foliar copper plus boron and nitrogen (granular). The control or check plot is untreated.

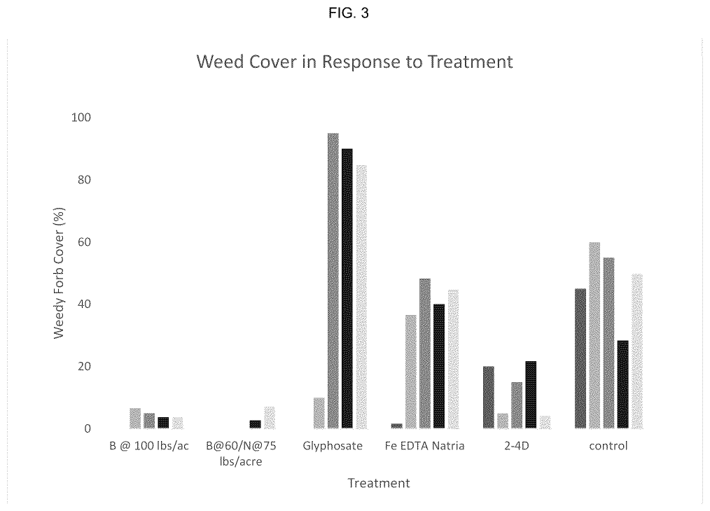

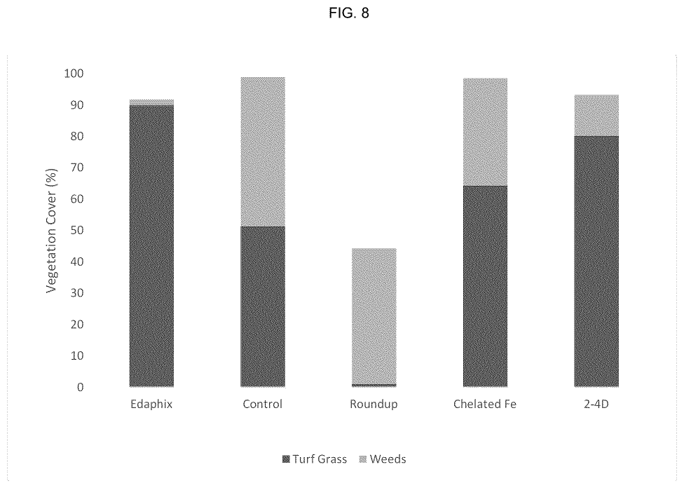

Over the first 2 years of monitoring the plots performed well compared to herbicides (FIG. 3). This site has about 50% weed cover as shown in the control and all the experimental treatments of the present disclosure were superior to 2-4D or the chelated iron. Roundup®4 is not a good turf treatment since it is a non-selective herbicide and kills all the vegetation including the turf grass. It was included solely for reference as the world's best-selling herbicide. The Natria®i FeEDTA is a chelated iron product that is currently considered the ‘best’ alternative weed control available in Canada. It is widely applied and its effect is very short lived (˜a few weeks). The tiny blue bar shows its treatment effect ˜1 month after application. It is also considered a relatively expensive treatment. The 2-4D treated areas typically had ˜20% weed cover while the experimental treatments of the present disclosure typically had less than 5% weed cover. Importantly, the experimental treatments of the present disclosure lasted over 2 years. The 2-4D and chelated Fe products are commonly applied with multiple applications annually. The following table compares the average percentage coverages for select treatments over the 21-month monitoring period. FIG. 8 provides a visual representation of the data provided in Table 3.

TABLE 3
Percentage healthy perennial grass cover and weed
cover averaged over each treatment category.

Average Percent Ground Cover
For 21-Month Monitoring Period

| | Turf | |
|---|---|---|
| Treatment | Grass | Weeds |
| Plot 5 | 90 | 2 |
| N @ 60 lbs/ac | | |
| B @ 75 lbs/ac | | |
| Fall application | | |
| Control | 51 | 48 |
| Roundup ® | 1 | 43 |
| Chelated Fe | 64 | 34 |
| 2-4 D | 80 | 13 |

The boron-only plots caused turf stress and yellowing. Immediately following application in monitoring, healthy and unhealthy/stressed turf was measured based on tissue color. “Healthy” or “healthy turf” are synonymous and defined as dark green turf, while “unhealthy” or “unhealthy turf” are also synonymous and defined as being yellow. At that time of these measurements, it was not known if the yellow turf was going to die or not. Importantly the B+N treatments did not cause yellowing and “unhealthy” conditions. Unhealthy grasses were not included in the calculations. There was no corresponding weed condition stress observed.

In terms of the nitrogen-only plot (i.e., N only), it was added as a point of reference. The amount of weeds remained essentially constant in that plot. However, the plot did look greener in the summer following application. One of key observations from these plots was increasing the granular boron rate and its effect on both perennial grasses and weeds (Table 4).

TABLE 4
Percentage healthy perennial grass cover and
weed cover for select boron treatments.

| | Approximate Number of Months After Treatments | | | | | | | | | |
|---|---|---|---|---|---|---|---|---|---|---|
| Granular | 1 Month | | 8 Months | | 10 Months | | 12 Months | | 21 Months | |
| Treatment | Grass | Weed | Grass | Weed | Grass | Weed | Grass | Weed | Grass | Weed |
| Plot 2 | 36.7 | 16.7 | 76.7 | 18.3 | 65.0 | 35.0 | 88.3 | 11.7 | 86.7 | 13.3 |
| B @ 50 | | | | | | | | | | |
| lbs/ac | | | | | | | | | | |
| (B50) | | | | | | | | | | |
| Plot 3 | 56.7 | 0.0 | 60.0 | 6.7 | 91.0 | 5.0 | 96.3 | 3.7 | 96.0 | 4.0 |
| B @ 100 | | | | | | | | | | |
| lbs/ac | | | | | | | | | | |
| (B100) | | | | | | | | | | |
| Control | 55 | 45 | 40 | 60 | 45 | 55 | 72 | 28 | 50 | 50 |

As shown in the table above, the higher rate of boron application resulted in less weedy cover. However, both rates of boron application subjected the perennial grasses to excessive stress resulting in yellowing of the turf. For example, the low grass cover of Plot 2 after 1 month was driven by the presence of yellow unhealthy turf grasses 1 month after treatment. In contrast, 8 months later the stress had abated.

The turf at this location in the control plot and in the test plots prior to treatment were a mixture of fine leaf blade grasses (e.g., Kentucky bluegrass) and wide leaf grasses (e.g., smooth brome). The Kentucky bluegrass was essentially gone from the B100 plot, suggesting lower tolerance of boron (data not provided). In contrast, the B50 plot had more Kentucky bluegrass but also more weeds (data not provided).

As show in the following Table 5, the best plots of those included in this study were those treated with a combination of boron and nitrogen.

TABLE 5
Percentage healthy perennial grass cover and weed cover
for combination treatments with boron and nitrogen.

| | Approximate Number of Months After Treatments | | | | | | | | | |
|---|---|---|---|---|---|---|---|---|---|---|
| Granular | 1 Month | | 8 Months | | 10 Months | | 12 Months | | 21 Months | |
| Treatment | Grass | Weed | Grass | Weed | Grass | Weed | Grass | Weed | Grass | Weed |
| Plot 4 | 93 | 0 | 80 | 0 | 92 | 0 | 96 | 4 | 97 | 3 |
| B @ 60 | | | | | | | | | | |
| lbs/ac | | | | | | | | | | |
| N @ 100 | | | | | | | | | | |
| lbs/ac | | | | | | | | | | |
| Plot 5 | 90 | 0 | 78 | 0 | 91 | 0 | 97 | 3 | 93 | 7 |
| B @ 60 | | | | | | | | | | |
| lbs/ac | | | | | | | | | | |
| N @ 75 | | | | | | | | | | |
| lbs/ac | | | | | | | | | | |
| Plot 30 | | | 67 | 28 | 73 | 27 | 96 | 4 | 92 | 6 |
| B @ 60 | | | | | | | | | | |
| lbs/ac | | | | | | | | | | |
| N @ 75 | | | | | | | | | | |
| lbs/ac | | | | | | | | | | |
| Plot 31 | | | 92 | 3 | 98 | 2 | 100 | 0 | 93 | 0 |
| B @ 60 | | | | | | | | | | |
| lbs/ac | | | | | | | | | | |
| N @ 60 | | | | | | | | | | |
| lbs/ac | | | | | | | | | | |
| Plus, Cu | | | | | | | | | | |
| Plot 32 | | | | | | | | | 66 | 2 |
| B @ 60 | | | | | | | | | | |
| lbs/ac | | | | | | | | | | |
| N @ 60 | | | | | | | | | | |
| lbs/ac | | | | | | | | | | |
| Control | 55 | 45 | 40 | 60 | 45 | 55 | 72 | 28 | 50 | 50 |

There are several key teachings from the above data. First, with the exception of Plot 32, all of the boron plus nitrogen plots were better than the boron-only plots at resulting in increased percentages healthy perennial grasses versus the percentage of weeds. The one outlier was Plot 32 that was initiated in October and that late date of treatment resulted in abundant turf stress in the following spring monitoring event. Additional turf plots initiated at another location at that same time had the same outcome. It appears based on this data that starting the treatment plots in the July-September timeframe results in the best increase in percentage of healthy perennial grasses. While not wishing to be bound to any particular theory, this may be because most perennial weeds are recharging their roots during this time. Spring treatment is relatively less successful. Using Plot 30 as an example of a spring application, it took from the first application in May until September to decrease weed cover from 27 to 4%. The treatment worked, but it took a relatively longer time. The notable exception to this trend is Plot 31 where a similar granular treatment had an additional application of foliar copper liquid. That plot immediately went to 3% weedy cover and stayed low. In contrast, a plot with foliar copper alone returned to heavy weed cover (˜50%) 3 weeks after application when the treatment did not include the granular product also. From the results of this investigation, the granular B+N plus foliar Cu appears to be the best spring treatment. The longevity of the treatment performance is also a key finding compared to commercial herbicides that last a short time and, in some instances, do not kill the weeks but rather defoliate them for a short time. Plots installed with granular B+N last at least 21 months, likely longer at the rates shown.

Plot 32 also included a Cu foliar spray. It was observed during experimentation that only spraying foliar Cu defoliated the weeds but they grew back in several weeks (data not provided). While not wishing to be bound by any particular theory, it is hypothesized that combining the Cu foliar spray with soil treatment of a granular boron-containing formulation results in the weeds failing to grow back or growing back in much-weakened state, thereby allowing the perennial grasses to flourish.

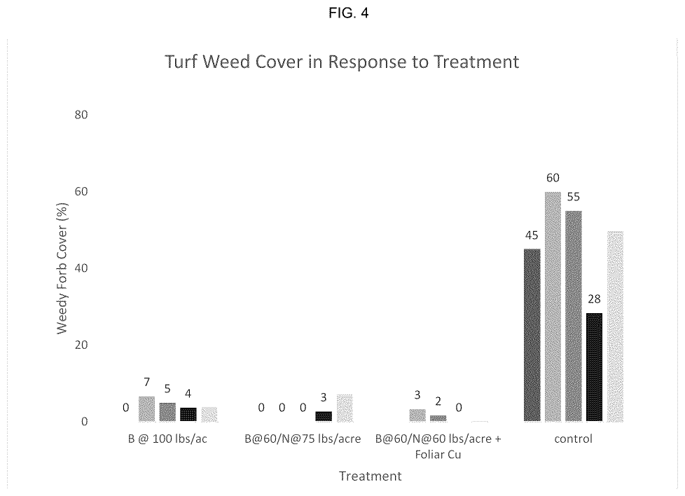

The findings of the above tables are presented along with a comparison to boron-only treatments in FIG. 4. Plot 5 (fall application of N+B) was one of the successful plots and 21 months after its treatment application had only 7% weed cover and no issues with turf stress on Kentucky bluegrass.

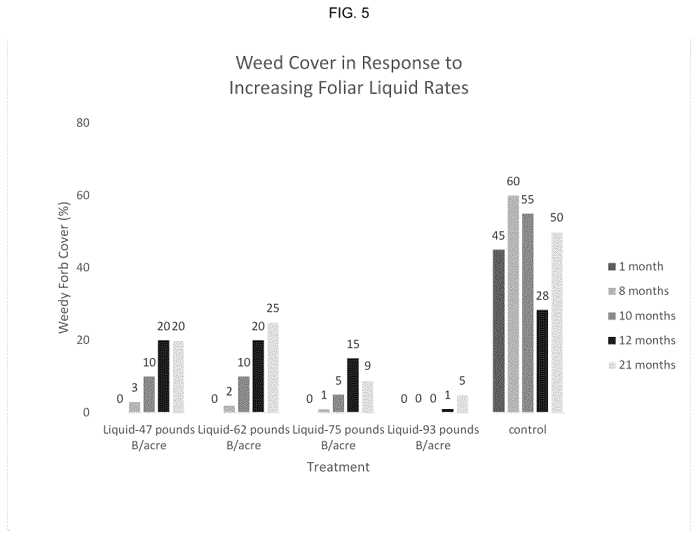

The same basic findings apply to the liquid formulation treatments (FIG. 5) in that there was better weed control with increasing rates and more turf stress with boron-only treatments and less turf stress with liquid B+N. The 93-pound B/acre liquid application (Plot 11) stood out as remarkable for its continued ability to maintain a high percentage of healthy perennial grasses even after 21 months. Fine-bladed perennial grasses were, however, almost absent in the plot. Plot 13 received 47 pounds of foliar B plus an N rate of 104 lbs/acre still resulting in increasing the percent coverage of perennial grasses over weeds and, again, had less turf stress.

The combination B+N as a liquid provided modest increases in the percent coverage of perennial grass cover as shown in the following Table 6. Healthy perennial grasses had only 25% coverage one month after installation due to turf stress and over application of boron. Likewise, the control of broadleaf weeds was not fully satisfactory as shown below. Overall, the treatment effect was short-term or about 1 month. Foliar application on clover requires addition of a surfactant to the liquid.

TABLE 6
Percentage healthy perennial grass cover and
weed cover for liquid B + N treatments.

| | Approximate Number of Months After Treatments | | | | | | | | | |
|---|---|---|---|---|---|---|---|---|---|---|
| Granular | 1 Month | | 8 Months | | 10 Months | | 12 Months | | 21 Months | |
| Treatment | Grass | Weed | Grass | Weed | Grass | Weed | Grass | Weed | Grass | Weed |
| Plot 12 | 85 | 0 | 60 | 35 | 50 | 50 | 65 | 35 | 75 | 25 |
| B @ 23 | | | | | | | | | | |
| lbs/ac | | | | | | | | | | |
| N @ 50 | | | | | | | | | | |
| lbs/ac | | | | | | | | | | |
| Plot 13 | 25 | 0 | 80 | 10 | 50 | 50 | 80 | 20 | 80 | 20 |
| B @ 47 | | | | | | | | | | |
| lbs/ac | | | | | | | | | | |
| N @ 104 | | | | | | | | | | |
| lbs/ac | | | | | | | | | | |
| Control | 55 | 45 | 40 | 60 | 45 | 55 | 72 | 28 | 50 | 50 |

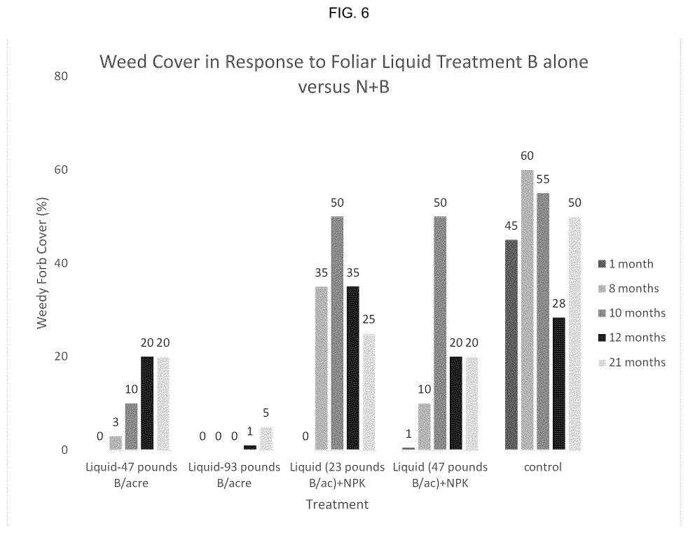

FIG. 6 provides an illustration of the percent weed cover in response to foliar liquid treatment for boron alone and for nitrogen plus boron treatments. Overall, and as shown in the figure, the boron plus nitrogen treatments were more favorable to percentage weed coverage. Comparing the 47 pound per acre rate of B versus the 47 pound per acre B+N liquid after 21 months the weed control is the same, however both are better than the untreated control.

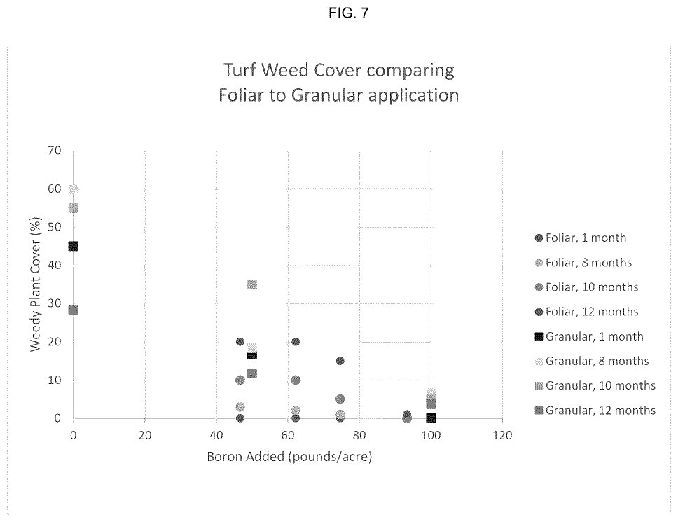

Looking at granular and liquid boron combined in their efficacy to limit turf weeds there is an envelope where the turf weeds using either method are approaching zero around 100 pounds of boron per acre (FIG. 7). However, to achieve this kind of weed control imposes considerable stress on turf grass. FIG. 7 does not reflect the demonstrated efficacy of the B+N formulations that were discussed previously.

Based on this research, the following was learned from these test plots:
(1) Granular boron is effective in controlling turf weeds, however higher rates can cause unwelcome turf stress.
(2) Granular boron plus granular nitrogen applied mid to late summer is the best treatment strategy for turf weeds when balancing weed control and turf stress.
(3) Within the family of perennial grasses, turf grass Kentucky bluegrass was less tolerant of higher levels of boron compared to pasture grass smooth brome. Many turf mixes have multiple species and differential sensitivity has been observed.
(4) Liquid boron is similarly effective to granular boron, however faster acting since it does not require rainfall to dissolve and was immediately available to plants. Higher rates of boron-only liquid also caused turf stress yet were highly effective in controlling turf weeds.
(5) Liquid boron plus nitrogen caused much less turf stress (same as granular) and controlled turf weeds effectively, however the treatment effect was not as long lasting as granular approaches. Liquid B+N has the added advantage of use as a spot spray to selectively treat small areas.
(6) Early season granular treatment is less effective than mid-to late season application. Late fall application should be avoided. Early season granular B+N can be improved with a companion foliar copper treatment that is highly and rapidly effective on broadleaf weeds.

### Example 2. Turfgrass Plots in Canada

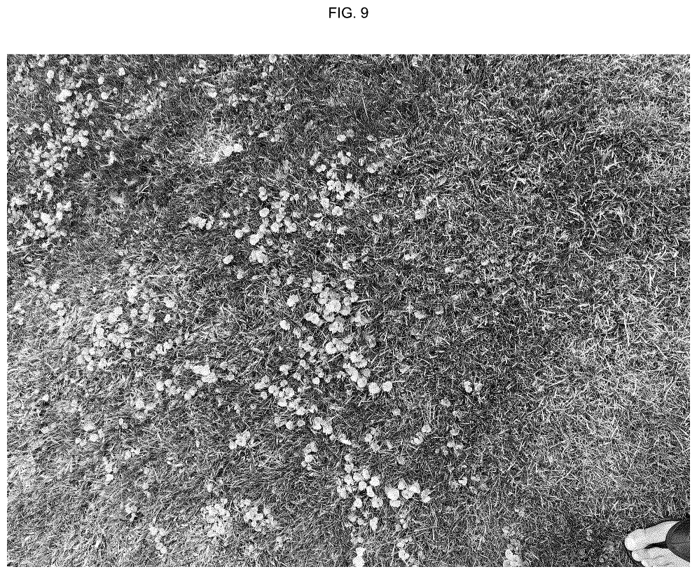

Tests were conducted on a residential lawn near Cornwall, Ontario, Canada. The residential address is located on Stonehouse Pt Rd, Township of South Glengarry, Ontario, which is located along the St. Lawrence River in southeast Ontario. The test area was on the south side of the house in an area exposed to full sun. The treatment was applied on August 20. FIG. 9 is a photograph showing the results of the test on the following September 15. The weed cover was primarily creeping Charlie with some clover, plaintain and violet. Soil was topsoil native to this area applied over glacial till fill after the house was built about 18 years earlier than the test was conducted. PH is unknown but will be typical of the area. In most of Southern Ontario, soils are neutral to alkaline, though there are areas where soils are too acidic for optimum growth of most plants (The Online Gardener's Handbook 2010, Chapter 3: A world about soil/The nature of soil, Ontario Ministry of Agriculture, Food and Rural Affairs). Sprinkler system was turned off. Approximately 2.5 inches of rain was received during this period and temperatures averaged 65-70 F. Average rainfall for this period is normally about 2.0 inches. Temperatures begin to moderate and precipitation begins to increase mid-August to September after the hot dry period of mid-June to mid-August.

Phase One. The first experiment involved a 100 square foot plot within a 2-acre lawn, wherein the test plot was treated with the granular formulation set forth in the following Table 7.

TABLE 7
Experimental composition for Ontario, Canada, test plots. Multi-Element
fertilizer also included trace amounts of Fe, Mn, Mo, Cu, Zn and B.

| Element | | | | | | Elemental | | |
|---|---|---|---|---|---|---|---|---|
| Supplied | Fertilizer | Fertilizer | Elemental | Elemental | Elemental | Target | Fertilizer | Fertilizer |
| by | Weight | Rate | Purity | Total | Rate (g/sq | Rate | Rate | Rate |
| Fertilizer | (grams) | (g/sq ft) | (%) | (grams) | ft) | (lbs/acre) | (lbs/acre) | (kg/ha) |
| Boron | 1389 | 3.47 | 15% | 208.35 | 0.52 | 50 | 332.8 | 373.5 |
| Nitrogen | 431 | 1.08 | 29% | 124.99 | 0.31 | 40 | 103.3 | 115.9 |
| Multi- | 20 | 0.05 | N = 20% | trace | N/A | N/A | N/A | N/A |
| Element | | | P = 20% | | | | | |
| N-P-K | | | K = 20% | | | | | |
| | | | (20-20-20) | | | | | |
| Totals | 1840 | 4.6 | | 333.34 | | | 436 | 489 |

On August 20, 1 kg of the lawn treatment formulation containing 15% elemental boron and 29% elemental nitrogen plus micronutrients (Table 7) was applied evenly by hand over the 10′×10′, 100 sq ft area. This perennial grass lawn area was infested with abundant Creeping Charlie cover plus some Plantain and other weeds. No other treatment was applied or used during the testing period. No artificial watering occurred during the testing period. FIG. 9 is a photograph taken on the following September 16 showing part of the treated area on the right side plus untreated lawn immediately adjacent to the treated area on the left side of the photo. As shown in FIG. 9, the treated area is essentially weed free and the grass has filled in the area that was previously occupied by weeds—primarily creeping Charlie and Plantain.

Phase Two. Based on the success of the Phase One trial, 860 pounds of a lawn treatment was created using 15% purity Boron and 46% purity Nitrogen from urea. This was applied to approximately 2 acres of lawn in early October using a commercial fertilizer spreader typically used by a homeowner or landscaper for such use. The majority of the lawn looked like the untreated 100 sq ft area that was treated in the Phase One Trial.

While this second treatment of a larger area was likely applied too late in the season to be fully effective prior to plant dormancy in November, the grass looked healthier and was beginning to outcompete the weeds. In late April and early May it is expected that the full impact of the lawn treatment will be visible.

Within a very short time after application of the experimental composition, it was observed that the percentage of healthy perennial grass coverage dramatically increased while the percentage of weed cover decreased as compared to the rest of the 2-acre lawn.

### Example 3. Household Lawn Fertilizer Experiments

Unirrigated test plots were installed in Eastern Canada during the next season using an experimental design derived from successful technology demonstration in the previous growing season (i.e., Phase One and Phase Two experiments as described above). By assessing the impact of various formulations of nutrient packages and boron, these experiments guided further refinement and development in a product that is meant to address the nuisance weeds commonly found on homeowners' lawns while promoting growth and health of perennial grasses. The tested formulations included key ingredients such as nitrogen, phosphorus, potassium and boron in specific ratios to achieve this result. These studies tested various formulations of perennial grass promoting lawn fertilizer to determine the most effective formula. This will result in the development of products that will effectively promote grass and eliminate weeds on lawns and golf courses using novel compositions of common fertilizers.

Goals of these studies included: 1) determining the nutrient-based formulations that are the most effective at promoting the growth of turfgrasses over that of important broad leaf weeds; 2) determining the best application window(s) to apply the nutrient-based formulations; and, 3) determining the impact of someone accidently or purposely over applying or under applying the formulations from the recommended rate.

The F1, F2 and F3 Formulations each contained the same basic nutrient package (NPK and micronutrients) in addition to the following varying amounts of boron to achieve the following application rates for this study: F1=0 lbs/acre of boron, F2=25 lbs/acre of boron, F3=50 lbs/acre of boron and F4=10 lbs/acre boron. The F4 Formulation was applied at 220 lbs/acre in the fall on all plots that were first treated in May. Additional treatments included over/under rates of 50% of boron to determine what happens if a homeowner inadvertently applies the formulations in this manner. The boron used in this study was in soluble form at 15% elemental boron purity. There was no change in the actual formulations used for the over/under rates but the rate of application for each formulation was adjusted to obtain the desired level of boron delivery in pounds per acre.

Each treatment was applied to test plots that contained natural populations of both dandelions, creeping Charlie and other weeds common to the area such as plantains, clover, and violetr. To assess impacts of different formulations, 20′×20′ 3 replication, randomized plots (i.e., 400 square feet per plot) were created to accommodate each formulation, application rate and application window. A summary of the treatments used in this study are provided in the following Table 8.

TABLE 8
Treatments used in this study.
Table 8. Part A. Overall experimental design.

| | | Total Fertilizer | | |
|---|---|---|---|---|
| | | Application Rate | | |
| | Boron Application | (N, K, Cu, S, B, | Application | Fall |
| Plot ID | Rate | Mg, Fe, Mn) | Date | Supplement |
| S/F-Neg | Negative Control | N/A | N/A | No |
| S-0B + 0 | B @ 0 lbs/acre | 310 lbs/acre | May | Yes |
| S-0B + 50 | B @ 0 lbs/acre | 465 lbs/acre | May | Yes |
| S-0B-50 | B @ 0 lbs/acre | 155 lbs/acre | May | Yes |
| S-25B + 0 | B @ 25 lbs/acre | 475 lbs/acre | May | Yes |
| S-25B + 50 | B @ 25 lbs/acre | 713 lbs/acre | May | Yes |
| S-25B-50 | B @ 25 lbs/acre | 238 lbs/acre | May | Yes |
| S-50B + 0 | B @ 50 lbs/acre | 643 lbs/acre | May | Yes |
| S-50B + 50 | B @ 50 lbs/acre | 965 lbs/acre | May | Yes |
| S-50B-50 | B @ 50 lbs/acre | 322 lbs/acre | May | Yes |
| F-0B + 0 | B @ 0 lbs/acre | 310 lbs/acre | September | N/A |
| F-25B + 0 | B @ 25 lbs/acre | 475 lbs/acre | September | N/A |
| F-50B + 0 | B @ 50 lbs/acre | 643 lbs/acre | September | N/A |

TABLE 8
Part B. Amounts of each element applied in pounds per acre (lbs/ac).

| | Total | | | | | | | | |
|---|---|---|---|---|---|---|---|---|---|
| | Fertilizer | | | | | | | | |
| | Application | | | | | | | | |
| | Rate | | | | | | | | |
| | (N, K, Cu, | | | | | | | | |
| | S, B, Mg, | | | | | | | | |
| | Fe, Mn) | NO₃_{_{—}}N | K | B | Cu | S | Mg | Fe | Mn |
| Plot ID | (lbs/ac) | (lbs/ac)¥ | (lbs/ac) | (lbs/ac) | (lbs/ac) | (lbs/ac) | (lbs/ac) | (lbs/ac) | (lbs/ac) |
| S/F- | N/A | 0 | 0 | 0 | 0 | 0 | 0 | 0 | 0 |
| Neg | | | | | | | | | |
| S-0B + 0 | 310 | 65 | 35 | 0 | 2 | 15 | 6 | 4 | 2 |
| S- | 465 | 98 | 53 | 0 | 3 | 23 | 9 | 6 | 3 |
| 0B + 50 | | | | | | | | | |
| S-0B- | 155 | 33 | 18 | 0 | 1 | 8 | 3 | 2 | 1 |
| 50 | | | | | | | | | |
| S- | 475 | 65 | 35 | 25 | 2 | 15 | 6 | 4 | 2 |
| 25B + 0 | | | | | | | | | |
| S- | 713 | 98 | 53 | 37 | 3 | 23 | 9 | 6 | 3 |
| 25B + 50 | | | | | | | | | |
| S-25B- | 238 | 33 | 18 | 12 | 1 | 8 | 3 | 2 | 1 |
| 50 | | | | | | | | | |
| S- | 643 | 65 | 35 | 50 | 2 | 15 | 6 | 4 | 2 |
| 50B + 0 | | | | | | | | | |
| S- | 965 | 98 | 53 | 75 | 3 | 23 | 9 | 6 | 3 |
| 50B + 50 | | | | | | | | | |
| S-50B- | 322 | 33 | 18 | 25 | 1 | 8 | 3 | 2 | 1 |
| 50 | | | | | | | | | |
| F-0B + 0 | 310 | 65 | 35 | 50 | 2 | 15 | 6 | 4 | 2 |
| F- | 475 | 65 | 35 | 50 | 2 | 15 | 6 | 4 | 2 |
| 25B + 0 | | | | | | | | | |
| F- | 643 | 65 | 35 | 50 | 2 | 15 | 6 | 4 | 2 |
| 50B + 0 | | | | | | | | | |

¥Nitrate nitrogen (NO₃_{_{—}}N) was split 50/50 into ‘fast release’ and ‘slow release’ forms

Nine plots (3 trts×3 reps) were randomized for Formulations F1, F2 & F3 for spring (May) application at the appropriate application rates. To assess under and over application, 18 plots (3 trts×3 reps×2 plus/minus rates of application) were randomized for the ˜50% application rate and +50% application rate for each of these formulations (i.e., F1, F2 and F3). Formulation F4 was used for a fall supplement on each of 27 spring-application plots (9 trts/reps+18 trts/reps). Finally, nine plots (3 trts×3 reps) were randomized for a fall application for each of boron at 0, 25 and 50 lbs/acre. No supplemental fertilizer was used with the fall application. For both spring and fall, three plots were randomized to act as negative controls. Thus, the total number of plots is 42 (i.e., 6 control plots+36 trts/reps combinations).

To assess effectiveness of the formulations, pre-application, post-project and weekly visual analysis of each plot were taken to quantify percentage of grasses and percentage of weeds (dandelions, creeping Charlie and others). In addition, soil analyses was performed pre- and post-application to assess the impact of the formulations to soil porosity and composition (once before and at the end of the project) and pH was assessed on a weekly basis.

Up to an additional 20 lawns of ˜1 acre in size were used with the 50 lbs Boron formulation. This provides critical information back to the team about spatial variability and impact of different soil compositions. The same parameters as for the experimental plots were monitored.

Quantitative data collected from these research plots (not provided) were not as positive overall as that of the Phase One and Phase Two trials (described above). The ‘optimization’ of the timing and formulation of the present experiments were different than the highly successful trials done in the prior year.

The Phase One application was installed in August, while the Phase Two was installed in October. The Phase One and Phase Two formulations were primarily boron+nitrogen with a tiny amount of multielement fertilizer in Phase One. Thus, in the present experiments the timing was different (May versus August-October) and the formulation was different (Phase One and Phase Two were B+N essentially and the present experiments consisted of 8 elements, importantly with appreciable K).

The weather for the unirrigated plots in the present experiments was also much drier compared to the weather of the Phase One and Phase Two trials of the previous year. The Government of Canada reported the following regarding the drought that occurred for the time span of the present experiments: “In the east, going into the planting season, Ontario and Quebec had a significant moisture deficit with spring precipitation between 25-75% of normal totals. Deficits ranged from 110 to 130 mm in places such as Chatham-Kent in southwestern Ontario and in the Montreal area. Spring precipitation in Montreal was very close to the historical record dating from 1915. May was among the driest on record from London to Ottawa covering 75 years.” Thus, while the causative reason for the poorer performance is unknown, it is suspected that the main driver of the differences from previous testing was drought since the present experimental plots were planted in May and were not irrigated. In contrast, the demonstration homeowner lawns treated at the same time and described below responded well (where turf watering was performed).

In summary, there are several reasons for the poorer experimental findings in the present experiments including: 1) product formulation changes including additional potassium (K), 2) application timing variation to springtime versus late summer, and 3) prevalent drought during the growing season (as evidenced by reports from the Canadian government). Drought was also observed during the growing season limiting the dissolution of the applied granular fertilizer. While the overall results were generally viewed as positive, the aggregate effect resulted in poorer results than anticipated rendering the data not all that helpful or instructive other than helping to define the most optimal formulations and/or application timings.

### Example 4. Demonstration Homeowner Lawns in Canada

As discussed above, qualitative data collected from the Phase One and Phase Two trials showed strong evidence of weed prevention. The present series of demonstration plots were conducted on participating homeowner properties spreadout across Cornwall, Canada, and surrounding areas including The United Counties of Stormont, Dundas and Glengarry (“SD&G”), an upper-tier municipality in the Canadian province of Ontario.

A total of 23 property owners took part in the present fertilizer trials. The spring application on the homeowner properties consisted of the F3 formulation at the recommended rate of 645 lbs/acre. Three (3) properties also had areas treated with both F3 and F2 formulations for comparative purposes. The rates for the demonstration lawns F3 was 645 lbs/acre (i.e., a relatively heavy rate) and included 50 pounds of B per acre. The F2 rate was used on three of the demonstration lawns was lighter (475 pounds) but contained half as much B (25 lbs/acre).

Assessment and monitoring of homeowner lawns was strictly qualitative, site visits included weekly monitoring events where photographs and general observations were documented. It was apparent that the F3 treatments had a greater effect on the lawns, as shown by greater grass coverage and associated reduction in weed coverage than was observed when compared to areas also treated with F2.

In conclusion, the F3 formulation appeared to have had a beneficial impact on lawns. The degree to which the treatment improved lawn health is strongly correlated to the quality of the soil and grass coverage at the time of application. The best results were observed on healthy lawns, however improvements were still documented on less healthy lawns, where weeds made up a high proportion of the lawn. All in all, homeowners seemed to be very pleased with the overall product. Many trial participants felt that their lawns were greener, thicker and healthier as a result of the experimental treatments.

While not wishing to be bound by any particular theory, the hypothesis based upon the experiments described above is that the most successful lawn treatment strategy according to the present disclosure may be to apply the boron-containing formulations in the summer months (post-flowering of the weed species). This is because most perennial weeds would have spent their root reserves in the spring to reproduce and are actively recharging their roots with nutrients at that time.

### Further Numbered Embodiments of the Disclosure

Other subject matter contemplated by the present invention is set out in the following numbered embodiments:

1. Compositions, formulations, systems and methods for selectively promoting the growth and/or health of desirable perennial grass species so that they are better able to outcompete invasive, unwanted, weedy plant species, wherein such compositions, formulations, systems and methods do not utilize chemically synthesized herbicides.

2. Compositions, formulations, systems and methods used to achieve weed control in lawns by promoting soil chemistry that favors perennial grasses over weeds.

3. Compositions, formulations, systems and methods that provide environmentally friendly and sustainable alternatives to the fertilizers and chemically synthesized herbicides that are presently available for turfgrass establishment, maintenance and management, wherein the compositions, formulations, systems and methods promote the growth of perennial grasses thereby allowing them to outcompete weeds.

4. Compositions, formulations, systems and methods that effectively promote desirable grasses and result in the reduction or elimination of weeds on lawns, golf courses and other types of grassy areas, wherein the compositions, formulations, systems and methods utilize a fertilizer-based formula composed of selected ingredients, including micronutrients, which are all safe and currently federally registered and approved for use.

5. Compositions, formulations, systems and methods that promote the growth and/or health of turfgrasses thereby allowing them to outcompete and/or exert allopathic influence over weedy species.

6. Compositions, formulations, systems and methods for selectively controlling the growth of at least one invasive plant species in a turfgrass community.

7. Compositions, formulations, systems and methods for controlling unwanted weeds in the vicinity of preferred, cultivated perennial grasses in a lawn or turf area.

8. A method of applying a composition comprising boron and nitrogen to an area of lawn or turf comprising at least one perennial grass species and at least one weed species growing therein, wherein the method results in an application rate of about 25 lbs/acre to about 100 lbs/acre of boron and about 40 lbs/acre to about 100 lbs/acre of nitrogen, and wherein the method promotes the germination, health, vigor and/or growth of the at least one perennial grass species and suppresses the germination, health, vigor and/or growth of the at least one weed species within one month following application.

9. The method of embodiment 8, wherein the application rate is about 75 lbs/acre of boron and about 60 lbs/acre of nitrogen.

10. The method of embodiment 8, wherein the application rate is about 50 lbs/acre of boron and about 50 lbs/acre of nitrogen.

11. The method of embodiment 8, wherein the at least one weed species is dandelion or creeping Charlie.

12. The method of embodiment 8, wherein the at least one perennial grass species is selected from the group consisting of Kentucky bluegrass, fescue, bent grass, and perennial ryegrass.

13. The method of embodiment 8, wherein the area of lawn or turf is in the Northeastern United States.

14. The method of embodiment 8, wherein the area of lawn or turf is in Eastern Canada.

15. The method of embodiment 8, wherein the application of the composition occurs in the Spring months.

The method of embodiment 8, wherein the method further comprises providing supplemental watering of the area of lawn or turf.

16. The method of embodiment 8, wherein the method further comprises measuring the area of lawn or turf that is covered by the at least one perennial grass species before the composition is applied and again 1 month after the composition is applied.

17. The method of embodiment 16, wherein the area of lawn or turf covered by the at least one perennial grass species has increased by at least 25% relative to the area of law or turf covered by the at least one weed species 1 month after the composition is applied.

18. The method of embodiment 8, wherein the composition is in granular form.

19. The method of embodiment 8, wherein the composition is in liquid form.

20. The method of embodiment 8, wherein the composition is applied as a foliar spray.

21. The method of embodiment 8, wherein the method continues to promote the germination, health, vigor and/or growth of the at least one perennial grass species and suppress the germination, health, vigor and/or growth of the at least one weed species for 1 month to 21 months after the composition is applied.

22. The method of embodiment 8, wherein the at least one weed species is eliminated from the area of lawn or turf.

23. The method of embodiment 8, wherein the application of the composition occurs in the Summer months.

24. The method of embodiment 8, wherein the application of the composition occurs post-flowering of the weed species.

### INCORPORATION BY REFERENCE

All references, articles, publications, patents, patent publications, and patent applications cited herein within the above text and/or cited below are incorporated by reference in their entireties for all purposes. However, mention of any reference, article, publication, patent, patent publication, and patent application cited herein is not, and should not be taken as acknowledgment or any form of suggestion that they constitute valid prior art or form part of the common general knowledge in any country in the world. Further, U.S. Pat. Nos. U.S. Pat. No. 8,835,355 (issued on Sep. 16, 2014), U.S. Pat. No. 9,096,478 (issued on Aug. 4, 2015), U.S. Pat. No. 9,775,357 (issued on Oct. 3, 2017), U.S. Pat. No. 10,251,399 (issued on Apr. 9, 2019), U.S. Pat. No. 10,681,913 (issued on Jun. 16, 2020), are hereby incorporated by reference. Also, U.S. Patent Application No. U.S. Ser. No. 16/714,177 (published as US2020/0187504 A1 on Jun. 18, 2020), U.S. patent application Ser. No. 16/868,118 (published as US2020/0260735 A1 on Aug. 20, 2020), and U.S. patent application Ser. No. 16/988,553 (published as US2021/0037830 A1 on Feb. 11, 2021) are hereby incorporated by reference.

### ADDITIONAL REFERENCES

Bangsund, D. A., and Leistritz, F. L. 1991. Economic impacts of leafy spurge on grazing lands in the northern Great Plains. NDSU Agriculture Economic Report No. 275-S.
Elliott, G. C. and P. V., Nelson. 1981. Acute boron toxicity in Begonia×hiemalis Schwabenland Red.’ Commun. Soil Sci. Plant Annu. 12(8):775-783.
Gogue, G. J. and K. C. Sanderson. 1973. Boron toxicity of Chrysanthemum. HortScience 8:473-475.
Hammer, P. A. and D. A. Bailey. 1987. Poinsettia tolerance of molybdenum. HortScience 22: 1284-1285.
Heap I. 2006. The International Survey of Herbicide Resistant Weeds. Available from URL: http://www.weedscience.com.
Jong-Myung, Chun-Ho Pak, and Chiwon W. Lee, 1996. Micro-nutrient toxicity in French marigold. J. Plant Nut. 19(6): 901-916.
Kabata-Pendias, A. and H. Pendias. 2001. Trace Elements in Soils and Plants, Third Edition. CRC Press.
Keren R and Bingham F T 1985 Boron in water, soils, and plants. Adv. Soil Sci. 1, 230-276.
Lee, Chiwon W., Jong-Myung Choi, and Chun-Ho Pak. 1996. Micronutrient Toxicity in Seed Geranium (Pelargonium×hortorum Bailey). J. Amer. Soc. Hort. Sci. 121(1):77-82.
Marousky, F. J. 1981. Symptomology of fluoride and boron injury in Lilium longiflorum Thunb. J. Amer. Soc. Hort. Sci. 106:341-344.
Maxwell B. D., Roush M. L. and Radosevich S. R. 1990. Predicting the evolution and dynamics of herbicide resistance in weed populations. Weed Technol. 4, 2-13.
Pimentel, D., McNair, S., Janecka, J., Wightman, J., Simmonds, C., O'Connell, C., Wong, E., Russel, L., Zern, J., Aquino, T. and Tsomondo, T. 2001. Economic and environmental threats of alien plant, animal, and microbe invasions. Agriculture, Ecosystems and Environment 84: 1-20
Pimentel, D., Zuniga, R., and Morrison, D. 2005. Update on the environmental and economic costs associated with alien-invasive species in the United States. Ecological Economics. 52: 273-288.
Yamada, T., R. J. Kremer, P. R. de Camargo e Castro, and B. W. Wood. 2009. Glyphosate Interactions with physiology, nutrition, and diseases of plants: Threat to agricultural sustainability?Europ. J. Agron. 31:111-113.

1. A method of applying a composition comprising boron and nitrogen to an area of lawn or turf, wherein said area comprises at least one perennial grass species and at least one weed species growing therein, wherein the applying occurs at least once during July to September, wherein the method results in an application rate of about 20 lbs/acre to about 100 lbs/acre of boron and about 25 lbs/acre to about 100 lbs/acre of nitrogen, and wherein the method promotes the germination, health, vigor and/or growth of the at least one perennial grass species and suppresses the germination, health, vigor and/or growth of the at least one weed species within one month following application.

2. The method of claim 1, wherein the application rate is about 20 lbs/acre to about 32 lbs/acre of boron and about 25 lbs/acre to about 40 lbs/are of nitrogen.

3. The method of claim 1, wherein the application rate is about 32 lbs/acre to about 52 lbs/acre of boron and about 40 lbs/acre to about 65 lbs/acre of nitrogen.

4. The method of claim 1, wherein the at least one weed species is dandelion or creeping Charlie.

5. The method of claim 1, wherein the at least one perennial grass species is selected from the group consisting of Kentucky bluegrass, fescue, bent grass, and perennial ryegrass.

6. The method of claim 1 further comprising measuring the area of lawn or turf that is covered by the at least one perennial grass species before the composition is applied and again 1 month after the composition is applied.

7. (canceled)

8. (canceled)

9. The method of claim 6, wherein the area of lawn or turf covered by the at least one perennial grass species has increased by at least 25% relative to the area of lawn or turf covered by the at least one weed species 1 month after the composition is applied.

10. The method of claim 1, wherein the composition is in granular form.

11. The method of claim 1, wherein the composition is in liquid form.

12. The method of claim 1, wherein the composition is applied as a foliar spray.

13. The method of claim 1, wherein the method continues to promote the germination, health, vigor and/or growth of the at least one perennial grass species and suppress the germination, health, vigor and/or growth of the at least one weed species for 1 month to 21 months after the composition is applied.

14. The method of claim 1, wherein the at least one weed species is eliminated from the area of lawn or turf.

15. The method of claim 1, wherein the application of the composition occurs in the Summer months.

16. The method of claim 1, wherein the application of the composition occurs post flowering of the weed species.

17. The method of claim 1, wherein the method further comprises providing supplemental watering of the area of lawn or turf.

18. The method of claim 1, wherein the applying occurs post-flowering of the at least one weed species.

19. The method of claim 10, wherein the foliar spray is applied as a spot spray.

20. The method of claim 1, wherein the composition does not include fluoride.

21. The method of claim 1, wherein said boron is applied at 52 lbs/acre to about 100 lbs/acre and said nitrogen is applied at about 65 lbs/acre to about 100 lbs/acre.
